(19) United States
(12) Patent Application Publication
(10) Pub. No.: US 2024/0284449 A1
(43) Pub. Date: Aug. 22, 2024

(54) Wireless Resource Usage Reporting

(71) Applicant: Comcast Cable Communications, LLC, Philadelphia, PA (US)

(72) Inventors: Hsin-Hsi Tsai, Taichung City (TW); Hyoungsuk Jeon, Centreville, VA (US); Esmael Hejazi Dinan, McLean, VA (US); Bing Hui, Herndon, VA (US); Ali Cagatay Cirik, Chantilly, VA (US); Mohammad Ghadir Khoshkholgh Dashtaki, Burnaby (CA)

(21) Appl. No.: 18/444,168

(22) Filed: Feb. 16, 2024

Related U.S. Application Data
(60) Provisional application No. 63/446,229, filed on Feb. 16, 2023.
(60) Provisional application No. 63/446,239, filed on Feb. 16, 2023.

(51) Int. Cl. H04W 72/1268; H04L 1/1607; H04W 72/0446; H04W 72/21

(52) U.S. Cl. CPC H04W 72/1268; H04L 1/1614; H04W 72/0446; H04W 72/21

(57) ABSTRACT

One or more wireless devices may be configured with resources for transmission. The resources may comprise configured grant transmission occasions for uplink transmission. At least one of the configured grant transmission occasions may not be used by a wireless device. An indication of one or more configured grant transmission occasions that are used, and/or that are not used, by the wireless device may be provided to a base station.

### CROSS-REFERENCE TO RELATED APPLICATIONS

This application claims the benefit of U.S. Provisional Application No. 63/446,229, filed on Feb. 16, 2023 and U.S. Provisional Application No. 63/446,239, filed on Feb. 16, 2023. The above referenced applications are hereby incorporated by reference in their entirety.

### BACKGROUND

In a wireless communication system, wireless devices communicate with a base station. A wireless device is granted resources for uplink transmission.

### SUMMARY

The following summary presents a simplified summary of certain features. The summary is not an extensive overview and is not intended to identify key or critical elements.

One or more wireless devices may communicate with a base station in a wireless network. A wireless device may be configured with resources for transmission, such as configured grant resource occasions for uplink transmission. A report may be generated and sent by the wireless device to indicate used and/or unused resources of the configured resources. The report may comprise parameters that may indicate quantity and timing of used and/or unused resources. A base station may use the report to reallocate resources for other wireless devices, which may improve network efficiency.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein.

FIG. 16A, FIG. 16B, FIG. 16C, and FIG. 16D show examples of uplink and downlink signal transmission.

FIG. 17 shows an example of alternatives for protocol (or packet) data unit (PDU) Set/quality of service (QoS) Flow/data radio bearer (DRB) mapping.

FIG. 18 shows an example of multiple configured grant (CG) physical uplink shared channel (PUSCH) resource occasions in a period of a single CG configuration.

FIG. 19 shows an example of transmission(s) of multiple transport blocks (TBs) via separate CG resource occasions (CGOs) in a CG period.

FIG. 20 shows an example of unused CGO indication.

FIG. 21 shows example issues of unused CGO indication.

FIG. 22 shows an example of unused CGO indication indicating one or more subsequent unused CG resources.

FIG. 23 shows an example of unused CGO indication comprising one or more fields to indicate one or more unused CG resources.

FIG. 24 shows an example of unused CGO indication indicating remaining/subsequent unused CG resources of a CG period.

FIG. 25 shows an example of unused CGO indication comprising a field to indicate the quantity (e.g., number) of unused CG resources.

FIG. 26 shows an example of unused CGO indication indicating unused CG resources within one or more CG periods.

FIG. 27 shows an example of unused CGO indication indicating unused CG resources within a duration and/or based on a timer.

FIG. 28A and FIG. 28B show example embodiments of unused CGO indication.

FIG. 29 shows example issues of unused CGO indication.

FIG. 30 shows an example that an unused CGO indication is associated with a CG configuration.

FIG. 31 shows an example that an unused CGO indication is associated with CG configurations.

FIG. 32 shows an example that an unused CGO indication is associated with some of CG configurations.

FIG. 33 shows an example that an unused CGO indication is associated with one or more BWP/Cell/Group of Cells.

FIG. 34A and FIG. 34B show example embodiments of unused CGO indication.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems.

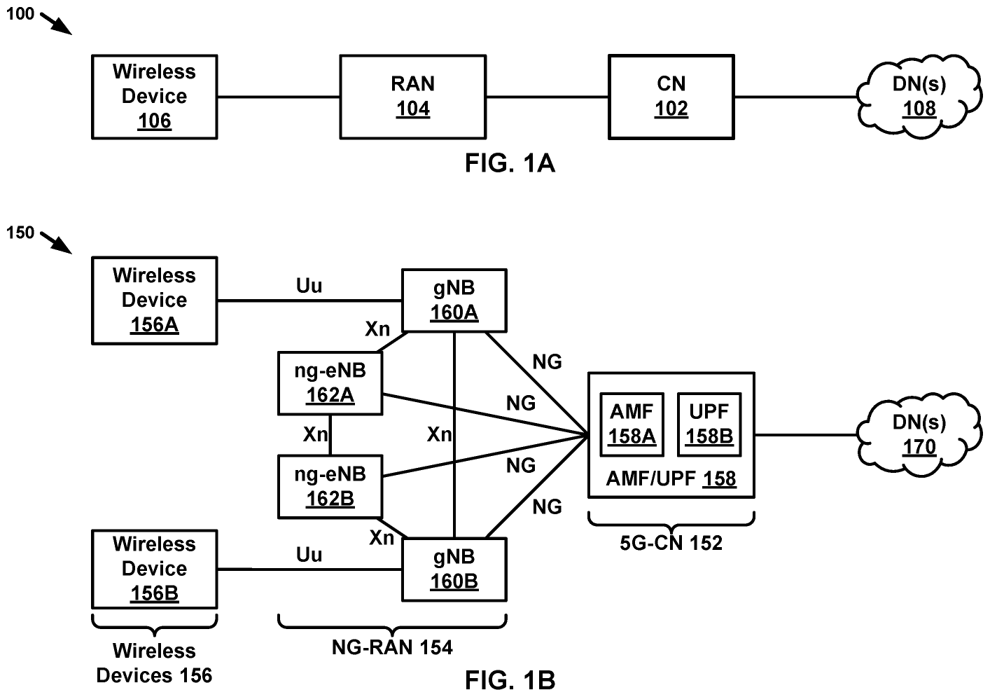

FIG. 1A shows an example communication network 100. The communication network 100 may comprise a mobile communication network). The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with one or more DNs 108, such as public DNs (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle road side unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a gNB, an ng-eNB, a relay node (e.g., an integrated access and backhaul (IAB) node), a donor node (e.g., a donor eNB, a donor gNB, etc.), an access point (e.g., a Wi-Fi access point), a transmission and reception point (TRP), a computing device, a device capable of wirelessly communicating, or any other device capable of sending and/or receiving signals. A base station may comprise one or more of each element listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an Evolved Node B (eNB) (e.g., associated with Evolved-Universal Terrestrial Radio Access (E-UTRA) and/or fourth-generation (4G) standards), a remote radio head (RRH), a baseband processing unit coupled to one or more remote radio heads (RRHs), a repeater node or relay node used to extend the coverage area of a donor node, a Next Generation Evolved Node B (ng-eNB), a Generation Node B (gNB) (e.g., associated with NR and/or fifth-generation (5G) standards), an access point (AP) (e.g., associated with, for example, Wi-Fi or any other suitable wireless communication standard), any other generation base station, and/or any combination thereof. A base station may comprise one or more devices, such as at least one base station central device (e.g., a gNB Central Unit (gNB-CU)) and at least one base station distributed device (e.g., a gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an access point, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform the substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to one or more DNs 170, such as public DNs (e.g., the Internet), private DNs, and/or intra-operator DNs. As part of the interface functionality, the CN 152 (e.g., 5G-CN) may set up end-to-end connections between the wireless device(s) 156 and the one or more DNs, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between a RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QoS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode UE reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., gNBs comprising a gNB 160A and a gNB 160B (collectively gNBs 160)) and/or one or more second-type base stations (e.g., ng eNBs comprising an ng-eNB 162A and an ng-eNB 162B (collectively ng eNBs 162)). The RAN 154 may comprise one or more of any quantity of types of base station. The gNBs 160 and ng eNBs 162 may be referred to as base stations. The base stations (e.g., the gNBs 160 and ng eNBs 162) may comprise one or more sets of antennas for communicating with the wireless device(s) 156 wirelessly (e.g., an over an air interface). One or more base stations (e.g., the gNBs 160 and/or the ng eNBs 162) may comprise multiple sets of antennas to respectively control multiple cells (or sectors). The cells of the base stations (e.g., the gNBs 160 and the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide Evolved UMTS Terrestrial Radio Access (E UTRA) user plane and control plane protocol terminations towards the wireless device(s) 156 via a Uu interface (e.g., where E UTRA may refer to the 3GPP 4G radio-access technology). A base station (e.g., the ng-eNB 162B) may provide E UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, internet of things (IoT) devices, hotspots, cellular repeaters, computing devices, and/or, more generally, user equipment (e.g., UE). Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise a terrestrial network (e.g., a LTE network, a 5G network, a 6G network), a non-terrestrial network (e.g., a satellite network), and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

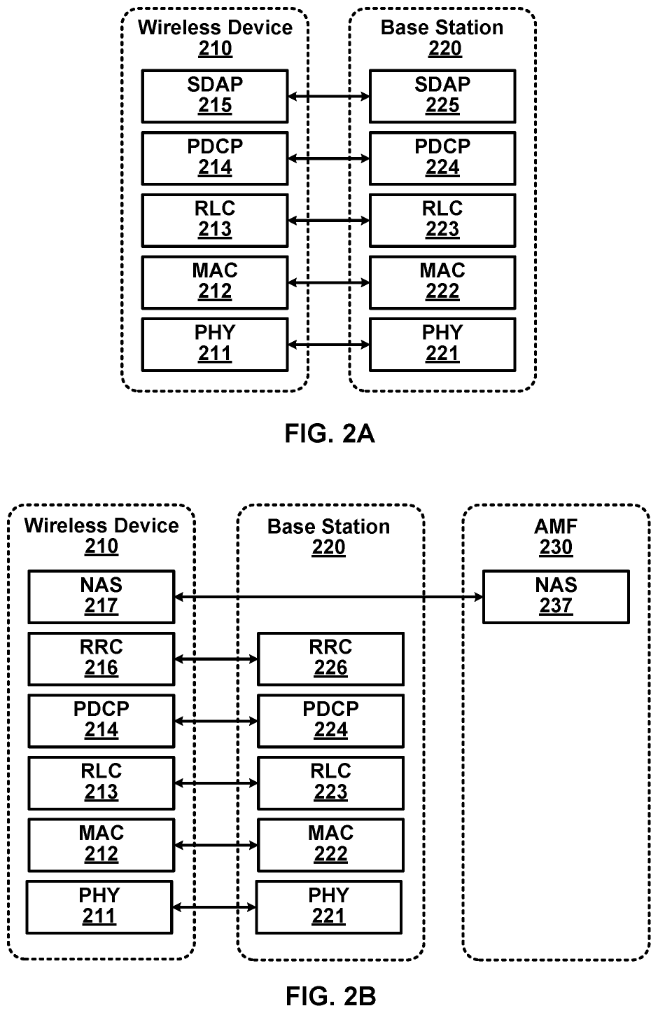

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configuration and/or the control plane configuration may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

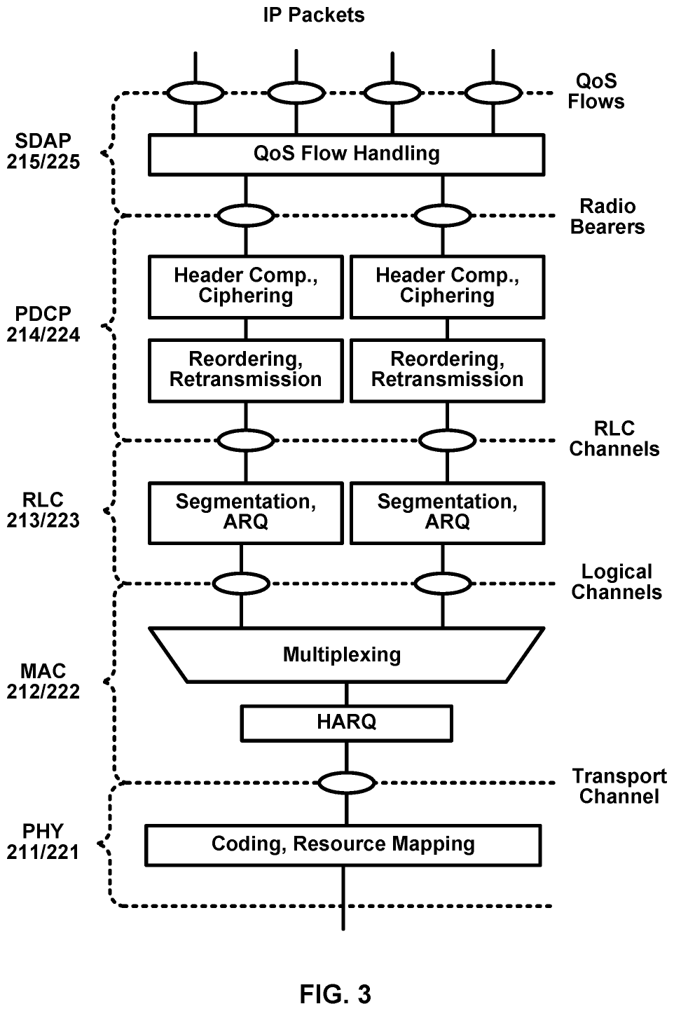

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform Quality of Service (QoS) flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted over the air interface, ciphering/deciphering to prevent unauthorized decoding of data transmitted over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity example/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers may perform one or more of the noted functions, for example, based on the transmission mode an RLC layer is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels as a service to the PDCP layers (e.g., PDCPs 214 and 224, respectively), such as shown in FIG. 3.

The MAC layers (e.g., MACs 212 and 222) may perform multiplexing/demultiplexing of logical channels and/or mapping between logical channels and transport channels. The multiplexing/demultiplexing may comprise multiplexing/demultiplexing of data units/data portions, belonging to the one or more logical channels, into/from Transport Blocks (TBs) delivered to/from the PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

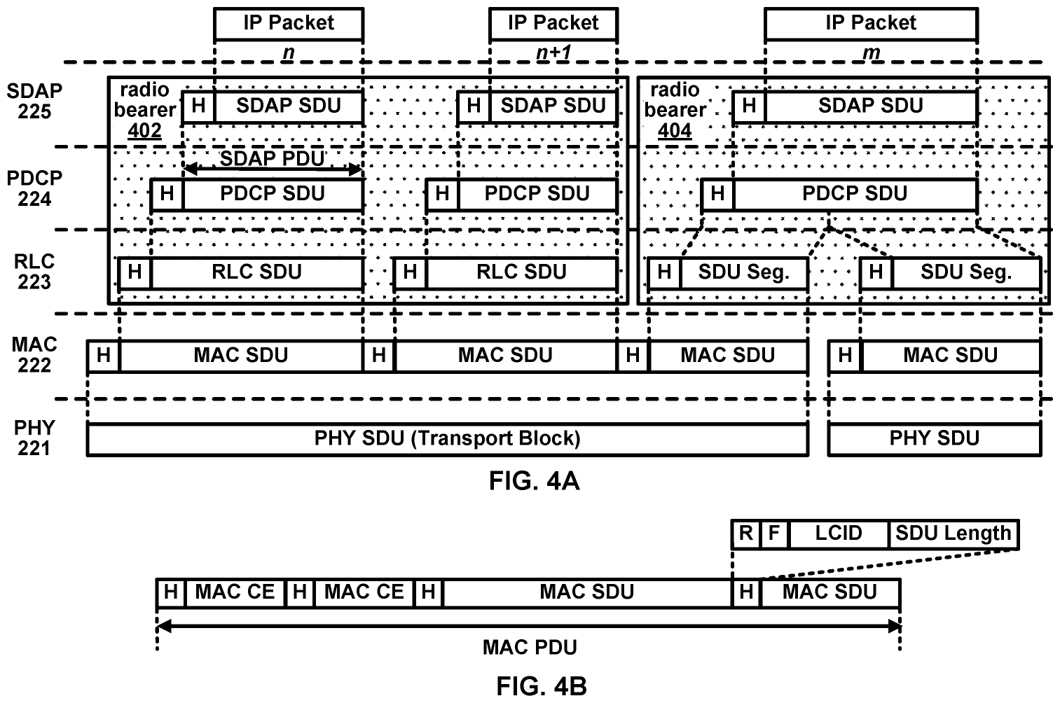

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a number of RLC PDUs (MAC SDUs). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 223 or MAC 222. As shown in FIG. 4B, two MAC CEs may be inserted/added before two MAC PDUs. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

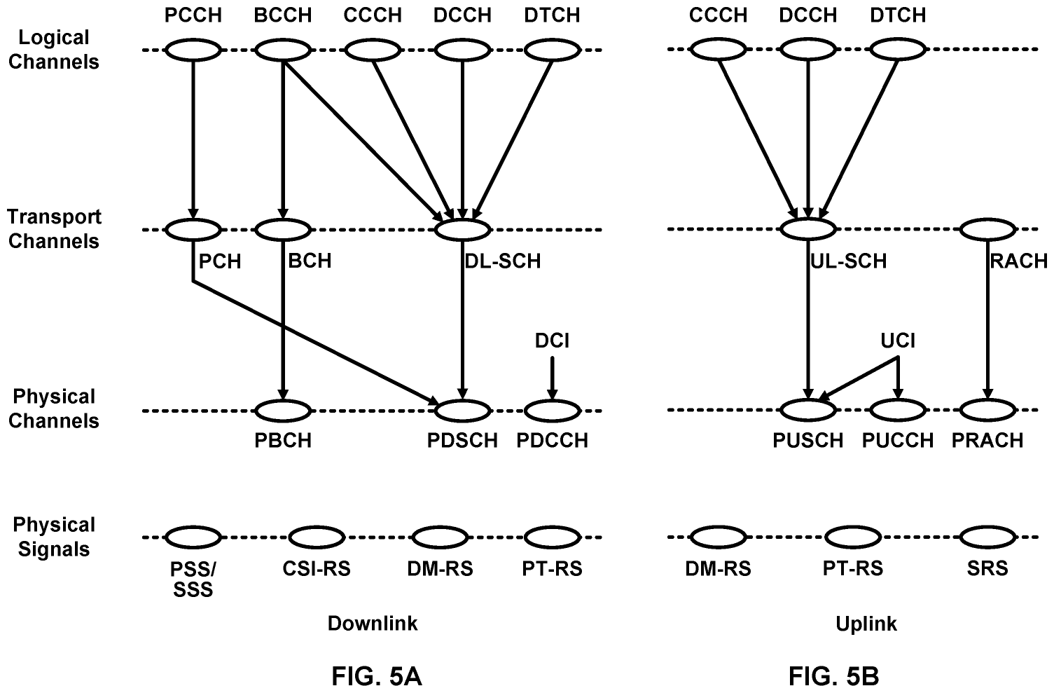

FIG. 5A shows an example mapping for downlink channels. The mapping for uplink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless devices).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may have an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as L1/L2 control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The physical layer may generate physical signals to support the low-level operation of the physical layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), sounding reference signals (SRS), phase-tracking reference signals (PT RS), and/or any other signals.

One or more of the channels (e.g., logical channels, transport channels, physical channels, etc.) may be used to carry out functions associated with the control plan protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHY 211 and 221, MAC 212 and 222, RLC 213 and 223, and PDCP 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting (e.g., the wireless device measurement reporting) and control of the reporting; detection of and recovery from radio link failure (RLF); and/or NAS message transfer. As part of establishing an RRC connection, RRC layers 216 and 226 may establish an RRC context, which may involve configuring parameters for communication between the wireless device 210 and the RAN (e.g., the base station 220).

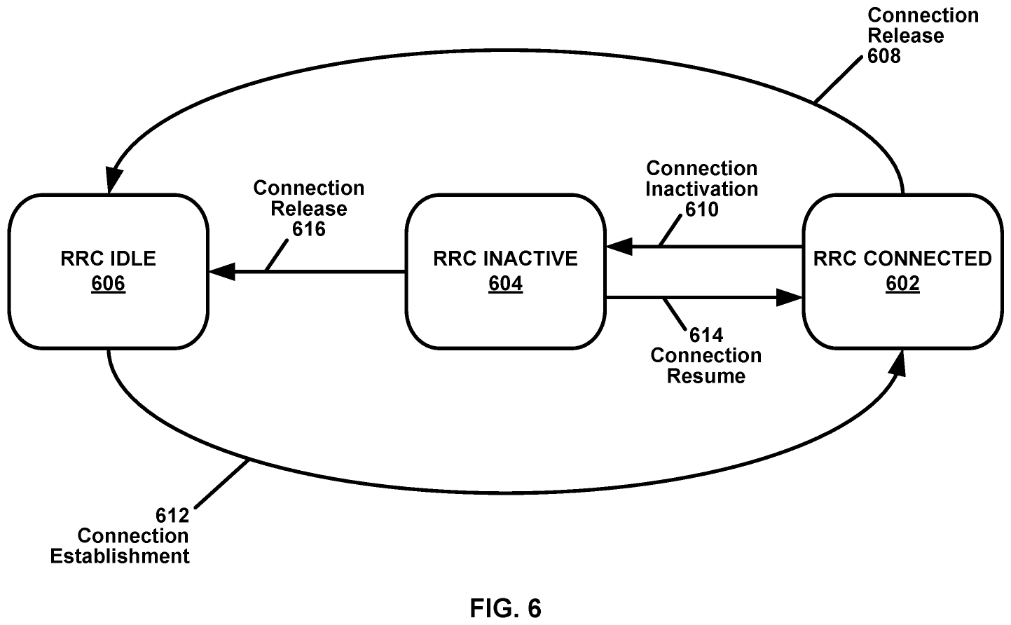

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by a RAN (e.g., the RAN 104 or the NG RAN 154). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., RRC connected 602) to an RRC idle state (e.g., the RRC idle 606) via a connection release procedure 608. The RRC state may transition from the RRC connected state (e.g., RRC connected 602) to the RRC inactive state (e.g., RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., each discontinuous reception (DRX) cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614. The RRC state may transition from the RRC inactive state (e.g., the RRC inactive 604) to the RRC idle state (e.g., the RRC idle 606) via a connection release procedure 616 that may be the same as or similar to connection release procedure 608.

An RRC state may be associated with a mobility management mechanism. During the RRC idle state (e.g., RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC idle state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the 5G CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the UE registration area, for example, for example, if the wireless device moves (e.g., via a cell reselection) to a cell associated with a TAI that may not be included in the list of TAIs associated with the UE registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., RRC inactive 604).

A base station (e.g., gNBs 160 in FIG. 1B or any other base station) may be split in two parts: a central unit (e.g., a base station central unit, such as a gNB CU) and one or more distributed units (e.g., a base station distributed unit, such as a gNB DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM is a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as for example, if they are in the frequency domain. The F parallel symbols may be used as inputs to an Inverse Fast Fourier Transform (FOR EXAMPLE, IFFT) block that transforms them into the time domain. The FOR EXAMPLE, IFFT block may take in F source symbols at a time, one from each of the F parallel symbol streams. The FOR EXAMPLE, IFFT block may use each source symbol to modulate the amplitude and phase of one of F sinusoidal basis functions that correspond to the F orthogonal subcarriers. The output of the FOR EXAMPLE, IFFT block may be F time-domain samples that represent the summation of the F orthogonal subcarriers. The F time-domain samples may form a single OFDM symbol. An OFDM symbol provided/output by the FOR EXAMPLE, IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the FOR EXAMPLE, IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

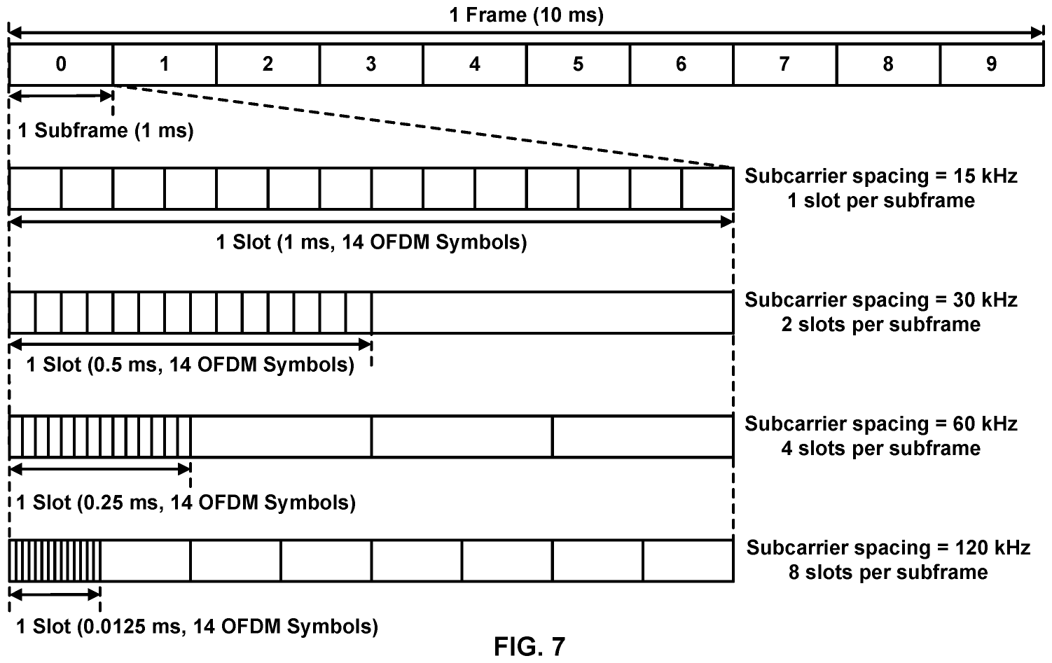

FIG. 7 shows an example configuration of a frame. The frame may comprise, for example, an NR radio frame into which OFDM symbols may be grouped. A frame (e.g., an NR radio frame) may be identified/indicated by a system frame number (SFN) or any other value. The SFN may repeat with a period of 1024 frames. One NR frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed number/quantity of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

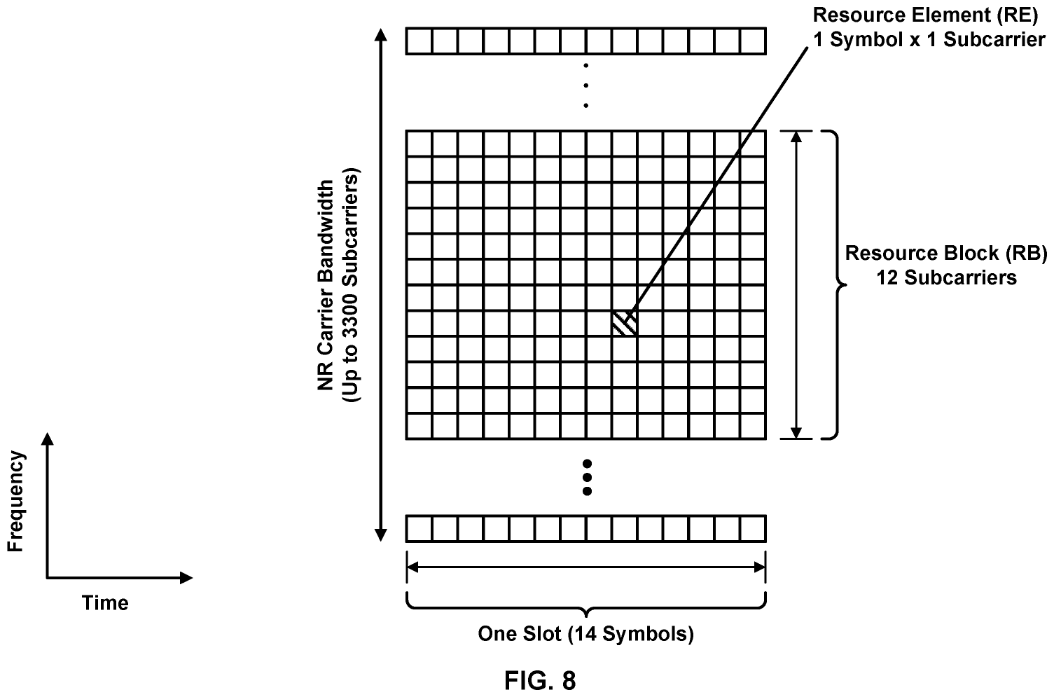

FIG. 8 shows an example resource configuration of one or more carriers. The resource configuration of may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), for example, if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, for example, if the wireless device does not detect DCI during a time interval (e.g., 1 ms or 0.5 ms). The wireless device may switch from the active downlink BWP to the default downlink BWP, for example, for example, if the BWP inactivity timer expires.

A base station may semi-statically configure a wireless device with one or more BWPs. A wireless device may switch an active BWP from a first BWP to a second BWP, for example, after (e.g., based on or in response to) receiving DCI indicating the second BWP as an active BWP. A wireless device may switch an active BWP from a first BWP to a second BWP, for example, after (e.g., based on or in response to) an expiry of the BWP inactivity timer (e.g., for example, if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

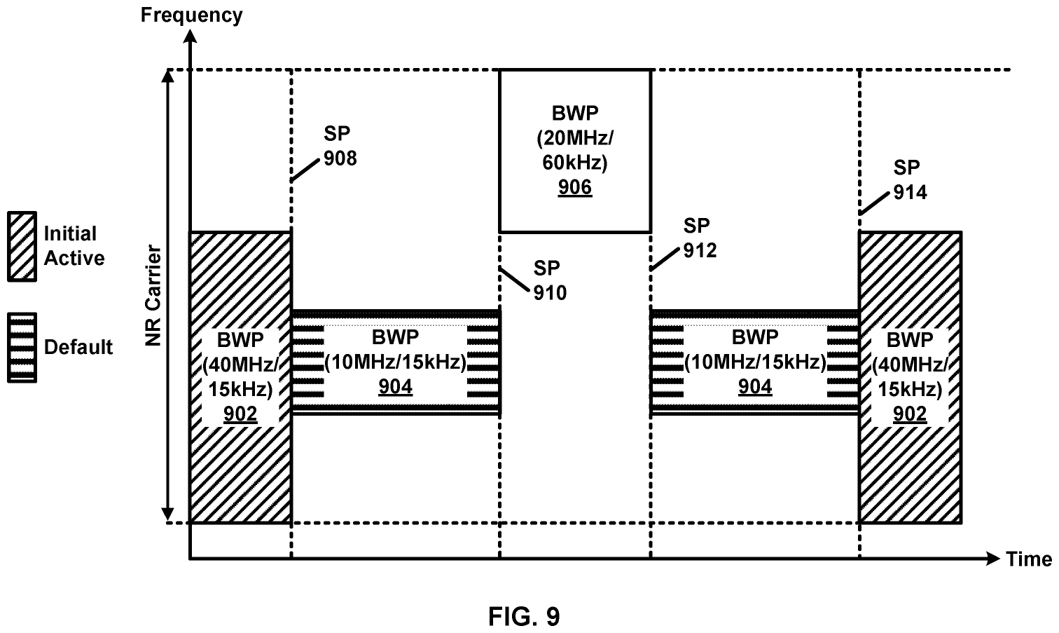

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at a switching point 908 may occur, for example, after (e.g., based on or in response to) an expiry of a BWP inactivity timer (e.g., indicating switching to the default BWP). The switching at the switching point 908 may occur, for example, after (e.g., based on or in response to) receiving DCI indicating BWP 904 as the active BWP. The wireless device may switch at a switching point 910 from an active BWP 904 to the BWP 906, for example, after or in response receiving DCI indicating BWP 906 as a new active BWP. The wireless device may switch at a switching point 912 from an active BWP 906 to the BWP 904, for example, after (e.g., based on or in response to) an expiry of a BWP inactivity timer. The wireless device may switch at the switching point 912 from an active BWP 906 to the BWP 904, for example, after or in response receiving DCI indicating BWP 904 as a new active BWP. The wireless device may switch at a switching point 914 from an active BWP 904 to the BWP 902, for example, after or in response receiving DCI indicating the BWP 902 as a new active BWP.

Wireless device procedures for switching BWPs on a secondary cell may be the same/similar as those on a primary cell, for example, for example, if the wireless device is configured for a secondary cell with a default downlink BWP in a set of configured downlink BWPs and a timer value. The wireless device may use the timer value and the default downlink BWP for the secondary cell in the same/similar manner as the wireless device uses the timer value and/or default BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a number/quantity of serving cells for the wireless device (e.g., one serving cell for a CC), for example, for example, if CA is configured/used. The CCs may have multiple configurations in the frequency domain.

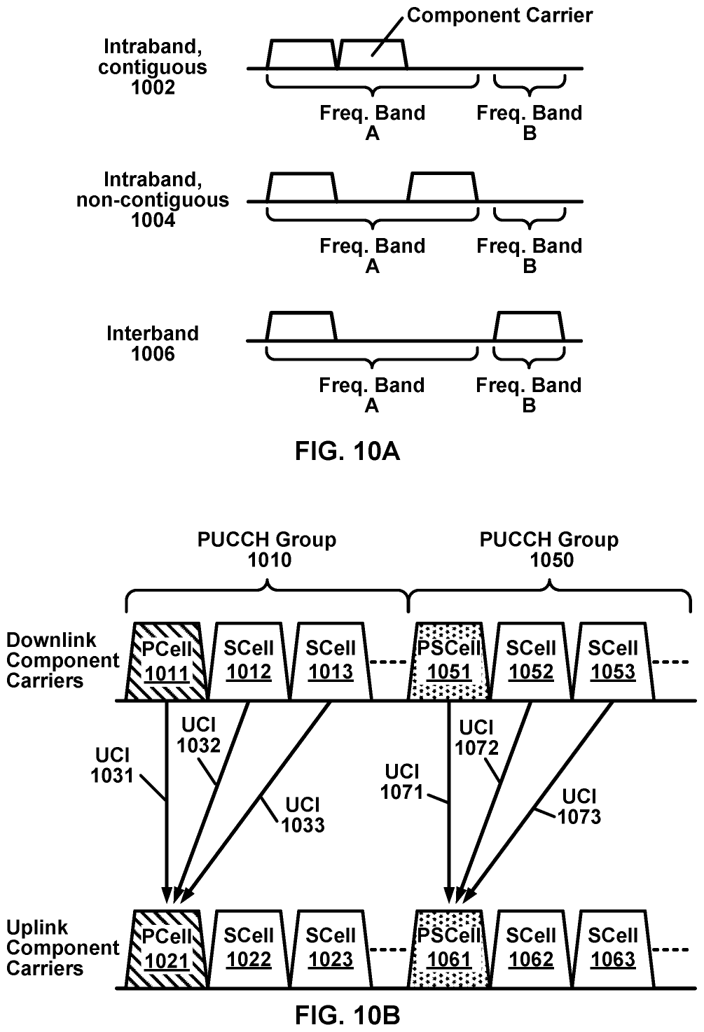

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, for example, if the wireless device has more data traffic in the downlink than in the uplink.

One of the aggregated cells for a wireless device may be referred to as a primary cell (PCell), for example, for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless device may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, after (e.g., based on or in response to) an expiration of an SCell deactivation timer (e.g., one SCell deactivation timer per SCell may be configured).

DCI may comprise control information, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. Uplink control information (UCI) may comprise control information, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, for example, if the aggregated cells shown in FIG. 10B are not divided into the PUCCH group 1010 and the PUCCH group 1050. The PCell 1021 may become overloaded, for example, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more reference signals (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

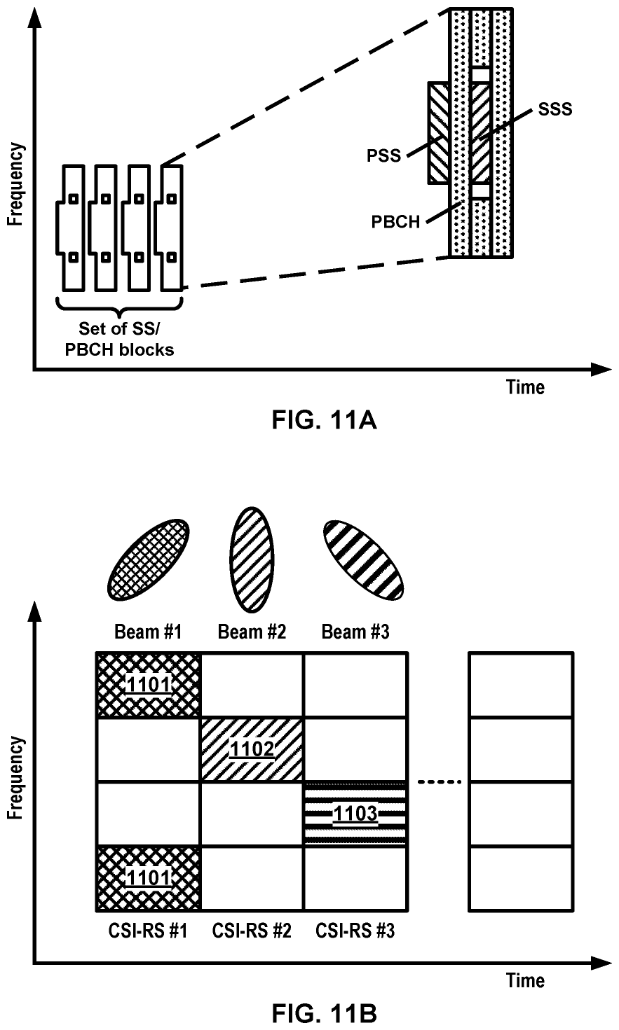

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., for example, if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block for example, if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIBL. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial Rx parameters). The wireless device may not assume QCL for SS/PBCH block transmissions having different SS/PBCH block indexes. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine channel state information (CSI). The base station may configure the wireless device with one or more CSI-RSs for channel estimation or any other suitable purpose. The base station may configure a wireless device with one or more of the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a number/quantity (e.g. a maximum number/quantity) of front-loaded DM-RS symbols for a PDSCH. A DM-RS configuration may support one or more DM-RS ports. A DM-RS configuration may support up to eight orthogonal downlink DM-RS ports per wireless device (e.g., for single user-MIMO). A DM-RS configuration may support up to 4 orthogonal downlink DM-RS ports per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DMRSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, for example, if configured, may be associated with one or more DCI parameters comprising at least MCS. A network (e.g., an NR network) may support a plurality of PT-RS densities defined in the time and/or frequency domains. A frequency domain density (for example, if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a number/quantity (e.g. the maximum number/quantity) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DMRSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, for example, if configured, may be associated with one or more DCI parameters comprising at least MCS. A radio network may support a plurality of uplink PT-RS densities defined in time/frequency domain. A frequency domain density (for example, if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in an SRS resource set of the one or more SRS resource sets (e.g., with the same/similar time domain behavior, periodic, aperiodic, and/or the like) may be sent/transmitted at a time instant (e.g., simultaneously), for example, for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS for example, if a PUSCH and an SRS are sent/transmitted in a same slot. A base station may semi-statically configure a wireless device with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, for example, if the first symbol and the second symbol are sent/transmitted on the same antenna port. A first antenna port and a second antenna port may be referred to as quasi co-located (QCLed), for example, for example, if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a resource block (RB) within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a number of CSI-RS ports, a CSI-RS configuration (e.g., symbol and resource element (RE) locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams are shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure an RSRP of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication (TCI) states comprising a number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, for example, if the wireless device has the capability of beam correspondence. The wireless device may perform an uplink beam selection procedure to determine the spatial domain filter of the Tx beam, for example, for example, if the wireless device does not have the capability of beam correspondence. The wireless device may perform the uplink beam selection procedure, for example, based on one or more sounding reference signal (SRS) resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a precoding matrix indicator (PMI), a channel quality indicator (CQI), and/or a rank indicator (RI).

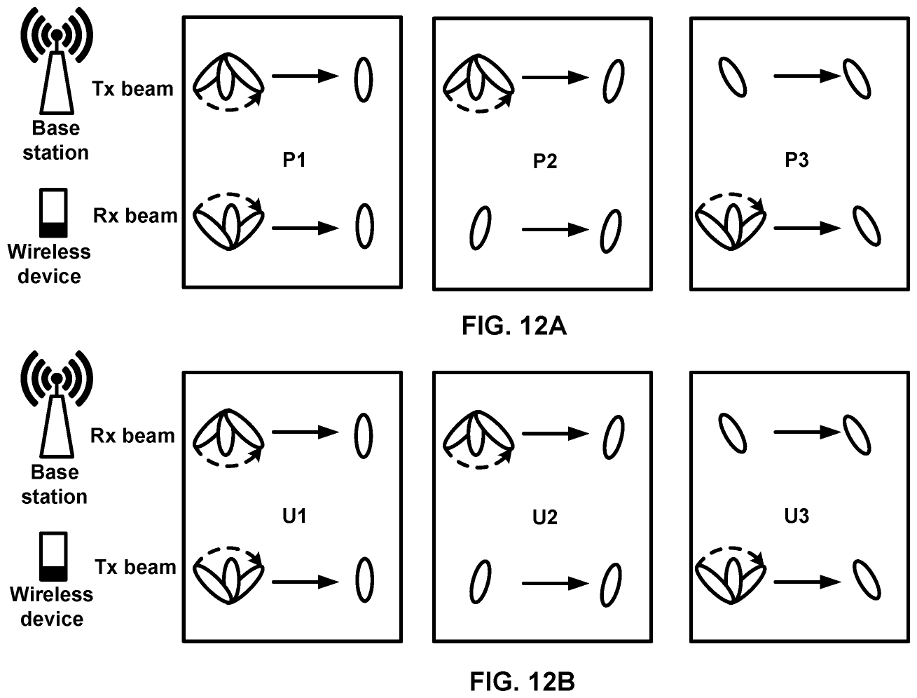

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station and the Rx beams of a wireless device are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station to perform a measurement on Tx beams of a wireless device (e.g., to support a selection of one or more Tx beams of the wireless device and/or Rx beams of the base station). The Tx beams of the wireless device and the Rx beams of the base station are shown as ovals in the top row of U1 and bottom row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, for example, if the UE uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more reference signals (RSs) comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, for example, if the channel characteristics (e.g., Doppler shift, Doppler spread, an average delay, delay spread, a spatial Rx parameter, fading, and/or the like) from a transmission via the RS resource to the wireless device are similar or the same as the channel characteristics from a transmission via the channel to the wireless device.

A network (e.g., an NR network comprising a gNB and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR for example, if there is no PUCCH resource available) and/or acquire/obtain/determine an uplink timing (e.g., for example, if an uplink synchronization status is non-synchronized). The wireless device may initiate/start/perform the random access procedure to request one or more system information blocks (SIBs) (e.g., other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

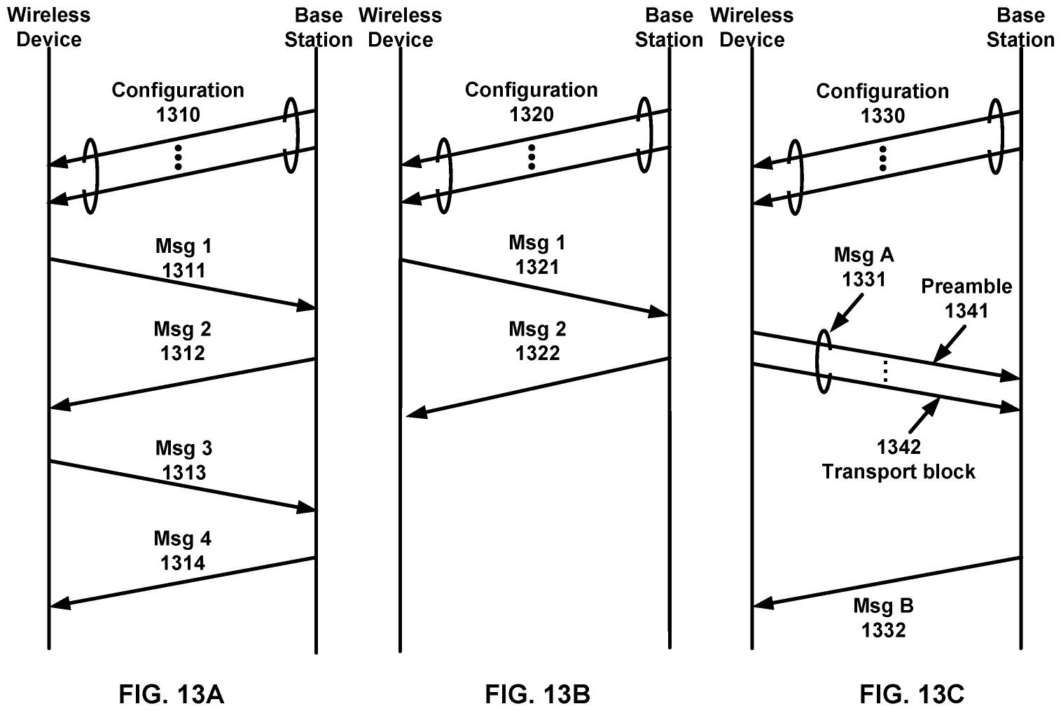

FIG. 13A shows an example four-step random access procedure. The four-step random access procedure may comprise a four-step contention-based random access procedure. A base station may send/transmit a configuration message 1310 to a wireless device, for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more random access channel (RACH) parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-ConfigDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more Physical RACH (PRACH) occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association for example, if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, for example, if no response is received after (e.g., based on or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, after (e.g., based on or in response to) the sending/sending (e.g., transmitting) of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-ResponseWindow) to monitor a PDCCH for the second message (e.g., Msg 2 1312), for example, after sending/sending (e.g., transmitting) the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Typel-PDCCH common search space) configured by an RRC message. The wireless device may identify/determine the RAR, for example, based on an RNTI. Radio network temporary identifiers (RNTIs) may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

RA-RNTI=1+s_id+14×t_id+14×80×f_id+14×80×8×ul_carrier_id
where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, after (e.g., based on or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another the wireless device. The wireless device may comprise a device identifier in the third message (e.g., Msg 3 1313) (e.g., a C-RNTI for example, if assigned, a TC RNTI comprised in the second message (e.g., Msg 2 1312), and/or any other suitable identifier), for example, to perform contention resolution.

The fourth message (e.g., Msg 4 1314) may be received, for example, after (e.g., based on or in response to) the sending/sending (e.g., transmitting) of the third message (e.g., Msg 3 1313). The base station may address the wireless on the PDCCH (e.g., the base station may send the PDCCH to the wireless device) using a C-RNTI, for example, For example, if the C-RNTI was included in the third message (e.g., Msg 3 1313). The random access procedure may be determined to be successfully completed, for example, for example, if the unique C RNTI of the wireless device is detected on the PDCCH (e.g., the PDCCH is scrambled by the C-RNTI). Fourth message (e.g., Msg 4 1314) may be received using a DL-SCH associated with a TC RNTI, for example, for example, if the TC RNTI is comprised in the third message (e.g., Msg 3 1313) (e.g., for example, if the wireless device is in an RRC idle (e.g., an RRC_IDLE) state or not otherwise connected to the base station). The wireless device may determine that the contention resolution is successful and/or the wireless device may determine that the random access procedure is successfully completed, for example, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, for example, if a measured quality of one or more reference signals (e.g., one or more reference signals associated with the NUL carrier) is lower than a broadcast threshold. Uplink transmissions of the random access procedure (e.g., the first message (e.g., Msg 1 1311) and/or the third message (e.g., Msg 3 1313)) may remain on, or may be performed via, the selected carrier. The wireless device may switch an uplink carrier during the random access procedure (e.g., between the Msg 1 1311 and the Msg 3 1313). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station may, prior to initiation of the procedure, send/transmit a configuration message 1320 to the wireless device. The configuration message 1320 may be analogous in some respects to the configuration message 1310. The procedure shown in FIG. 13B may comprise transmissions of two messages: a first message (e.g., Msg 1 1321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-ResponseWindow) to monitor a PDCCH for the RAR, for example, after (e.g., based on or in response to) sending (e.g., transmitting) the preamble. The base station may configure the wireless device with one or more beam failure recovery parameters, such as a separate time window and/or a separate PDCCH in a search space indicated by an RRC message (e.g., recoverySearchSpaceld). The base station may configure the one or more beam failure recovery parameters, for example, in association with a beam failure recovery request. The separate time window for monitoring the PDCCH and/or an RAR may be configured to start after sending (e.g., transmitting) a beam failure recovery request (e.g., the window may start any quantity of symbols and/or slots after sending (e.g., transmitting) the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, after (e.g., based on or in response to) sending (e.g., transmitting) first message (e.g., Msg 1 1321) and receiving a corresponding second message (e.g., Msg 2 1322). The wireless device may determine that a random access procedure has successfully been completed, for example, for example, if a PDCCH transmission is addressed to a corresponding C-RNTI. The wireless device may determine that a random access procedure has successfully been completed, for example, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station may, prior to initiation of the procedure, send/transmit a configuration message 1330 to the wireless device. The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

Msg A 1331 may be sent/transmitted in an uplink transmission by the wireless device. Msg A 1331 may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, after (e.g., based on or in response to) sending (e.g., transmitting) the first message (e.g., Msg A 1331). The second message (e.g., Msg B 1332) may comprise contents that are similar and/or equivalent to the contents of the second message (e.g., Msg 2 1312) (e.g., an RAR shown in FIGS. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as L1/L2 control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as downlink control information (DCI). The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCI messages may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCI messages with one or more DCI formats, for example, depending on the purpose and/or content of the DCI messages. DCI format 0_0 may be used for scheduling of a PUSCH in a cell. DCI format 00 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 10 may be a fallback DCI format (e.g., with compact DCI payloads). DCI format 1_1 may be used for scheduling of a PDSCH in a cell (e.g., with more DCI payloads than DCI format 1_0). DCI format 2_0 may be used for providing a slot format indication to a group of wireless devices. DCI format 2_1 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a number of contiguous control channel elements (CCEs), for example, based on a payload size of the DCI and/or a coverage of the base station. The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

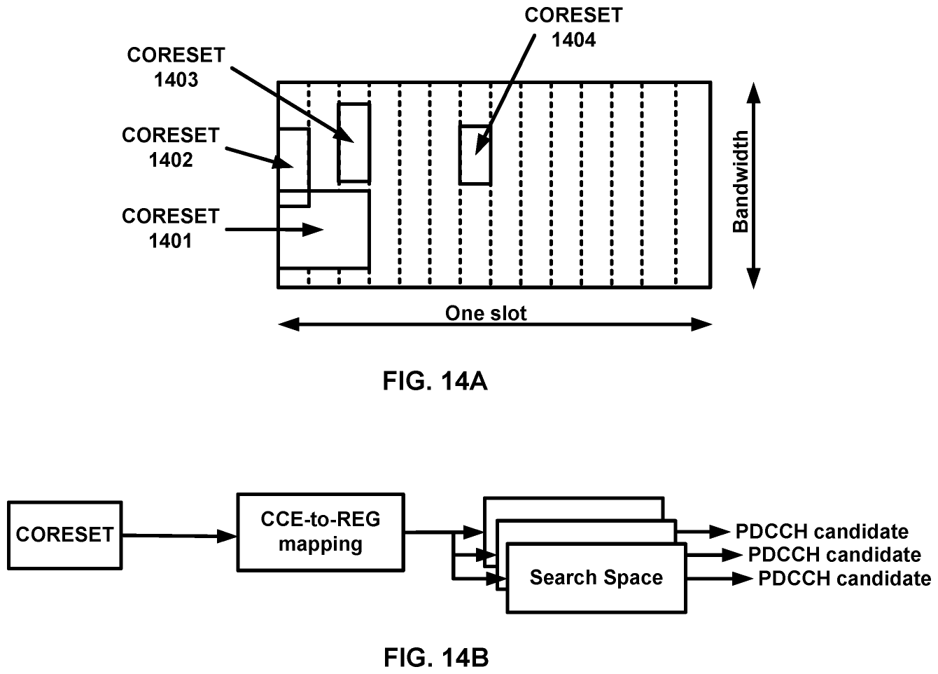

FIG. 14A shows an example of CORESET configurations. The CORESET configurations may be for a bandwidth part or any other frequency bands. The base station may send/transmit DCI via a PDCCH on one or more control resource sets (CORESETs). A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCI messages. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the number of CCEs, the number of PDCCH candidates in common search spaces, and/or the number of PDCCH candidates in the wireless device-specific search spaces) and possible (or configured) DCI formats. The decoding may be referred to as blind decoding. The wireless device may determine DCI as valid for the wireless device, for example, after (e.g., based on or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The wireless device may send/transmit uplink control signaling (e.g., UCI) to a base station. The uplink control signaling may comprise HARQ acknowledgements for received DL-SCH transport blocks. The wireless device may send/transmit the HARQ acknowledgements, for example, after (e.g., based on or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise scheduling requests (SR). The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a number of UCI bits). PUCCH format 0 may have a length of one or two OFDM symbols and may comprise two or fewer bits. The wireless device may send/transmit UCI via a PUCCH resource, for example, using PUCCH format 0 for example, if the transmission is over/via one or two symbols and the quantity/number of HARQ-ACK information bits with positive or negative SR (HARQ-ACK/SR bits) is one or two. PUCCH format 1 may occupy a number of OFDM symbols (e.g., between four and fourteen OFDM symbols) and may comprise two or fewer bits. The wireless device may use PUCCH format 1, for example, for example, if the transmission is over/via four or more symbols and the number of HARQ-ACK/SR bits is one or two. PUCCH format 2 may occupy one or two OFDM symbols and may comprise more than two bits. The wireless device may use PUCCH format 2, for example, for example, if the transmission is over/via one or two symbols and the quantity/number of UCI bits is two or more. PUCCH format 3 may occupy a number of OFDM symbols (e.g., between four and fourteen OFDM symbols) and may comprise more than two bits. The wireless device may use PUCCH format 3, for example, for example, if the transmission is four or more symbols, the quantity/number of UCI bits is two or more, and the PUCCH resource does not comprise an orthogonal cover code (OCC). PUCCH format 4 may occupy a number of OFDM symbols (e.g., between four and fourteen OFDM symbols) and may comprise more than two bits. The wireless device may use PUCCH format 4, for example, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) for example, if configured with a plurality of PUCCH resource sets. The wireless device may select a first PUCCH resource set having a PUCCH resource set index equal to “0,” for example, for example, if the total bit length of UCI information bits is two or fewer. The wireless device may select a second PUCCH resource set having a PUCCH resource set index equal to “1,” for example, for example, if the total bit length of UCI information bits is greater than two and less than or equal to a first configured value. The wireless device may select a third PUCCH resource set having a PUCCH resource set index equal to “2,” for example, for example, if the total bit length of UCI information bits is greater than the first configured value and less than or equal to a second configured value. The wireless device may select a fourth PUCCH resource set having a PUCCH resource set index equal to “3,” for example, for example, if the total bit length of UCI information bits is greater than the second configured value and less than or equal to a third value (e.g., 1406, 1706, or any other quantity of bits).

The wireless device may determine a PUCCH resource from the PUCCH resource set for UCI (HARQ-ACK, CSI, and/or SR) transmission, for example, after determining a PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

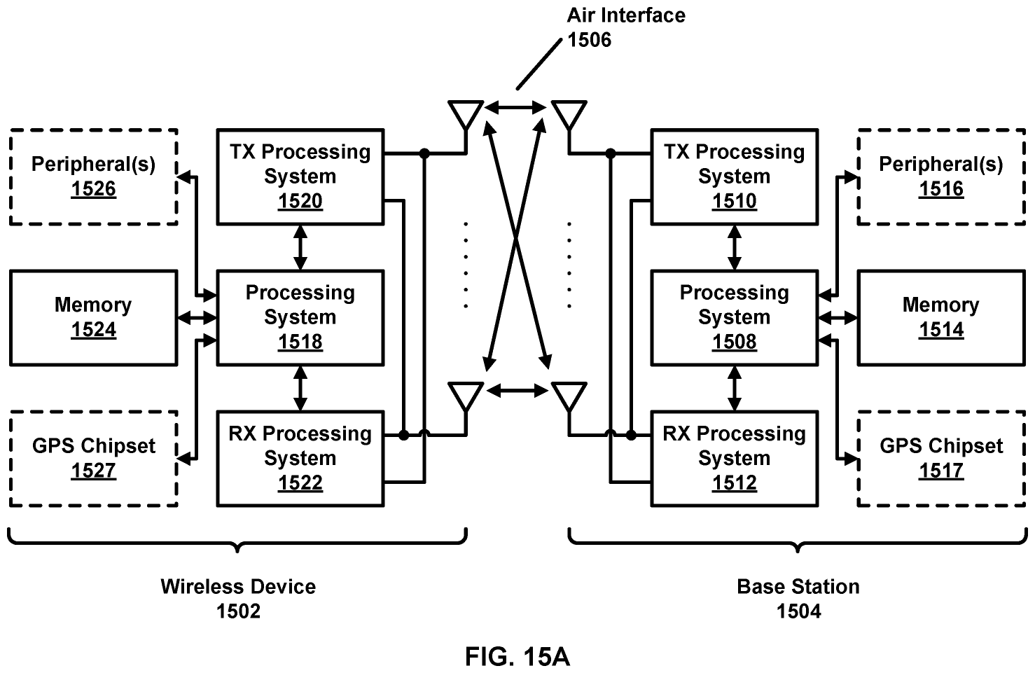

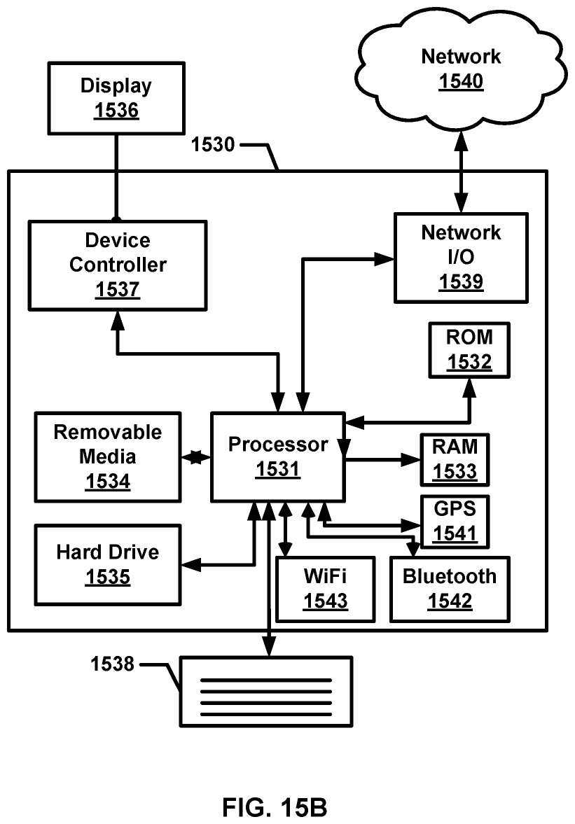

FIG. 15A shows example communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For sending/transmission processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, and/or 1504, the wireless device 106, 156A, 156B, 210, and/or 1502, or any other base station, wireless device, AMF, UPF, network device, or computing device described herein. The computing device 1530 may include one or more processors 1531, which may execute instructions stored in the random-access memory (RAM) 1533, the removable media 1534 (such as a Universal Serial Bus (USB) drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a Wifi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a global positioning system (GPS) microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

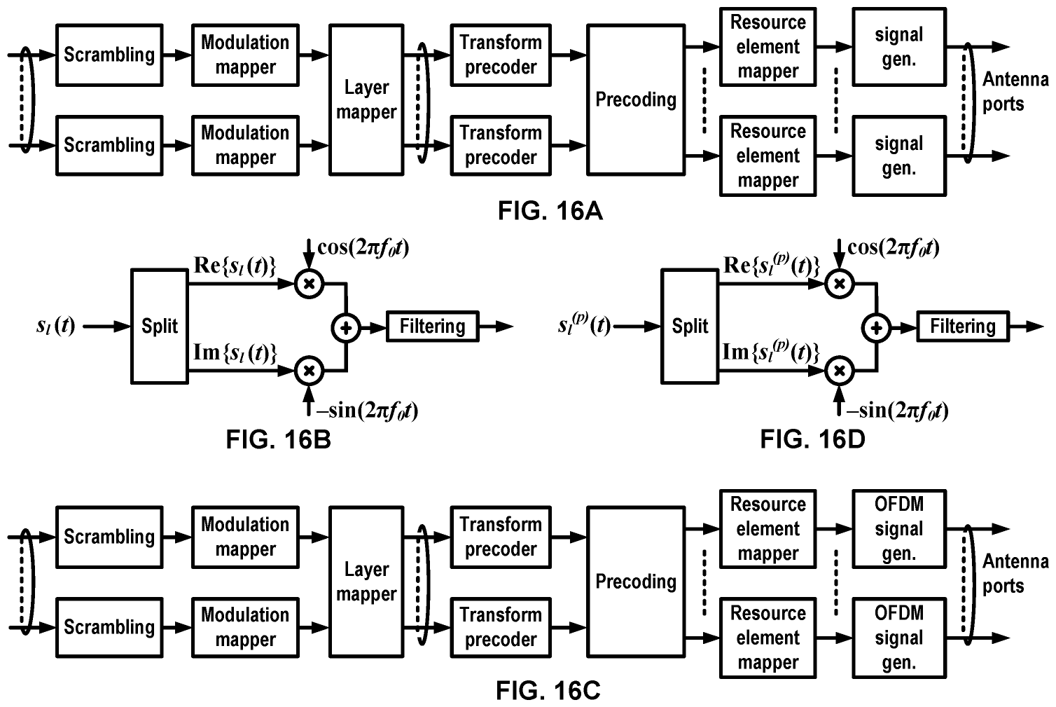

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, for example, if transform precoding is enabled. A CP-OFDM signal for uplink transmission may be generated, for example, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, for example, if it is started, and continue running until it is stopped or until it expires. A timer may be started, for example, for example, if it is not running or restarted for example, if it is running. A timer may be associated with a value (e.g., the timer may be started or restarted from a value or may be started from zero and expire for example, if it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, for example, if a timer is restarted. Other example implementations may be configured/provided to restart a measurement of a time window.

With Configured Grants, the Network (NW) may allocate uplink resources for the initial HARQ transmissions and HARQ retransmissions to UEs. At least two types of configured uplink grants may be defined:
With Type 1, RRC/NW may directly provide the configured uplink grant (e.g., including the periodicity).
With Type 2, RRC/NW may define the periodicity of the configured uplink grant while PDCCH addressed to CS-RNTI may either signal and/or activate the configured uplink grant, and/or deactivate it; e.g., a PDCCH addressed to CS-RNTI may indicate that the uplink grant can be implicitly reused according to the periodicity defined by RRC, until deactivated.

A wireless device (e.g., UE) may be configured (e.g., indicated) with up to 12 active configured uplink grants for a given Bandwidth Part (BWP) of a serving cell. The network may decide which of these configured uplink grants are active at a time (e.g., including all of them), for example, for example, if more than one is configured (e.g., indicated). Each configured uplink grant may either be of Type 1 or Type 2. Activation and deactivation of configured uplink grants Type 2 may be independent among the serving cells. Each configured grant may be activated separately using a Downlink Control Information (DCI) command and deactivation of Type 2 configured grants is done using a DCI command, which can either deactivate a single configured grant configuration or multiple configured grant configurations jointly, for example, for example, if more than one Type 2 configured grant is configured. The network may ensure that an active configured uplink grant on SUL does not overlap in time with another active configured uplink grant on the other UL configuration, for example, for example, if SUL is configured.

For both dynamic grant and configured grant, two or more repetitions may be in one slot, or across slot boundary in consecutive available slots with each repetition in one slot for a transport block. For both dynamic grant and configured grant Type 2, the quantity (e.g., number) of repetitions may be also dynamically indicated in the L1 signaling. The dynamically indicated quantity (e.g., number) of repetitions may override the RRC configured quantity (e.g., number) of repetitions, for example, if both are present.

There are at least two types of transmission without dynamic grant:
configured grant Type 1 where an uplink grant may be provided by RRC, and stored as configured uplink grant;
configured grant Type 2 where an uplink grant may be provided by PDCCH, and stored or cleared as configured uplink grant based on L1 signaling indicating configured uplink grant activation or deactivation.

CG Type 1 and CG Type 2 may be configured by RRC for a Serving Cell per BWP. Multiple configurations may be active simultaneously in the same BWP. For Type 2, activation and deactivation may be independent among the Serving Cells. For the same BWP, the wireless device (e.g., UE/MAC entity) may be configured with both Type 1 and Type 2.

RRC may configure the following parameters, for example, if the configured grant Type 1 is configured: cs-RNTI: CS-RNTI for retransmission; periodicity: periodicity of the configured grant Type 1; timeDomainOffset: offset of a resource with respect to SFN=timeReferenceSFN in time domain; timeDomainAllocation: allocation of configured uplink grant in time domain which contains startSymbolAndLength or startSymbol; nrofHARQ-Processes: the quantity (e.g., number) of HARQ processes for configured grant; harq-ProcID-Offset: offset of HARQ process for configured grant configured with cg-RetransmissionTimer for operation with shared spectrum channel access; harq-ProcID-Offset2: offset of HARQ process for configured grant not configured with cg-RetransmissionTimer; timeReferenceSFN: SFN used for determination of the offset of a resource in time domain. The wireless device (e.g., UE) may use the closest SFN with the indicated quantity (e.g., number) preceding the reception of the configured grant configuration.

RRC may configure the following parameters, for example, if the configured grant Type 2 is configured: cs-RNTI: CS-RNTI for activation, deactivation, and retransmission; periodicity: periodicity of the configured grant Type 2; nrofHARQ-Processes: the quantity (e.g., number) of HARQ processes for configured grant; harq-ProcID-Offset: offset of HARQ process for configured grant configured with cg-RetransmissionTimer for operation with shared spectrum channel access; harq-ProcID-Offset2: offset of HARQ process for configured grant not configured with cg-RetransmissionTimer.

A wireless device (e.g., UE/MAC entity), upon configuration of a configured grant Type 1 for a BWP of a Serving Cell by upper layers, may store the uplink grant provided by upper layers as a configured uplink grant for the indicated BWP of the Serving Cell; and/or may initialize/re-initialize the configured uplink grant to start in the symbol according to timeDomainOffset, timeReferenceSFN, and S (e.g., derived from startSymbolAndLengh (SLIV) or provided by startSymbol), and to reoccur with periodicity.

A wireless device (e.g., UE/MAC entity) may consider sequentially that the Nth (N>=0) uplink grant occurs in the symbol, after an uplink grant is configured for a configured grant Type 1/Type 2. The wireless device (e.g., UE/MAC entity) may consider the uplink grants occur in those additional PUSCH, for example, if cg-nrofPUSCH-InSlot or cg-nrofSlots is configured for a configured grant Type 1 or Type 2. All the corresponding configurations may be released and all corresponding uplink grants may be cleared, for example, if the configured uplink grant is released by upper layers/RRC/NW. The wireless device (e.g., UE/MAC entity), for a configured grant Type 2, may clear the configured uplink grant(s) immediately after first transmission of Configured Grant Confirmation MAC CE or Multiple Entry Configured Grant Confirmation MAC CE which confirms the configured uplink grant deactivation.

An information element (e.g., IE ConfiguredGrantConfig) may be used to configure uplink transmission without dynamic grant according to two possible schemes. The actual uplink grant may either be configured via RRC (type1) or provided via the PDCCH (addressed to CS-RNTI) (type2). Multiple Configured Grant configurations may be configured in one BWP of a serving cell.

PUSCH transmission(s) may be dynamically scheduled by an UL grant in a DCI, or the transmission can correspond to a configured grant Type 1 or Type 2. The configured grant Type 1 PUSCH transmission may be semi-statically configured to operate upon the reception of higher layer parameter of configuredGrantConfig including rrc-ConfiguredUplinkGrant without the detection of an UL grant in a DCI. The configured grant Type 2 PUSCH transmission may be semi-persistently scheduled by an UL grant in a valid activation DCI after the reception of higher layer parameter configuredGrantConfig not including rrc-ConfiguredUplinkGrant. More than one configured grant configuration of configured grant Type 1 and/or configured grant Type 2 may be active at the same time on an active BWP of a serving cell, for example, if configuredGrantConfigToAddModList is configured.

16 HARQ processes per cell, for uplink, may be supported by a wireless device (e.g., UE), or subject to a wireless device (e.g., UE) capability, a maximum of 32 HARQ processes per cell. The quantity (e.g., number) of processes, which the wireless device (e.g., UE) may assume, may at most be used for the uplink is configured to the wireless device (e.g., UE) for each cell separately by higher layer parameter nrofHARQ-ProcessesForPUSCH, and/or the wireless device (e.g., UE) may assume a default quantity (e.g., number) of 16 processes, for example, if no configuration is provided.

The following higher layer parameters may be applied in the transmission, for example, if PUSCH resource allocation is semi-statically configured by higher layer parameter configuredGrantConfig in BWP-UplinkDedicated information element, and the PUSCH transmission corresponding to a configured grant:
The following parameters, for Type 1 PUSCH transmissions with a configured grant, may be given in configuredGrantConfig unless mentioned otherwise:
   PUSCH repetition type B, for the determination of the PUSCH repetition type, may be applied, for example, if the higher layer parameter pusch-RepTypeIndicator in rrc-ConfiguredUplinkGrant is configured and set to ‘pusch-RepTypeB’; otherwise, PUSCH repetition type A may be applied;
   The selection of the time domain resource allocation table, for PUSCH repetition type A, may follow the rules for DCI format 0_0 on UE specific search space.
   The selection of the time domain resource allocation table, for PUSCH repetition type B, may be as follows: pusch-TimeDomainAllocationListDCI-0-1 in pusch-Config may be used, for example, if pusch-RepTypelndicatorDCI-0-1 in pusch-Config is configured and set to ‘pusch-RepTypeB’; Otherwise, pusch-TimeDomainAllocationListDCI-0-2 in pusch-Config may be used. It may not be expected that pusch-RepTypeIndicator in rrc-ConfiguredUplinkGrant is configured with ‘pusch-RepTypeB’ when none of pusch-RepTypelndicatorDCI-0-1 and pusch-RepTypelndicatorDCI-0-2 in pusch-Config is set to ‘pusch-RepTypeB’.
   The higher layer parameter timeDomainAllocation value may provide a row index m+1 pointing to the determined time domain resource allocation table.
For Type 2 PUSCH transmissions with a configured grant: the resource allocation may follow the higher layer configuration, and UL grant received on the DCI.
   The PUSCH repetition type and the time domain resource allocation table may be determined by the PUSCH repetition type and the time domain resource allocation table associated with the UL grant received on the DCI, respectively. The value of Koffset, if configured, may be applied, for example, if determining the first transmission opportunity.

A quantity (e.g., number) of (nominal) repetitions K to be applied to the sent (e.g., transmitted) transport block, for PUSCH transmissions with a Type 1 or Type 2 configured grant, may be provided by the indexed row in the time domain resource allocation table, for example, if numberOfRepetitions is present in the table; otherwise K is provided by the higher layer configured parameters repK. The wireless device (e.g., UE) may not send (e.g., transmit) anything on the resources configured by configuredGrantConfig, for example, if the higher layers did not deliver a transport block to send (e.g., transmit) on the resources allocated for uplink transmission without grant.

A set of allowed periodicities P may be defined. The higher layer parameter cg-nrofSlots, may provide the quantity (e.g., number) of consecutive slots allocated within a configured grant period. The higher layer parameter cg-nrofPUSCH-InSlot may provide the quantity (e.g., number) of consecutive PUSCH allocations within a slot, where the first PUSCH allocation may follow the higher layer parameter timeDomainAllocation for Type 1 PUSCH transmission or the higher layer configuration, and UL grant received on the DCI for Type 2 PUSCH transmissions, and the remaining PUSCH allocations may have the same length and PUSCH mapping type, and may be appended following the previous allocations without any gaps. The same combination of start symbol and length and PUSCH mapping type may repeat over the consecutively allocated slots.

Uplink grant may be either received dynamically on the PDCCH, in a Random Access Response, configured semi-persistently by RRC or determined to be associated with the PUSCH resource of Message (MSG) A. The wireless device (e.g., UE/MAC entity) may have an uplink grant to send (e.g., transmit) on the UL-SCH. The wireless device (e.g., the UE/MAC layer) may receive HARQ information from lower layers of the wireless device (e.g., UE) to perform the requested transmissions. An uplink grant addressed to CS-RNTI with NDI=0 may be considered as a configured uplink grant. An uplink grant addressed to CS-RNTI with NDI=1 may be considered as a dynamic uplink grant.

The maximum quantity (e.g., number) of transmissions of a TB within a bundle of the dynamic grant or configured grant or the uplink grant received in a MAC Random Access Response (RAR) may be given by REPETITION_NUMBER as follows:
REPETITION_NUMBER, for a dynamic grant, may be set to a value provided by lower layers;
REPETITION_NUMBER, for a configured grant, may be set to a value provided by lower layers;
REPETITION_NUMBER, for an uplink grant received in a MAC RAR, may be set to a value provided by lower layers.

At most REPETITION_NUMBER−1 HARQ retransmissions, after the first transmission within a bundle, may follow within the bundle, for example, if REPETITION_NUMBER>1. Bundling operation, for both dynamic grant and configured uplink grant, and uplink grant received in a MAC RAR, may rely on the HARQ entity for invoking the same HARQ process for each transmission that is part of the same bundle. Within a bundle, HARQ retransmissions may be triggered without waiting for feedback from previous transmission according to REPETITION_NUMBER for a dynamic grant or configured uplink grant or uplink grant received in a MAC RAR unless they are terminated. Each transmission within a bundle may be a separate uplink grant delivered to the HARQ entity.

Sequence of redundancy versions, for each transmission within a bundle of the dynamic grant or uplink grant received in a MAC RAR, may be determined according to TS 38.214. For each transmission within a bundle of the configured uplink grant, the sequence of redundancy versions may be determined according to TS 38.214. A timer may be started at the beginning of the first symbol of the PUSCH transmission, for example, if the timer (e.g., configuredGrantTimer or cg-RetransmissionTimer or cg-Small Data Transmission (SDT)-RetransmissionTimer) is started or restarted by a PUSCH transmission.

HARQ Process ID, for configured uplink grants neither configured with harq-ProcID-Offset2 nor with cg-RetransmissionTimer, may be associated with the first symbol of a UL transmission, and may be derived from the following equation: HARQ Process Index (ID)=[floor(CURRENT_symbol/periodicity)] modulo nrofHARQ-Processes.

HARQ Process ID associated with the first symbol of a UL transmission, for configured uplink grants with harq-ProcID-Offset2, may be derived from the following equation: HARQ Process ID=[floor(CURRENT_symbol/periodicity)] modulo nrofHARQ-Processes+harq-ProcID-Offset2. Where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the quantity (e.g., number) of consecutive slots per frame and the quantity (e.g., number) of consecutive symbols per slot, respectively.

Wireless device (e.g., UE) implementation, for configured uplink grants configured with cg-RetransmissionTimer, may select an HARQ Process ID among the HARQ process IDs available for the configured grant configuration. The wireless device (e.g., UE), for HARQ Process ID selection, may prioritize the HARQ Process ID with the highest priority, for example, if the wireless device (e.g., UE/MAC entity) is configured with intraCG-Prioritization, where the priority of HARQ process may be determined by the highest priority among priorities of the logical channels that are multiplexed (e.g., the packet data unit to send (e.g., transmit) is already stored in the HARQ buffer) or have data available that can be multiplexed (e.g., the packet data unit to send (e.g., transmit) is not stored in the HARQ buffer) in the packet data unit, according to the mapping restrictions.

A wireless device (e.g., UE), for HARQ Process ID selection among initial transmission and retransmission with equal priority, may prioritize retransmissions before initial transmissions, for example, if the MAC entity is configured with intraCG-Prioritization. The priority of a HARQ Process for which no data for logical channels is multiplexed or can be multiplexed in the packet data unit may be lower than the priority of a HARQ Process for which data for any logical channels is multiplexed or can be multiplexed in the packet data unit. The wireless device (e.g., UE), for HARQ Process ID selection, may prioritize retransmissions before initial transmissions, for example, if the wireless device (e.g., UE/MAC entity) is not configured with intraCG-Prioritization. The wireless device (e.g., UE) may toggle the New Data Indicator (NDI) in the Configured Grant-Uplink Control Information (CG-UCI) for new transmissions and not toggle the NDI in the CG-UCI in retransmissions. A current symbol parameter (e.g., CURRENT_symbol) may refer to the symbol index of the first transmission occasion of a bundle of configured uplink grant.

A HARQ process may be configured for a configured uplink grant where neither harq-ProcID-Offset nor harq-ProcID-Offset2 is configured, for example, if the configured uplink grant is activated and the associated HARQ process ID is less than nrofHARQ-Processes. A HARQ process may be configured for a configured uplink grant where harq-ProcID-Offset2 is configured, for example, if the configured uplink grant is activated and the associated HARQ process ID is greater than or equal to harq-ProcID-Offset2 and less than sum of harq-ProcID-Offset2 and nrofHARQ-Processes for the configured grant configuration. The quantity (e.g., number) of parallel UL HARQ processes per HARQ entity may be specified in TS 38.214.

Each HARQ process may support one TB. Each HARQ process may be associated with a HARQ process identifier. HARQ process identifier 0, for UL transmission with UL grant in RA Response or for UL transmission for MSGA payload, may be used. Each HARQ process may be associated with a HARQ buffer.

New transmissions may be performed on the resource and with the MCS indicated on PDCCH or indicated in the Random Access Response (i.e. MAC RAR or fallbackRAR), or signalled in RRC or determined for MSGA payload. Retransmissions may be performed on the resource and, if provided, with the MCS indicated on PDCCH, or on the same resource and with the same MCS as was used for last made transmission attempt within a bundle, or on stored configured uplink grant resources and stored MCS, for example, if cg-RetransmissionTimer or cg-SDT-RetransmissionTimer is configured. Retransmissions with the same HARQ process may be performed on any configured grant configuration, for example, if cg-RetransmissionTimer is configured and the configured grant configurations have the same TBS.

The UE/HARQ process may: store the packet data unit in the associated HARQ buffer, store the uplink grant received from the HARQ entity, and/or generate a transmission as described below, for example, if the UE/HARQ entity request a new transmission for a TB. The UE/HARQ process may: store the uplink grant received from the HARQ entity, and/or generate a transmission as described below, for example, if the UE/HARQ entity requests a retransmission for a TB.

Extended Reality (XR) may refer to all real-and-virtual combined environments and human-machine interactions generated by computer technology and wearables. XR may be an umbrella term for different types of realities: Virtual reality (VR), Augmented reality (AR), Mixed reality (MR)

Virtual reality (VR) may be a rendered version of a delivered visual and audio scene. The rendering may be designed to mimic the visual and audio sensory stimuli of the real world as naturally as possible to an observer or user as they move within the limits defined by the application. Virtual reality may, but not necessarily, require a user to wear a head mounted display (HMD), to completely replace the user's field of view with a simulated visual component, and to wear headphones, to provide the user with the accompanying audio. Some form of head and motion tracking of the user in VR may be also necessary to allow the simulated visual and audio components to be updated in order to ensure that, from the user's perspective, items and sound sources remain consistent with the user's movements.

Augmented reality (AR) may be providing a user with additional information or artificially generated items or content overlaid upon their current environment. Such additional information or content may be visual and/or audible and their observation of their current environment may be direct, with no intermediate sensing, processing and rendering, or indirect, where their perception of their environment may be relayed via sensors and may be enhanced or processed.

Mixed reality (MR) may be an advanced form of AR where some virtual elements are inserted into the physical scene with the intent to provide the illusion that these elements are part of the real scene.

Other terms used in the context of XR may be Immersion as the sense of being surrounded by the virtual environment as well as Presence providing the feeling of being physically and spatially located in the virtual environment. The sense of presence may provide significant minimum performance requirements for different technologies such as tracking, latency, persistency, resolution and optics.

This application may use the acronym XR throughout to refer to equipment, applications and functions used for VR, AR and MR. Examples may include, but are not limited to HMDs for VR, optical see-through glasses and camera see-through HMDs for AR and MR and mobile devices with positional tracking and camera. They may all offer some degree of spatial tracking and the spatial tracking results in an interaction to view some form of virtual content.

Many of the XR and CG use cases may be characterized by quasi-periodic traffic (with possible jitter) with high data rate in DL (i.e., video steam) combined with the frequent UL (i.e., pose/control update) and/or UL video stream. Both DL and UL traffic may also be characterized by relatively strict packet delay budget (PDB). Hence, there may be a need to study and potentially specify possible solutions to better support such challenging services, i.e., by better matching the non-integer periodicity of traffic, such as 60/90/120 frames per second to the NR signaling.

Many of the end user XR and CG devices may be expected to be mobile and of small-scale, thus having limited battery power resources. Therefore, additional power enhancements may be needed to reduce the overall wireless device (e.g., UE) power consumption, for example, if running XR and CG services, and to extend the effective wireless device (e.g., UE) battery lifetime. Release 17 Study Item on “XR evaluations” may identify that the current DRX configurations do not fit well for (i) the non-integer XR traffic periodicity, (ii) variable XR data rate and (iii) quasi-periodic XR periodicity, hence enhancements would be beneficial in this area.

The set of anticipated XR and CG services having a certain variety and characteristics of the data streams (i.e., video) may change “on-the-fly”, for example, if the services are running over NR. Therefore, additional information on the running services from higher layers may be beneficial to facilitate informed choices of radio parameters.

Table 1 shows example XR traffics characteristics.

TABLE 1

| | Period (ms) | | | | | Packet | | | Packet |
|---|---|---|---|---|---|---|---|---|---|
| | | | (60fps - | | Rate | size | | | success |
| Traffic | (120fps) | (90fps) | baseline) | Jitter | (Mb/s) | (kbytes) | Direction | PDB | rate |
| Video | 8.33333 | 11.1111 | 16.66667 | +/−4 ms | 45 | 93.7 +/− | DL & UL | 10 ms | 99% |
| | | | | | | 50% | | (baseline DL), | |
| | | | | | | | | 30 ms UL | |

| | | | | | | | |
|---|---|---|---|---|---|---|---|
| Audio + | 10 | 0 | 1.12 | 1.4 | DL & UL | 30 ms | 99% |
| data | | | | | | | |
| Pose/ | 4 | 0 | 0.025 | 100 bytes | UL | 10 ms | 99% |
| control | | | | | | | |

XR content may be represented in different formats, e.g. panoramas or spheres depending on the capabilities of the capture systems. Projection may be used for conversion of a spherical (or 360°) video into a two-dimensional rectangular video before the encoding stage, since modern video coding standards are not designed to handle spherical content. The obtained two-dimensional rectangular image, after projection, may be partitioned into regions (e.g. front, right, left, back, top, bottom) that can be rearranged to generate “packed” frames to increase coding efficiency or viewport dependent stream arrangement.

The frame rate for XR video may vary from 15 frames per second up to 90 or even 120 frames per second, with a typical minimum of 60 for VR. The latency of action of the angular or rotational vestibulo-ocular reflex may be known to be of the order of 10 ms or in a range from 7-15 milliseconds and may seem reasonable that this should represent a performance goal for XR systems. The latency of action results in a motion-to-photon latency of less than 20 milliseconds, with 10 ms being given as a goal. Between 10 and 200 Mbps regarding the bit rates may be expected for XR depending on frame rate, resolution and codec efficiency.

Audio may be distinguished from channel-based and object-based representations. Channel-based representation may use multiple microphones to capture sounds from different directions and post-processing techniques may be known in the industry, as they have been the standard for decades. Object-based representations may represent a complex auditory scene as a collection of single audio elements, each comprising an audio waveform and a set of associated parameters or metadata. The metadata may embody the artistic intent by specifying the transformation of each of the audio elements to playback by the final reproduction system. Sound objects may generally use monophonic audio tracks that have been recorded or synthesized through a process of sound design. These sound elements may be further manipulated, so as to be positioned in a horizontal plane around the listener, or in full three-dimensional space using positional metadata.

Users may be more accustomed to the relatively slower speed of sound compared to that of light, and therefore tolerant of sound being relatively delayed with respect to the video component than sound being relatively in advance of the video component. Recent studies may have led to recommendations of an accuracy of between 15 ms (audio delayed) and 5 ms (audio advanced) for the synchronization, with recommended absolute limits of 60 ms (audio delayed) and 40 ms (audio advanced) for broadcast video.

XR applications require highly accurate, low-latency tracking of the device at about 1 kHz sampling frequency to maintain a reliable registration of the virtual world with the real world, as well as to ensure accurate tracking of the XR Viewer pose. The size of a XR Viewer Pose associated to time, typically results in packets of size in the range of 30-100 bytes, such that the generated data may be around several hundred kbit/s, for example, if delivered over the network. Pose information may have to be delivered with ultra-high reliability, therefore, similar performance as Ultra Reliable and Low Latency Communications (URLLC) is expected i.e. packet loss rate should be lower than 10E-4 for uplink sensor data.

XR-Awareness, in both uplink and downlink, may contribute to optimizations of base station (e.g., gNB) radio resource scheduling and relies at least on the notions of packet data unit Set and Data Burst (specified in Technical Report (TR) 23.700): a packet data unit Set may be composed of one or more packet data units carrying the payload of one unit of information generated at the application level (e.g. a frame or video slice), for example, if a Data Burst is a set of data packet data units generated and sent by the application in a short period of time. A Data Burst may be composed of multiple packet data units belonging to one or multiple packet data unit Sets. A packet data unit set may be considered as successfully delivered when all packet data units of a packet data unit Set are delivered successfully.

The following information may be provided by the CN to RAN (e.g., such as specified in TR 23.700) to assist the handling of QoS flows and packet data units. Semi-static information for both UL and DL may be provided via control plane (NGAP). Semi-static information for both UL and DL may be provided via control plane (NGAP). The semi-static information may comprise, for example, one or more of: periodicity for UL and DL traffic of the QoS flow; traffic jitter; Traffic jitter information (e.g., jitter range) associated with each periodicity of the QoS flow; PDU Set QoS parameters; PDU Set Error Rate (PSER); PDU Set Delay Budget (PSDB); and/or PDU Set Integrated Indication (PSII). Dynamic information for DL may be provided by user plane (GTP-U header). The dynamic information may comprise, for example, at least one or more of: PDU Set Sequence Number; PDU Set Size in bytes; PDU SN within a PDU Set; End PDU of the PDU Set; PDU Set Importance (this parameter may be used to identify the importance of a PDU Set within a QoS flow. RAN may use it for PDU Set level packet discarding in presence of congestion); and/or End of Data Burst indication in the header of the last PDU of the Data Burst.

A wireless device (e.g., UE), for the uplink XR traffic, may need to be able to identify PDU Set and Data Bursts dynamically but in-band marking over Uu of packet data units is not needed. The remaining packet data units of that packet data unit set may no longer be needed by the application and may be subject to discard operation, for example, if a certain quantity (e.g., number) of packet data units of a packet data unit set are known to be required by the application layer to use the corresponding unit of information (for instance due to the absence or limitations of error concealment techniques, see TR 26.926), and the quantity (e.g., number) of packet data units known to be lost exceeds this quantity (e.g., number).

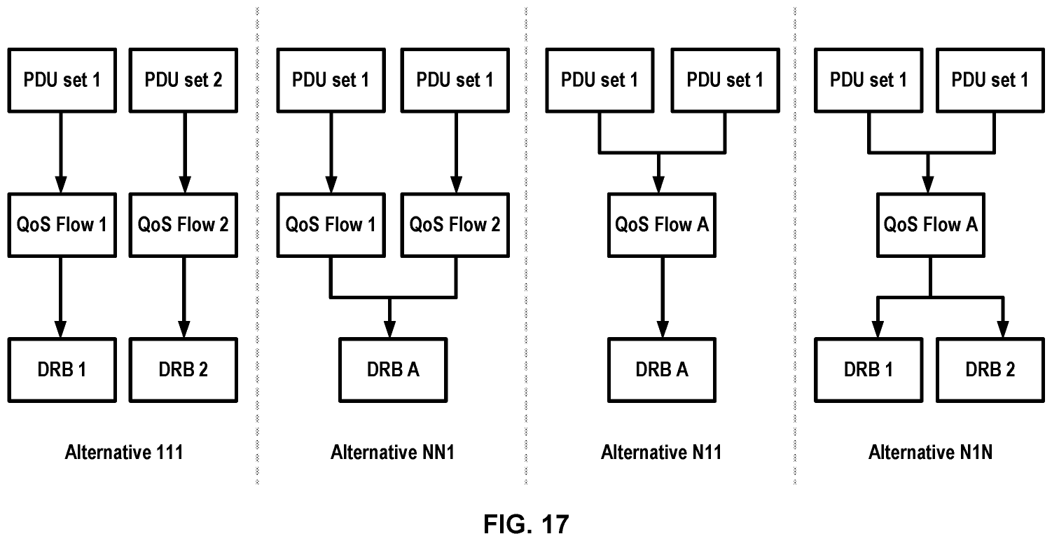

Depending on how the mapping of packet data unit sets onto QoS flows is done in the NAS and how QoS flows are mapped onto Data Radio Bearers (DRBs) in the AS can be distinguished to the following alternatives (as depicted on FIG. 17):
111: one-to-one mapping between types of packet data unit sets and QoS flows in the NAS and one-to-one mapping between QoS flows and DRBs in the AS.
NN1: one-to-one mapping between types of packet data unit sets and QoS flows in the NAS and possible multiplexing of QoS flows in one DRB in the AS.
N11: possible multiplexing of types of packet data unit sets in one QoS flow in the NAS and one-to-one mapping between QoS flows and DRBs in the AS.
N1N: possible multiplexing of types of packet data unit sets in one QoS flow in the NAS and demultiplexing of types of packet data unit sets from one QoS flow on multiple DRBs in the AS.
   When comparing these alternatives, a QoS flow may not be mapped onto multiple DRBs in the uplink, which may exclude alternative N1N.

The notion of packet data unit set may not impact the granularity of one or more of: SDAP SDU handling (SDAP may map every incoming SDU to a single PDU for a single PDCP entity); and/or Retransmissions (HARQ may rely on MAC PDUs and ARQ on RLC PDUs). Enhancements for configured grant based transmission may be recommended. The enhancements, for example, may comprise at least one or more of: multiple CG PUSCH transmission occasions in a period of a single CG PUSCH configuration; and/or dynamic indication of unused CG PUSCH occasion(s) based on UCI (e.g., CG-UCI or a new UCI) by the UE. Improvements may be envisioned in order to enhance the scheduling of uplink resources for XR. The improvements, for example, may comprise one or more of: one or more additional Base Station (BS) table(s), delay knowledge of buffered data, additional BSR triggering conditions, and/or delivery of some assistance information (e.g., periodicity). The one or more additional Base Station (BS) table(s) may be used to reduce the quantization errors in BSR reporting (e.g. for high bit rates). The delay knowledge of buffered data (e.g., comprising remaining time) may distinguish how much data is buffered for which delay, and may be determined whether the delay information is reported as part of Buffer Status Report (BSR) or as a new MAC Control Element (CE). Also, how the delay information can be up to date considering (e.g., scheduling and transmission delays) needs to be investigated further. Additional BSR triggering conditions may allow timely availability of buffer status information being investigated further. Additional mechanism for delivery of some assistance information (e.g., periodicity) may be further considered with an assumption that all information may not be always available at wireless device (e.g., UE) application.

For PDCP discard operation in uplink, the timer-based discard operation (when configured) may apply to all SDUs/packet data units belonging to the same packet data unit set. Furthermore, all remaining packet data units of that packet data unit set may be discarded at the transmitter to free up radio resources, for example, if the quantity (e.g., number) of packet data units known to either be lost or associated to discarded SDUs exceeds a threshold.

Data may be an UL data and/or a DL data. The data may be one or more packet data unit, one or more packet data unit sets, one or more SDU, one or more IP packet, and/or a data burst. The packet data unit may be a SDAP PDU, PDCP PDU, RLC PDU, packet data unit (PDU). The SDU may be a SDAP SDU, PDCP SDU, RLC SDU, MAC SDU, PHY SDU (e.g., TB).

A set of multiple packet data units generated and sent by the application in a short period of time as data burst. The data burst may be composed by one or multiple packet data unit sets.

A packet data unit (PDU) set may be composed of one or more packet data units carrying the payload of one unit of information generated at the application level (e.g., a frame or video slice for Extended Reality and media (XRM) Services, as used in TR 26.926). All packet data units in a PDU Set may be needed by the application layer to use the corresponding unit of information. The application layer may still recover parts all or of the information unit, for example, if some packet data units are missing.

PDU Set Error Rate (PSER) may define an upper bound for the rate of PDU Sets that have been processed by the sender of a link layer protocol but that are not successfully delivered by the corresponding receiver to the upper layer (specified in TR 23.700-60). PDU Set Delay Budget (PSDB) may define time between reception of the first packet data unit and the successful delivery of the last arrived packet data unit of a PDU Set (see TR 23.700-60). PDU Set Integrated Indication (PSII) may define whether all packet data units are needed for the usage of PDU Set by application layer.

At least some terms referenced herein may be used interchangeable. For example, the terms “UE” and “wireless device” may be used interchangeably. The terms “gNB”, “eNB,” “BS”, “NW” and “base station” may be used interchangeably. The upper layer of the wireless device (e.g., UE) may be SDAP, RRC, PDCP, RLC, and/or MAC layer. The lower layer of the wireless device (e.g., UE) may be PHY layer. The terms “periodic”, “periodicity”, “CG periodic”, “CG periodicity”, and “periodicity of CG” may be used interchangeably. The terms “ID”, “index”, and “identifier” may be used interchangeably. The terms “determine”, “derive”, “detect”, “consider” may be used interchangeably. The terms “configure” and “indicate” may be used interchangeably. The terms “equation”, “formula”, and “pre-defined rule” may be used interchangeably.

The configured grant resource occasion (CGO) may be referred to as a CG PUSCH occasion. The CGO may be referred to as a CG resource. The CGO may be referred to as a CG resource occasion. The CGO may be a resource indicated (configured) by a CG configuration (type1 or type 2). The CGO may be an UL resource (e.g., used for sending/transmitting UL data). The CGO may be an UL resource of a PUSCH. The CGO may be a resource within a CG period. The CGO may be a transmission opportunity. The CG resources/CGO may occur or reoccur sequentially based on SFN (e.g., system frame quantity/number), numberOfSlotsPerFrame, numberOfSymbolsPerSlot, slot quantity (e.g., number) in the frame, symbol quantity (e.g., number) in the slot, timeReferenceSFN, numberOfSlotsPerFrame, timeDomainOffset, S (e.g., symbol quantity/number), N (e.g., Nth period/cycle), periodicity, and/or a time offset (e.g., the interval between each CGO).

For example, the next/following/subsequent CG resources/CGO(s) may occur or reoccur based on a first formula:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot).

The wireless device (e.g., UE) may determine one or more CGOs based on the CG resource(s) that occur based on the first formula. The one or more CGOs may occur after the next/following/subsequent CG resource(s) with a time offset. Configuration parameters, that the wireless device (e.g., UE) receives from a BS, may indicate the time offset. Configuration parameters, that the wireless device receives from a BS, may indicate a time interval between two consecutive CGOs of the one or more CGOs. The wireless device may determine, based on the configuration parameters, the one or more CGOs after the next/following/subsequent CG resource(s) with a time offset. The wireless device (e.g., UE) may determine the CG resources/CGO based on scheduling information (e.g., K2 (slot offset), SLIV (startSymbolAndLengh), repK, MCS, and/or PUSCH mapping type).

An unused CGO is an CGO that wireless device (e.g., UE) determines as a grant or resource available for UL transmission and determines not to use for the UL transmission, e.g., due to no more data to be sent (e.g., transmitted) via the CGO. The unused CGO may refer to as an CGO that the wireless device (e.g., UE) does not use and/or skips for UL transmission. For example, the disclosure of the wireless device (e.g., UE) not using an unused CGO for transmission may indicate that the wireless device (e.g., UE) not using an CGO (e.g., referred to as the unused CGO) the transmission. The disclosure of the wireless device (e.g., UE) skipping an unused CGO may indicate that the wireless device (e.g., UE) skipping an CGO (e.g., referred to as the unused CGO). The wireless device (e.g., UE) may prevent from (use of) the unused CGO for (UL) transmission. The wireless device (e.g., UE) may clear the unused CGO (e.g., clear a grant and/or resource associated with the unused CGO). The wireless device (e.g., UE) may deactivate the unused CGO (e.g., deactivate a grant and/or resource associated with the unused CGO). The wireless device (e.g., UE) may suspend the unused CGO (e.g., suspend a configuration, a grant and/or resource associated with the unused CGO). The wireless device (e.g., UE) may determine that an CGO is invalid and/or unavailable (to be used for transmission), e.g., if the CGO is the unused CGO. The wireless device (e.g., UE/MAC entity) may not deliver the grant (e.g., CG) and the associated/respective HARQ information to the HARQ entity, for example, if the grant (e.g., CG) is associated with the unused CGO. The wireless device (e.g., UE) may determine the grant (e.g., CG) as a skipped grant and/or de-prioritized grant, for example, if the grant (e.g., CG) is associated with the unused CGO. The wireless device (e.g., UE) may not generate a data (e.g., packet data unit) (for the HARQ entity), for example, if the grant is associated with the unused CGO.

The wireless device (e.g., UE) may receive and/or send (e.g., transmit) an indication of one or more unused CGOs. The indication may be referred to as an unused CGO indication. The unused CGO indication may be a dynamic indication (e.g., sent/transmitted via UCI) of the unused CG PUSCH occasion(s). A wireless device (e.g., UE) may trigger a transmission of the unused CGO indication and/or send (e.g., transmit) the unused CGO indication, e.g., based on the triggering the transmission of the unused CGO indication. The wireless device (e.g., UE) may send (e.g., transmit) the unused CGO indication via UCI (e.g., CG-UCI and/or a UCI for XR) and/or MAC CE. The wireless device (e.g., UE) may send (e.g., transmit) the unused CGO indication via PUSCH and/or PUCCH. The wireless device (e.g., UE) may send (e.g., transmit) the unused CGO indication via UL resource (e.g., CG resource and/or UL resource scheduled by a DCI). The unused CGO indication may indicate whether one or more CG resources will be unused. The unused CGO indication may indicate which CG resources are unused CGO. The BS may reallocate the unused CGO to other wireless devices (e.g., UEs).

Multiple CGOs within a CG period: The multiple CGOs within a single CG period may be referred to multiple CG PUSCH resource/transmission occasions in a period of a single CG PUSCH configuration. The multiple CGOs within a CG period may imply that the wireless device (e.g., UE) is indicated by (configured with) a plurality of CG resource occasions within a CG period. For example, the UE may be configured with a number/cluster of CG (PUSCH) resource occasions in each CG periodic/cycle. The periodicity of CG (PUSCH) resource occasions within a number/cluster of CG (PUSCH) resource occasions may be configured based on the arrival times of PDUs/PDU sets in a data burst and/or some delay requirements. The periodicity between a number/clusters of CG (PUSCH) resource occasions may be configured based on the periodicity of PDU set/data bursts.

CG grants may be periodic grants that occur with a periodicity that is referred to as a CG period. The CG period may be referred to as the periodicity of CG. The CG period may be determined based on a configuration parameter “periodicity” indicated (configured) by a configured grant configuration. The CG period (periodicity) may be used for UL transmission without UL grant for type 1 and type 2. The following periodicities may be supported depending on the configured subcarrier spacing [in the time unit symbols]:
15 kHz: 2, 7, n*14, where n={1, 2, 4, 5, 8, 10, 16, 20, 32, 40, 64, 80, 128, 160, 320, 640}
30 kHz: 2, 7, n*14, where n={1, 2, 4, 5, 8, 10, 16, 20, 32, 40, 64, 80, 128, 160, 256, 320, 640, 1280}
60 kHz with normal CP 2, 7, n*14, where n={1, 2, 4, 5, 8, 10, 16, 20, 32, 40, 64, 80, 128, 160, 256, 320, 512, 640, 1280, 2560}
60 kHz with ECP: 2, 6, n*12, where n={1, 2, 4, 5, 8, 10, 16, 20, 32, 40, 64, 80, 128, 160, 256, 320, 512, 640, 1280, 2560}
120 kHz: 2, 7, n*14, where n={1, 2, 4, 5, 8, 10, 16, 20, 32, 40, 64, 80, 128, 160, 256, 320, 512, 640, 1024, 1280, 2560, 5120}
480 and 960 kHz: n*14, where n={1, 2, 4, 5, 8, 10, 16, 20, 32, 40, 64, 80, 128, 160, 256, 320, 512, 640, 1024, 1280, 2560, 5120}

A wireless device (e.g., UE) may determine multiple CGOs within/per a CG period. The multiple CGOs within a single CG period may be referred to as multiple CG PUSCH resource/transmission occasions in a period of a single CG PUSCH configuration. The multiple CGOs within a CG period may imply that the wireless device (e.g., UE) is indicated by (configured with) a plurality of CG resource occasions within a CG period. For example, the wireless device (e.g., UE) may be configured with a number/cluster of CG (PUSCH) resource occasions in each CG periodic/cycle. The periodicity of CG (PUSCH) resource occasions within a number/cluster of CG (PUSCH) resource occasions may be configured based on the arrival times of packet data units/packet data unit sets in a data burst and/or some delay requirements. The periodicity between a number/clusters of CG (PUSCH) resource occasions may be configured based on the periodicity of packet data unit set/data bursts.

XR flows may have complex traffic patterns. For example, a video stream may consist of periodic bursts of packet data units instead of individual packet data units. Such new traffic patterns may require enhancements to the technology of CG configuration and procedure since a single CG with technology of CG configuration may not be able to efficiently support XR traffic. As a result, multiple CG PUSCH resource/transmission occasions in a period of a single CG PUSCH configuration (e.g., referred to as multiple CGO in a CG period in the present application) may be needed. Some enhancements may be introduced for a new CG configuration pattern which could match XR's traffic pattern. For example, the wireless device may be configured with (e.g., the wireless device may receive configuration parameter(s) indicating) a number/cluster of CG (PUSCH) resource occasions in each CG periodic/cycle. The periodicity of CG (PUSCH) resource occasions within a number/cluster of CG (PUSCH) resource occasions may be configured based on the arrival times of packet data units/packet data unit sets in a data burst and/or some delay requirements. The periodicity between a number/clusters of CG (PUSCH) resource occasions may be configured based on the periodicity of packet data unit set/data bursts.

A (single) DCI scheduling multiple PUSCH may be used to allocate multiple CG resource occasions with single CG configurations in a CG periodicity. NW may send (e.g., transmit) the DCI scheduling multi-PUSCH resource occasions as activation DCI for a CG configuration. Then, scheduled multiple PUSCH resource occasions may be obtained as CG PUSCH resource occasions in the first period and wireless device may repeat those CG PUSCH resource occasions in every CG period. The wireless device may be configured with (e.g., the wireless device may receive configuration parameter(s) indicating) multiple CG resource occasions by (RRC) parameters, e.g., cg-nrofPUSCH-InSlot and/or cg-nrofSlots. With these parameters, multiple PUSCH occasions may be configured in a slot, and such slots can be configured at the beginning of each period.

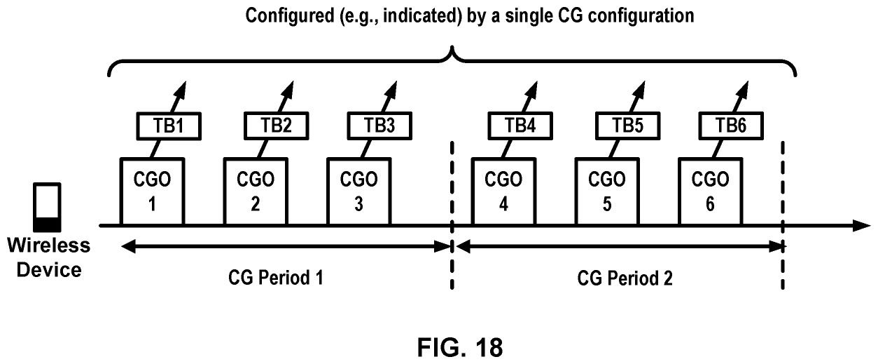

A quantity (e.g., number) of CG resource occasions for different TBs may be allocated. Each CG PUSCH resource occasion (CGO) within the same CG period, as shown in FIG. 18, may be used for a new transmission of a new TB.

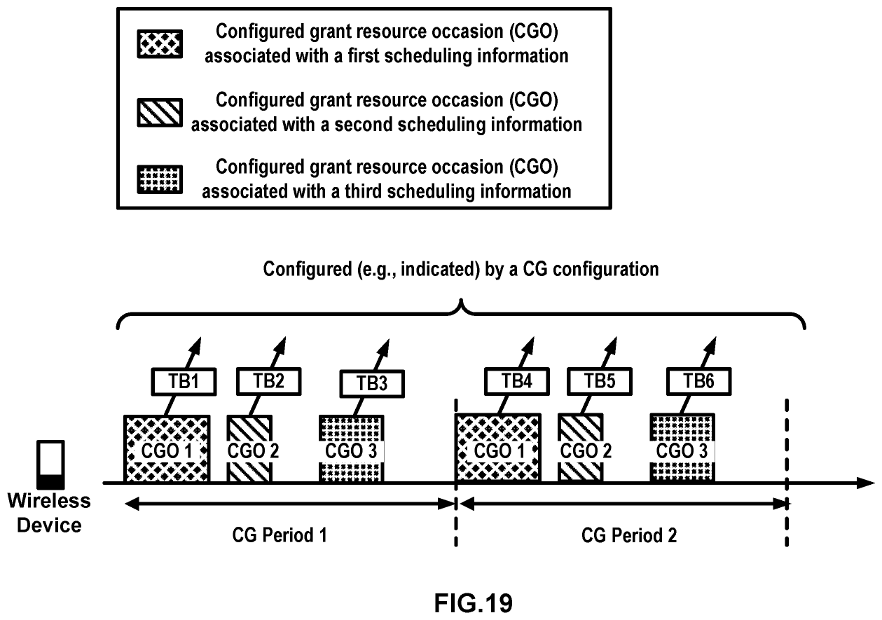

Each CGO within a CG period, as shown in FIG. 19, may be configured by separate scheduling information (e.g., K2 (slot offset), SLIV (startSymbolAndLengh), repK, MCS, and/or PUSCH mapping type). NW/RRC, in type 1 CG, may configure multiple configuration parameters (e.g., timeDomainAllocation and/or timeDomainOffset), e.g., via a list, for the multiple CGOs within a CG period. RRC, in type 2 CG, may configure multiple lists of configuration parameter sets (e.g., timeDomainAllocation and/or timeDomainOffset), and DCI may indicate one of the configured lists (e.g., by DCI TDRA field), to activate the CG configuration, for the multiple CGOs within a CG period.

Multiple CG PUSCH resource occasions, given the large size of the UL video frames, may be configured across multiple TTIs per CG period to deliver the same video frame over the UL. Data/frame sizes, for UL video streams, are relatively large and may change over time, for example, if CG resources are semi-statically configured by RRC or exposed by activation DCI. Dynamic adjustment of CG resources may be implemented to efficiently use CG resources to accommodate UL video packets. Assuming CG resources are configured according to the average size of XR frames, one method may be to notify the NW early enough to get more resources, for example, if the next XR frame is larger than the configured size. This method may become more difficult considering the scenario where the size of the next XR frame is smaller than the configured CG resource. Fewer CG PUSCH resources may be required to serve the XR traffic. Some configured CG resource may not be used by the wireless device (e.g., UE). A dynamic indication of the unused CG PUSCH occasion(s) (may be referred to as unused CGO indication), e.g., based on a UCI, by the wireless device (e.g., UE) may be supported to dynamically recycle unused resources to avoid resource wastage (and to increase the system capacity),

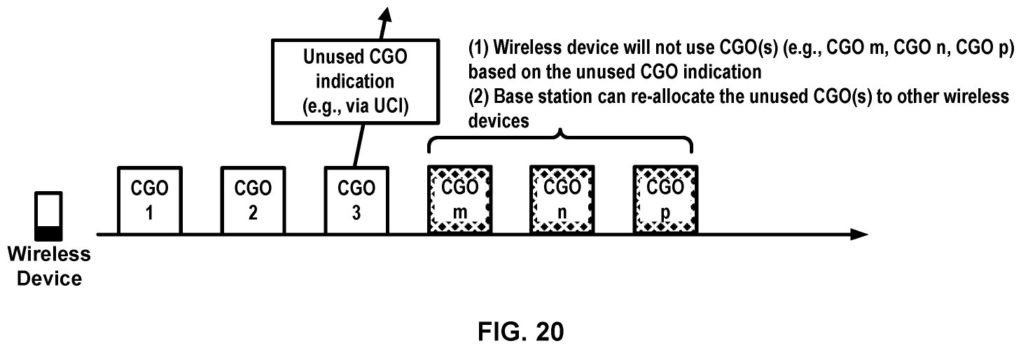

A wireless device (e.g., UE), as shown in FIG. 20, may not use one or more CG PUSCH resources (e.g., CGO m, CGO n, CGO p), for example, if the wireless device (e.g., UE) send/transmit the unused CGO indication (e.g., via UCI). For example, the wireless device (e.g., UE) may skip the unused CG PUSCH resources for UL transmission (based on/in response to the unused CGO indication). The unused CGO indication may be sent (e.g., transmitted) from the wireless device to the BS, via CGO 1, CGO 2, CGO3, and/or other UL resources. The resource may be released, recycled, and/or reallocated for other users or other traffic, for example, if the BS is aware of the unused resource, e.g., based on/in response to receiving the unused CGO indication.

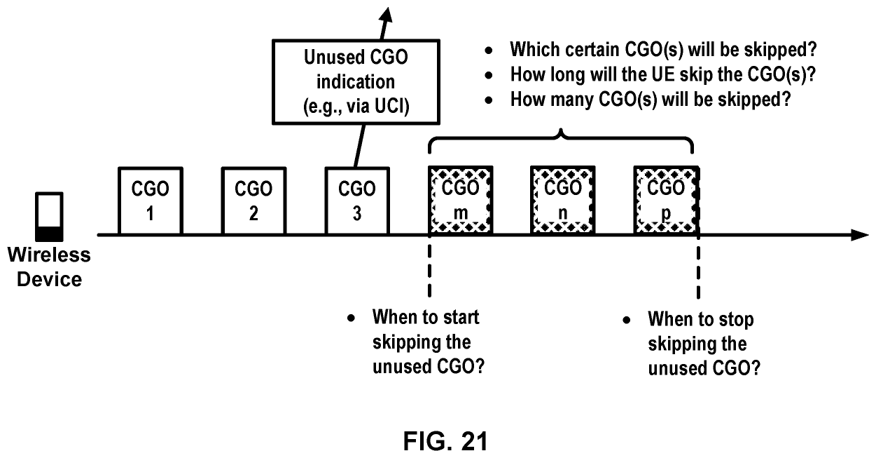

CG resource in at least some wireless communications may start in a time resource and to reoccur with periodicity (e.g., the CG resources may occur and reoccur sequentially in time domain), for example, if the wireless device (e.g., UE) is configured with (e.g., indicated by) configured uplink grant and/or the wireless device (e.g., UE) initializes/re-initializes/activates the CG. The objective of the unused CGO indication may indicate, by the wireless device (e.g., UE), that one or more CG resources will not be used by the wireless device (e.g., UE), so that the BS can reallocate the unused CG resources to other wireless devices (e.g., UEs). The wireless device (e.g., UE) and the BS may need to have the same understanding on which CG resources will not be used (e.g., be skipped) by a certain wireless device (e.g., UE). The unused CGO indication in the wireless communication technologies may cause different understanding between the wireless device (e.g., UE) and the BS which unused CG resources may be skipped by the wireless device (e.g., UE) (e.g., since the unused CGO indication in the wireless communication technologies doesn't indicate how many CGOs will be unused). FIG. 21 shows an example of problems with at least some wireless communications. For example, if the wireless device (e.g., UE) will start skipping the unused CG resources, the following may be uncertain/unknown:
how long will the wireless device (e.g., UE) keep skipping the unused CG resources?
how many unused CG resources will be skipped by the wireless device (e.g., UE)? and/or
when the wireless device (e.g., UE) will stop skipping the unused CG resources?

The above issues should be resolved, or it may cause the misalignment between the wireless device (e.g., UE) and the BS on the unused resource. The BS may not reallocate the resources to other wireless devices (e.g., UEs) efficiently, which will result in poor scheduling performance and reduce the system capacity. Examples described herein may resolve one or more of these and/or other problems. A report (e.g., UCI) may comprise a bitmap indicating which CGO will be unused. The report may sent from the wireless device to the base station. Based on the report, the base station may efficiently relocate the resources to other wireless devices.

A wireless device (e.g., UE) may be configured with (e.g., indicated by) one or more CG configurations (e.g., based on configuration parameters ConfiguredGrantConfigIndex, ConfiguredGrantConfigIndexMAC, ConfiguredGrantConfig, configuredGrantConfigToAddModList, and/or configuredGrantConfigToReleaseList). The wireless device (e.g., UE) may activate/initialize one or more CGs among the one or more CG configurations. The wireless device (e.g., UE) may initialize or re-initialize the configured uplink grant (for a Serving Cell) to start in the associated PUSCH duration and to recur sequentially with periodicity, for example, if the wireless device (e.g., UE) receives contents indicate configured grant Type 2 activation. The wireless device (e.g., UE/MAC entity), upon configuration of a configured grant Type 1 for a BWP of a Serving Cell, may initialize or re-initialize the configured uplink grant to start in the symbol according to timeDomainOffset, timeReferenceSFN, and S (derived from SLIV or provided by startSymbol and to reoccur sequentially with periodicity.

A wireless device (e.g., UE) may be configured with (e.g., indicated by) a configuration for multiple CGO within a CG period. The configuration for multiple CGO within a CG period may be enabled and/or with value true. The configuration for unused CGO indication may be enabled and/or with value true. The configuration for multiple CGO within a CG period may be included in a CG configuration, a PUSCH configuration, a (UL)BWP configuration, a serving cell configuration, a MAC entity configuration, and/or a PHY layer configuration. The wireless device (e.g., UE) may apply the function of the unused CGO indication, for example, if the wireless device (e.g., UE) is configured with (and/or enabled and/or with value true) the configuration for multiple CGO within a CG period. The wireless device (e.g., UE) may not apply the function of the unused CGO indication, for example, if the wireless device (e.g., UE) is not configured with (and/or disabled and/or with value false) the configuration for multiple CGO within a CG period.

A wireless device (e.g., UE) may indicate it supports the capability of unused CGO indication (e.g., by sending the UECapabilityInformation message which includes a parameter of unused CGO indication). The wireless device (e.g., UE) may apply the function of the unused CGO indication, for example, if the wireless device (e.g., UE) indicates it supports the capability of unused CGO indication. The wireless device (e.g., UE) may not apply the function of the unused CGO indication, for example, if the wireless device (e.g., UE) does not indicate it supports the capability of unused CGO indication.

As described herein, a wireless device (e.g., UE) may be configured with (e.g., indicated by) a configuration for unused CGO indication. The configuration for unused CGO indication may be enabled and/or with value true. The configuration for the unused CGO indication may be included in a CG configuration, a PUSCH configuration, a (UL)BWP configuration, a serving cell configuration, a MAC entity configuration, and/or a PHY layer configuration.

A wireless device (e.g., UE) may apply the function of the unused CGO indication for example, if the wireless device (e.g., UE) is configured with (and/or enabled and/or with value true) the configuration for unused CGO indication. The wireless device (e.g., UE) may not apply the function of the unused CGO indication, for example, if the wireless device (e.g., UE) is not configured with (and/or disabled and/or with value false) the configuration for unused CGO indication. Unused CGO indication may be sent (e.g., transmitted) via an UL resource/UL channel. The unused CGO indication may be sent (e.g., transmitted) via PUCCH, PUSCH, and/or PRACH. The unused CGO indication may be sent (e.g., transmitted) by a UCI (e.g., CG-UCI or a UCI for XR), a MAC CE, and/or a RRC signaling.

A wireless device (e.g., UE) may determine the size/quantity/number of the multiple fields (e.g., the size of the bitmap) of the unused CGO indication based on the quantity (e.g., number) of the CGOs (configured within a CG period.) The wireless device (e.g., UE) may determine the size/quantity/number of the multiple fields (e.g., the size of the bitmap) based on the remaining/subsequent/following CGOs within a CG period after sending (e.g., transmitting) the unused CGO indication. The wireless device (e.g., UE) may determine the size/quantity/number of the multiple fields (e.g., the size of the bitmap) based on a (RRC) configuration parameter. The (RRC) configuration parameter may be included in a CG configuration, a configuration for unused CGO indication and/or a configuration for multiple CGOs within a CG period.) The wireless device (e.g., UE) may determine the size/quantity/number of the multiple fields (e.g., the size of the bitmap) based on how many number of CGOs will be unused/skipped.

A wireless device (e.g., UE) may send (e.g., transmit) the unused CGO periodically and/or dynamically (e.g., if the wireless device (e.g., UE) triggers the transmission of the unused CGO indication). The wireless device (e.g., UE) may send (e.g., transmit) the unused CGO indication in each CG period and or in a certain period configured by a configuration parameter. The wireless device (e.g., UE) may send (e.g., transmit) the unused CGO no matter whether any unused CGO is determined or not. The wireless device (e.g., UE) may send (e.g., transmit) the unused CGO indication, for example, if the wireless device (e.g., UE) triggers the transmission of the unused CGO indication. The wireless device (e.g., UE) may send (e.g., transmit) the unused CGO indication, for example, if the wireless device (e.g., UE) determines there is unused CGO and (e.g., when there is no data needs to be sent/transmitted). The wireless device (e.g., UE) may not send (e.g., transmit) the unused CGO indication, for example, if the wireless device (e.g., UE) does not determine there is unused CGO (e.g., if there is data needs to be sent/transmitted).

Unused CGO indication may be sent (e.g., transmitted) via a UL resource (e.g., CG resource). The unused CGO indication may be sent (e.g., transmitted) via a first CGO of the multiple CGOs within a CG period. The unused CGO indication may be sent (e.g., transmitted) via a last CGO of the multiple CGOs within a CG period. The unused CGO indication may be sent (e.g., transmitted) via any CGO of the multiple CGOs within a CG period.

A wireless device (e.g., UE) may be configured with multiple CGOs within a CG period. The wireless device (e.g., UE) may select a first CGO among the multiple CGOs within a CG period to send (e.g., transmit) the unused CGO indication, for example, if the wireless device (e.g., UE) determine to send (e.g., transmit) the unused CGO indication.

A wireless device (e.g., UE) may be configured with multiple CGOs within a CG period. The wireless device (e.g., UE) may select a last CGO among the multiple CGOs within a CG period to send (e.g., transmit) the unused CGO indication, for example, if the wireless device (e.g., UE) determine to send (e.g., transmit) the unused CGO indication.

A wireless device (e.g., UE) may be configured with multiple CGOs within a CG period. The wireless device (e.g., UE) may select any CGO among the multiple CGOs within a CG period to send (e.g., transmit) the unused CGO indication, for example, if the wireless device (e.g., UE) determine to send (e.g., transmit) the unused CGO indication.

A wireless device (e.g., UE) may apply the function of the unused CGO indication within the same CG period (as the CG period that the unused CGO indication is sent (e.g., transmitted) on) and/or a next CG period after sending (e.g., transmitting) the unused CGO indication. The wireless device (e.g., UE) may send (e.g., transmit) the unused CGO indication within a first period of CG, and the wireless device (e.g., UE) may apply the unused CGO indication to the subsequent/following CGO(s) within the first period of CG.

A wireless device (e.g., UE) may send (e.g., transmit) the unused CGO indication within a first period of CG, and the wireless device (e.g., UE) may apply the unused CGO indication to the subsequent/following CGO(s) within a second period of CG, wherein the second period of CG may be a next period of CG from the first period of CG. The second period of CG may be one or more periods of CG after the first period of CG.

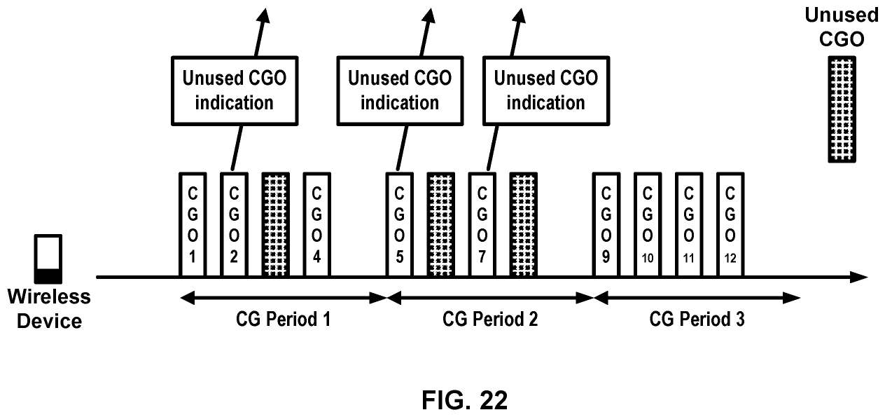

A wireless device (e.g., UE), as shown in FIG. 22, may send (e.g., transmit) one or more unused CGO indications. Each unused CGO indication may indicate a next/following/subsequent CG resource(s) will not be used (e.g., will be skipped) by the wireless device (e.g., UE). The next/following/subsequent CG resource(s) may be next one or more CG resource (s) occurs after sending (e.g., transmitting) the unused CGO indication.

Next/following/subsequent CG resource(s) may sequentially occur based on timeDomainOffset, timeReferenceSFN, and/or S (derived from SLIV or provided by startSymbol) and/or a time offset (e.g., an interval between each CGO). The next/following/subsequent CG resource(s) may sequentially occur based on SFN, numberOfSlotsPerFrame, numberOfSymbolsPerSlot, slot quantity (e.g., number) in the frame, symbol quantity (e.g., number) in the slot, imeReferenceSFN, umberOfSlotsPerFrame, timeDomainOffset, S, N, and/or periodicity. For example, the next/following/subsequent CG resource(s) may occur based on:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) \text{} modulo \text{} ( 1024 \times numberOfSlotsPerFrame \times numberOfSymbolsPerSlot ) .$$

A wireless device (e.g., UE) may determine to skip the next/following/subsequent CG resource(s), for example, if the wireless device (e.g., UE) sends (e.g., transmits) the unused CGO indication, wherein the next/following/subsequent CG resource(s) may occur based on SFN, numberOfSlotsPerFrame, numberOfSymbolsPerSlot, slot quantity (e.g., number) in the frame, symbol quantity (e.g., number) in the slot, imeReferenceSFN, umberOfSlotsPerFrame, timeDomainOffset, S, N, and/or periodicity. For example, the next/following/subsequent CG resource(s) may sequentially occur based on:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) \text{} modulo \text{} ( 1024 \times numberOfSlotsPerFrame \times numberOfSymbolsPerSlot ) .$$

A wireless device (e.g., UE), as shown in FIG. 22, may send (e.g., transmit) one or more unused CGO indications. Each unused CGO indication may indicate a next/following/subsequent CG resource(s) will not be used (e.g., will be skipped) by the wireless device (e.g., UE). The next/following/subsequent CG resource(s) may be determined based on multiple CGOs within a CG period. The wireless device (e.g., UE) may sends (e.g., transmits) the unused CGO indication via a first CGO, and/or the wireless device (e.g., UE) may skip the second CGO and/or the third CGO based on (e.g., in response to) sending (e.g., transmitting) the unused CGO indication, for example, if the configuration of multiple CGOs within a CG period indicates three CGOs within a CG period.

A wireless device (e.g., UE), as shown in FIG. 22, may send (e.g., transmit) one or more unused CGO indications. Each unused CGO indication may indicate a next/following/subsequent CG resource(s) will not be used (e.g., will be skipped) by the wireless device (e.g., UE). The next/following/subsequent CG resource(s) may be one or more CG resource (s) occurs within the same CG period (as the CG period that the unused CGO indication is sent (e.g., transmitted) on) and/or a next CG period after sending (e.g., transmitting) the unused CGO indication. The wireless device (e.g., UE) may send (e.g., transmit) the unused CGO indication within a first period of CG, and the wireless device (e.g., UE) may skip a next/following/subsequent CG resource(s) within the first period of CG, wherein the next/following/subsequent CG resource(s) may occur after sending (e.g., transmitting) the unused CGO indication.

A wireless device (e.g., UE) may send (e.g., transmit) the unused CGO indication within a first period of CG, and the wireless device (e.g., UE) may skip a next/following/subsequent CG resource(s) within a second period of CG, wherein the second period of CG may be a next period of CG of the first period of CG. The second period of CG may be one or more periods of CG after the first period of CG.

A wireless device (e.g., UE), as shown in FIG. 22, may send (e.g., transmit) one or more unused CGO indications. Each unused CGO indication may indicate a next/following/subsequent CG resource(s) will not be used (e.g., will be skipped) by the wireless device (e.g., UE). The next/following/subsequent CG resource(s) may be next one or more CG resource (s) occurs after a time period/offset from sending (e.g., transmitting) the unused CGO indication.

A wireless device (e.g., UE) may determine to skip the next/following/subsequent CG resource(s) after the time period/offset from the time of sending (e.g., transmitting) the unused CGO indication, for example, if the wireless device (e.g., UE) sends (e.g., transmits) the unused CGO indication. The wireless device (e.g., UE) may not skip the CG resources after the time of sending (e.g., transmitting) the unused CGO indication and before the time period/offset from the time of sending (e.g., transmitting) the unused CGO indication.

The time period/offset may be determined based on a quantity (e.g., number) of time unit. The time unit may be based on slot, symbol, subframe, system frame, millisecond, second, periodicity of CG, and/or DRX cycle. The quantity (e.g., number) of time unit may be pre-defined, and/or configured (indicated) by a configuration parameter (e.g., RRC configuration). The quantity (e.g., number) of time unit may be indicated by the wireless device (e.g., UE) (e.g., via the UCI (e.g., CG-UCI or a UCI for XR) and/or the unused CGO indication).

The time period/offset may be determined based on a time duration. The time duration may be pre-defined, and/or configured (indicated) by a configuration parameter (e.g., RRC configuration). The time duration may be indicated by the wireless device (e.g., UE) (e.g., via the UCI (e.g., CG-UCI or a UCI for XR) and/or the unused CGO indication).

The time period/offset may be determined based on a transmission delay. The transmission delay may be a delay for sending (e.g., transmitting) the unused CGO indication (e.g., via UCI (e.g., CG-UCI or a UCI for XR)). The transmission delay may be a delay based on the transmission time of the unused CGO indication (e.g., via UCI (e.g., CG-UCI or a UCI for XR)). The transmission delay may be pre-defined, and/or configured (indicated) by a configuration parameter (e.g., RRC configuration). The transmission delay may be indicated by the wireless device (e.g., UE) (e.g., via the UCI (e.g., CG-UCI or a UCI for XR) and/or the unused CGO indication).

The time period/offset may be determined based on an application delay/processing time. The application delay/processing time may be a delay for the wireless device (e.g., UE) and/or the BS to decode the unused CGO indication. The application delay/processing time may be pre-defined, and/or configured (indicated) by a configuration parameter (e.g., RRC configuration). The application delay/processing time may be indicated by the wireless device (e.g., UE) (e.g., via the UCI (e.g., CG-UCI or a UCI for XR) and/or the unused CGO indication).

The time period/offset may be determined based on a timer/time window. The timer/time window may be (re)started in response to sending (e.g., transmitting) the unused CGO indication. The wireless device (e.g., UE) may start skipping the unused CGO resource, for example, if/when/after the timer/time window expires and/or if/when/after the timer/time window is not running. The wireless device (e.g., UE) may not skip the CG resources, for example, if the timer/time window is running. The wireless device (e.g., UE) may stop the timer, for example, if the wireless device receives a signal from the BS. The wireless device (e.g., UE) may stop the timer, for example, if an UL data is in arrival.

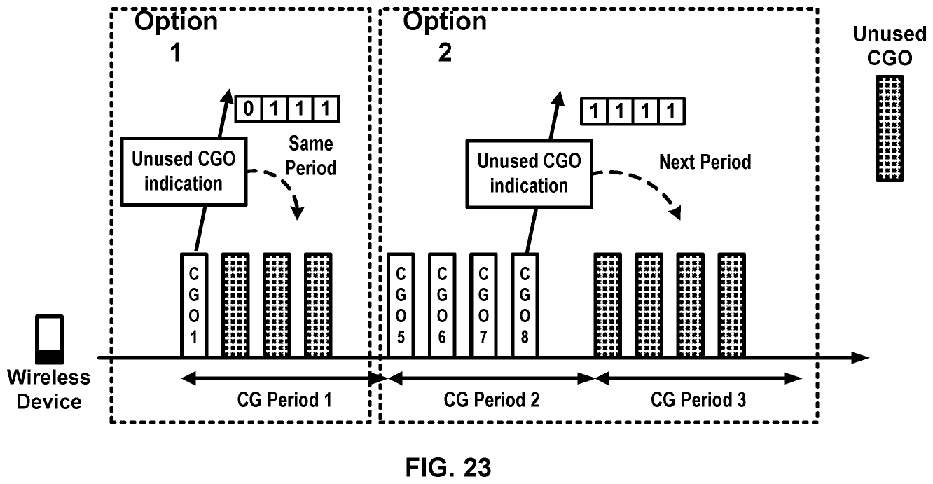

A wireless device (e.g., UE), as shown in FIG. 23, may send (e.g., transmit) one or more unused CGO indications. Each unused CGO indication may comprise multiple fields (e.g., based on a bitmap). Each field (e.g., each bit) may indicate one or more CG resource(s) will not be used (e.g., will be skipped) by the wireless device (e.g., UE). Each field of the unused CGO indication may indicate one CG occasion/resource (e.g., within a CG period), which will not be used (e.g., will be skipped) by the wireless device (e.g., UE). The one CG occasions/resource may be a next CG occasion/resource occurs after sending (e.g., transmitting) the unused CGO indication.

Each field of the unused CGO indication may indicate a plurality of CG occasion/resources (e.g., within the same CG period (as the CG period that the unused CGO indication is sent (e.g., transmitted) on) and/or within different CG periods). The quantity (e.g., number) of the plurality of CG occasion/resource may be configured by a configuration parameter. The quantity (e.g., number) of the plurality of CG occasion/resource may be based on a quantity (e.g., number) of multiple CGOs within a CG period. The quantity (e.g., number) of the plurality of CG occasion/resource may be indicated by the unused CGO indication.

Each field of the unused CGO indication may indicate a group of CG occasion/resources (e.g., within the same CG period (as the CG period that the unused CGO indication is sent/transmitted on) and/or within different CG periods). The group of the plurality of CG occasion/resource may be configured by a configuration parameter. The group of the plurality of CG occasion/resource may be based on a quantity (e.g., number) of multiple CGOs within a CG period. The group of the plurality of CG occasion/resource may be indicated by the unused CGO indication. Each field of the unused CGO indication may indicate all CG occasions/resources within the same CG period (as the CG period that the unused CGO indication is sent (e.g., transmitted) on).

A wireless device (e.g., UE), as shown in FIG. 23, may send (e.g., transmit) one or more unused CGO indications. Each unused CGO indication may comprise multiple fields (e.g., a bitmap). Each field (e.g., each bit) may indicate one or more CG resource(s) will not be used (e.g., will be skipped) by the wireless device (e.g., UE).

Each field may indicate the status of the CG resource by different values. The wireless device (e.g., UE) may skip the one or more CG resources, for example, if the field indicates a first value (e.g., 1) for one or more CG resources. The wireless device (e.g., UE) may not skip the one or more CG resources, for example, if the field indicates a second value (e.g., 0) for one or more CG resources.

A wireless device (e.g., UE), as shown in FIG. 23, may send (e.g., transmit) one or more unused CGO indications. Each unused CGO indication may comprise multiple fields (e.g., a bitmap). Each field (e.g., each bit) may indicate one or more CG resource(s) will not be used (e.g., will be skipped) by the wireless device (e.g., UE).

A quantity (e.g., number) of the multiple fields (e.g., the quantity/number of bits of the bitmap) may be based on the quantity (e.g., number) of multiple CGOs within a CG period. The quantity (e.g., number) of the multiple fields (e.g., the quantity/number of bits of the bitmap) may be configured by a configuration parameter (e.g., RRC configuration). The quantity (e.g., number) of the multiple fields (e.g., the quantity/number of bits of the bitmap) may be based on the quantity (e.g., number) of (active) CG configurations.

A wireless device (e.g., UE), as shown in FIG. 23, may send (e.g., transmit) one or more unused CGO indications. Each unused CGO indication may comprise multiple fields (e.g., a bitmap). Each field (e.g., each bit) may indicate one or more CG resource(s) will not be used (e.g., will be skipped) by the wireless device (e.g., UE).

A wireless device may receive configuration parameters (e.g., CG configuration indicating one or more CGOs) indicating in which CGO, e.g., within a CG period, the wireless device (e.g., UE) sends (e.g., transmits) an unused CGO indication for the CG period. The configuration parameters may indicate any CGO of the one or more CGOs, for example, if a transmission occasion via which the wireless device (e.g., UE) sends (e.g., transmits) the unused CGO indication. The configuration parameters may indicate Nth CGO (e.g., 1≤N≤M, M is a number of one or more CGOs within the CG period) among the one or more CGOs within the CG period, for example, if a transmission occasion via which the wireless device (e.g., UE) sends (e.g., transmits) the unused CGO indication.

FIG. 23 shows an example of transmission occasions that the wireless device (e.g., UE) may send (e.g., transmit) the unused CGO indication. Option 1 in FIG. 23 may be an example in which wireless device (e.g., UE) may send (e.g., transmit) (e.g., is configured by the configuration parameters to send (e.g., transmit)) the unused CGO indication via the first (firstly occurring CGO (e.g., 1st CGO) within a first CG period, and/or the wireless device (e.g., UE) may determine to un-use/skip the CGOs within the first CG (e.g., the same CG period as the one for sending (e.g., transmitting) the unused CGO indication). Option 2 in FIG. 23 may be an example in which wireless device (e.g., UE) may send (e.g., transmit) (e.g., is configured by the configuration parameters to send (e.g., transmit)) the unused CGO indication via the last CGO (e.g., Mth CGO) within a first CG period, and/or the wireless device (e.g., UE) may determine to unuse/skip the CGOs within a second CG (e.g., the next CG period of the first CG period that used for sending (e.g., transmitting) the unused CGO indication).

A wireless device (e.g., UE), in an example of Option 1 in FIG. 23, may be configured with multiple CGOs within a CG period. The wireless device (e.g., UE) may select a first CGO (e.g., firstly occurred CGO) among the multiple CGOs within a CG period to send (e.g., transmit) the unused CGO indication, for example, if the wireless device (e.g., UE) determines to send (e.g., transmit) the unused CGO indication. The configuration parameter that the wireless device (e.g., UE) receives may indicate that the transmission occasion that the wireless device (e.g., UE) sends (e.g., transmits) the unused CGO indication as the first CGO. The wireless device (e.g., UE) may determine to skip or not skip the CG resources for the same CG period (as the first CGO) based on the multiple fields (e.g., a bitmap), for example, if the unused CGO indication is sent (e.g., transmitted) via the first CGO of the CG period. The bitmap size (and/or a quantity (e.g., number) of fields) may be equal to or smaller than a quantity (e.g., number) of remaining CGOs after the first CGO in the same period.

A wireless device (e.g., UE), in an example of Option 2 in FIG. 23, may be configured with multiple CGOs within a CG period. The wireless device (e.g., UE) may select a last CGO among the multiple CGOs within a CG period to send (e.g., transmit) the unused CGO indication, for example, if the wireless device (e.g., UE) determines to send (e.g., transmit) the unused CGO indication. The configuration parameter that the wireless device (e.g., UE) receives may indicate that the transmission occasion that the wireless device (e.g., UE) sends (e.g., transmits) the unused CGO indication as the last CGO. The wireless device (e.g., UE) may determine to skip or not skip the CG resources for the next CG period based on the multiple fields (e.g., a bitmap), for example, if the unused CGO indication is sent (e.g., transmitted) via the first CGO of the CG period. The bitmap size (and/or a quantity (e.g., number) of fields) may be equal to or smaller than a quantity (e.g., number) of CGOs in the next CG period.

A wireless device (e.g., UE) may be configured with multiple CGOs within a CG period. The wireless device (e.g., UE) may select a particular (any) CGO which is not the first CGO among the multiple CGOs within a CG period to send (e.g., transmit) the unused CGO indication, for example, if the wireless device (e.g., UE) determines to send (e.g., transmit) the unused CGO indication. The wireless device (e.g., UE) may determine to skip or not skip the CG resources for the same CG period (as the first CGO) and/or next CG period based on the multiple fields (e.g., a bitmap), for example, if the unused CGO indication is sent (e.g., transmitted) via the particular CGO of the CG period.

A wireless device (e.g., UE), as shown in FIG. 23, may send (e.g., transmit) one or more unused CGO indications. Each unused CGO indication may comprise multiple fields (e.g., a bitmap). Each field (e.g., each bit) may indicate one or more CG resource(s) will not be used (e.g., will be skipped) by the wireless device (e.g., UE).

A wireless device (e.g., UE) may apply the function of the unused CGO indication within the same CG period (e.g., if the CG period that the unused CGO indication is sent (e.g., transmitted) on) and/or a next CG period after sending (e.g., transmitting) the unused CGO indication. The wireless device (e.g., UE) may send (e.g., transmit) the unused CGO indication within a first CG period, and the unused CGO indication which comprises the multiple fields (e.g., the bitmap) may indicate whether to unuse/skip the respective CG occasion/resources of the first CG period based on the multiple fields (e.g., the bitmap).

A wireless device (e.g., UE) may send (e.g., transmit) the unused CGO indication within a first CG period, and the unused CGO indication which comprises the multiple fields (e.g., the bitmap) may indicate whether to unuse/skip the respective CG occasion/resources of a second CG period based on the multiple fields (e.g., the bitmap), wherein the second period of CG may be a next period of CG of the first period of CG. The second period of CG may be one or more periods of CG after the first period of CG.

A wireless device (e.g., UE), as shown in FIG. 23, may send (e.g., transmit) one or more unused CGO indications. Each unused CGO indication may comprise multiple fields (e.g., a bitmap). Each field (e.g., each bit) may indicate one or more CG resource(s) will not be used (e.g., will be skipped) by the wireless device (e.g., UE).

A wireless device (e.g., UE) may determine to skip one or more CG resource(s) based on the multiple fields (e.g., a bitmap) (e.g., included in the unused CGO indication) after the time period/offset from the time of sending (e.g., transmitting) the unused CGO indication, for example, if the wireless device (e.g., UE) sends (e.g., transmits) the unused CGO indication. The wireless device (e.g., UE) may not skip the CG resources after the time of sending (e.g., transmitting) the unused CGO indication and before the time period/offset from the time of sending (e.g., transmitting) the unused CGO indication.

The time period/offset may be determined based on a quantity (e.g., number) of time unit. The time unit may be based on slot, symbol, subframe, system frame, millisecond, second, periodicity of CG, and/or DRX cycle. The quantity (e.g., number) of time unit may be pre-defined, and/or configured (indicated) by a configuration parameter (e.g., RRC configuration). The quantity (e.g., number) of time unit may be indicated by the wireless device (e.g., UE) (e.g., via the UCI (e.g., CG-UCI or a UCI for XR) and/or the unused CGO indication).

The time period/offset may be determined based on a time duration. The time duration may be pre-defined, and/or configured (indicated) by a configuration parameter (e.g., RRC configuration). The time duration may be indicated by the wireless device (e.g., UE) (e.g., via the UCI (e.g., CG-UCI or a UCI for XR) and/or the unused CGO indication).

The time period/offset may be determined based on a transmission delay. The transmission delay may be a delay for sending (e.g., transmitting) the unused CGO indication (e.g., via UCI (e.g., CG-UCI or a UCI for XR)). The transmission delay may be a delay based on the transmission time of the unused CGO indication (e.g., via UCI (e.g., CG-UCI or a UCI for XR)). The transmission delay may be pre-defined, and/or configured (indicated) by a configuration parameter (e.g., RRC configuration). The transmission delay may be indicated by the wireless device (e.g., UE) (e.g., via the UCI (e.g., CG-UCI or a UCI for XR) and/or the unused CGO indication).

The time period/offset may be determined based on an application delay/processing time. The application delay/processing time may be a delay for the wireless device (e.g., UE) and/or the BS to decode the unused CGO indication. The application delay/processing time may be pre-defined, and/or configured (indicated) by a configuration parameter (e.g., RRC configuration). The application delay/processing time may be indicated by the wireless device (e.g., UE) (e.g., via the UCI (e.g., CG-UCI or a UCI for XR) and/or the unused CGO indication).

The time period/offset may be determined based on a timer/time window. The timer/time window may be (re)started based on (e.g., in response to) sending (e.g., transmitting) the unused CGO indication. The wireless device (e.g., UE) may start skipping the unused CGO resource, for example, if/when/after the timer/time window expires and/or when/after the timer/time window is not running. The wireless device (e.g., UE) may not skip the CG resources while the timer/time window is running. The wireless device (e.g., UE) may stop the timer when receiving a signal from the BS. The wireless device (e.g., UE) may stop the timer when an UL data arrival.

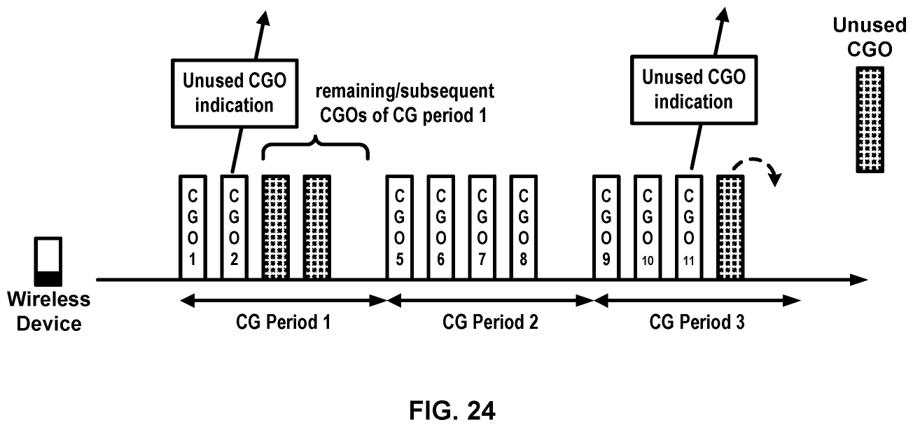

A wireless device (e.g., UE), as shown in FIG. 24, may send (e.g., transmit) an unused CGO indication via a CG period (e.g., a first CG period), and the unused CGO indication may indicate one or more remaining/subsequent CG resource(s) within the same CG period (e.g., the first CG period) will not be used (e.g., will be skipped) by the wireless device (e.g., UE), wherein the remaining/subsequent CG resources are CG resources after sending (e.g., transmitting) the unused CGO indication. The wireless device (e.g., UE) may not skip other CG resources within a CG period different from the first CG period (e.g., a next CG period/a second CG period).

The remaining/subsequent CG resource(s) may be one or more CG resources sequentially occur after sending (e.g., transmitting) the unused CGO indication (in time domain). The remaining/subsequent CG resource(s) may be CG resources sequentially occur within the same CG period (as the CG period that the unused CGO indication is sent (e.g., transmitted) on). The remaining/subsequent CG resource(s) may be CG resources sequentially occur based on the configuration of multiple CGO within a CG period.

The remaining/subsequent CG resource(s) may be CG resources sequentially occur based on SFN, numberOfSlotsPerFrame, numberOfSymbolsPerSlot, slot quantity (e.g., number) in the frame, symbol quantity (e.g., number) in the slot, imeReferenceSFN, umberOfSlotsPerFrame, timeDomainOffset, S, N, and/or periodicity. For example, the next/following/subsequent CG resource(s) may occur based on:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity) modulo (1024×numberOfSlotsPerFrame×numberOfSymbolsPerSlot).

A wireless device (e.g., UE), as shown in FIG. 24, may send (e.g., transmit) an unused CGO indication via a CG period (e.g., a first CG period), and the unused CGO indication may indicate one or more remaining/subsequent CG resource(s) within the same CG period (e.g., the first CG period) will not be used (e.g., will be skipped) by the wireless device (e.g., UE), wherein the remaining/subsequent CG resources may be CG resources after sending (e.g., transmitting) the unused CGO indication. The wireless device (e.g., UE) may not skip other CG resources within a CG period different from the first CG period (e.g., a next CG period/a second CG period).

A wireless device (e.g., UE) may determine whether to skip the remaining/subsequent CG resource(s) by indicating the unused CGO indication comprising a field with different values. The unused CCO indication may comprise a field with a first value to indicate that the wireless device (e.g., UE) will skip the remaining/subsequent CG resource(s). The unused CCO indication may comprise a field with a second value to indicate that the wireless device (e.g., UE) will not skip the remaining/subsequent CG resource(s).

A wireless device (e.g., UE) may determine whether to skip the remaining/subsequent CG resource(s) by sending (e.g., transmitting) or not sending (e.g., transmitting) the unused CGO indication. The wireless device (e.g., UE) may send (e.g., transmit) an unused CGO indication when the wireless device (e.g., UE) determine to skip the remaining/subsequent CG resource(s) of the CG period. The wireless device (e.g., UE) may not send (e.g., transmit) an unused CGO indication, for example, if the wireless device (e.g., UE) determine not to skip the remaining/subsequent CG resource(s) of the CG period.

A wireless device (e.g., UE), as shown in FIG. 24, may send (e.g., transmit) an unused CGO indication via a CG period (e.g., a first CG period), and the unused CGO indication may indicate one or more remaining/subsequent CG resource(s) within the same CG period (e.g., the first CG period) will not be used (e.g., will be skipped) by the wireless device (e.g., UE), wherein the remaining/subsequent CG resources may be CG resources after sending (e.g., transmitting) the unused CGO indication. The wireless device (e.g., UE) may not skip other CG resources within a CG period different from the first CG period (e.g., a next CG period/a second CG period).

A wireless device (e.g., UE) may be configured with multiple CGOs within a CG period. The wireless device (e.g., UE) may select a first CGO among the multiple CGOs within a CG period to send (e.g., transmit) the unused CGO indication, for example, if the wireless device (e.g., UE) determine to send (e.g., transmit) the unused CGO indication. The wireless device (e.g., UE) may determine to skip the one or more remaining/subsequent CG resource(s) within the same CG period (as the first CGO), for example, if the unused CGO indication is sent (e.g., transmitted) via the first CGO of the CG period.

A wireless device (e.g., UE) may be configured with multiple CGOs within a CG period. The wireless device (e.g., UE) may select a last CGO among the multiple CGOs within a CG period to send (e.g., transmit) the unused CGO indication, for example, if the wireless device (e.g., UE) determine to send (e.g., transmit) the unused CGO indication. The wireless device (e.g., UE) may determine to skip the one or more remaining/subsequent CG resource(s) within a next CG period, for example, if the unused CGO indication is sent (e.g., transmitted) via the first CGO of the CG period.

A wireless device (e.g., UE) may be configured with multiple CGOs within a CG period. The wireless device (e.g., UE) may select any CGO which is not the first CGO among the multiple CGOs within a CG period to send (e.g., transmit) the unused CGO indication, for example, if the wireless device (e.g., UE) determines to send (e.g., transmit) the unused CGO indication. The wireless device (e.g., UE) may determine to skip the one or more remaining/subsequent CG resource(s) within the same CG period (as the first CGO) and/or next CG period, for example, if the unused CGO indication is sent (e.g., transmitted) via the first CGO of the CG period.

A wireless device (e.g., UE), as shown in FIG. 24, may send (e.g., transmit) an unused CGO indication via a CG period (e.g., a first CG period), and the unused CGO indication may indicate one or more remaining/subsequent CG resource(s) within the same CG period (e.g., the first CG period) will not be used (e.g., will be skipped) by the wireless device (e.g., UE), wherein the remaining/subsequent CG resources may be CG resources after sending (e.g., transmitting) the unused CGO indication. The wireless device (e.g., UE) may not skip other CG resources within a CG period different from the first CG period (e.g., a next CG period/a second CG period).

The wireless device (e.g., UE) may determine to skip one or more remaining/subsequent CG resource(s) within the same CG period (e.g., the first CG period) after the time period/offset from the time of sending (e.g., transmitting) the unused CGO indication, for example, if the wireless device (e.g., UE) sends (e.g., transmits) the unused CGO indication via a CG period (e.g., a first CG period). The wireless device (e.g., UE) may not skip the CG resources after the time of sending (e.g., transmitting) the unused CGO indication and before the time period/offset from the time of sending (e.g., transmitting) the unused CGO indication.

The time period/offset may be determined based on a quantity (e.g., number) of time unit. The time unit may be based on slot, symbol, subframe, system frame, millisecond, second, periodicity of CG, and/or DRX cycle. The quantity (e.g., number) of time unit may be pre-defined, and/or configured (indicated) by a configuration parameter (e.g., RRC configuration). The quantity (e.g., number) of time unit may be indicated by the wireless device (e.g., UE) (e.g., via the UCI (e.g., CG-UCI or a UCI for XR) and/or the unused CGO indication).

The time period/offset may be determined based on a time duration. The time duration may be pre-defined, and/or configured (indicated) by a configuration parameter (e.g., RRC configuration). The time duration may be indicated by the wireless device (e.g., UE) (e.g., via the UCI (e.g., CG-UCI or a UCI for XR) and/or the unused CGO indication).

The time period/offset may be determined based on a transmission delay. The transmission delay may be a delay for sending (e.g., transmitting) the unused CGO indication (e.g., via UCI (e.g., CG-UCI or a UCI for XR)). The transmission delay may be a delay based on the transmission time of the unused CGO indication (e.g., via UCI (e.g., CG-UCI or a UCI for XR)). The transmission delay may be pre-defined, and/or configured (indicated) by a configuration parameter (e.g., RRC configuration). The transmission delay may be indicated by the wireless device (e.g., UE) (e.g., via the UCI (e.g., CG-UCI or a UCI for XR) and/or the unused CGO indication).

The time period/offset may be determined based on an application delay/processing time. The application delay/processing time may be a delay for the wireless device (e.g., UE) and/or the BS to decode the unused CGO indication. The application delay/processing time may be pre-defined, and/or configured (indicated) by a configuration parameter (e.g., RRC configuration). The application delay/processing time may be indicated by the wireless device (e.g., UE) (e.g., via the UCI (e.g., CG-UCI or a UCI for XR) and/or the unused CGO indication).

The time period/offset may be determined based on a timer/time window. The timer/time window may be (re)started in response to sending (e.g., transmitting) the unused CGO indication. The wireless device (e.g., UE) may start skipping the unused CGO resource when/after the timer/time window expires and/or when/after the timer/time window is not running. The wireless device (e.g., UE) may not skip the CG resources while the timer/time window is running. The wireless device (e.g., UE) may stop the timer when receiving a signal from the BS. The wireless device (e.g., UE) may stop the timer when an UL data arrival.

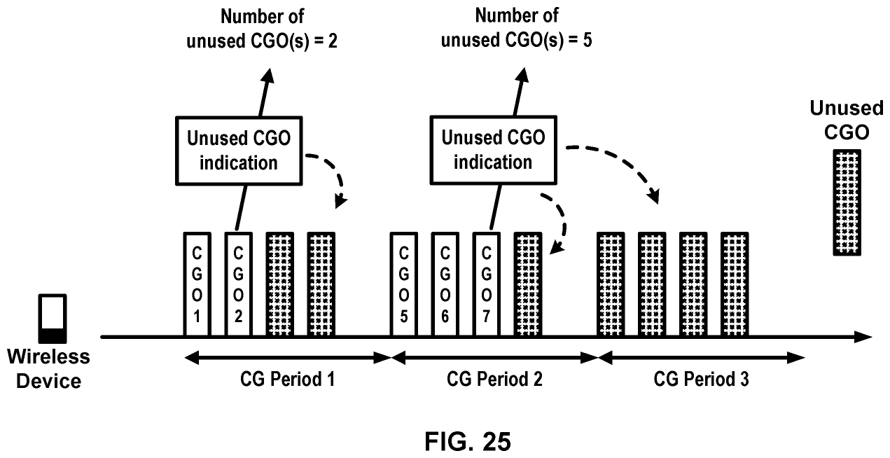

A wireless device (e.g., UE), as shown in FIG. 25, may determine to skip a quantity (e.g., number) of CG resources based on a value in response to sending (e.g., transmitting) an unused CGO indication. The value may be an integer number. The wireless device (e.g., UE) may skip two CG resources occur after sending (e.g., transmitting) the unused CGO indication, for example, if the value is two. The wireless device (e.g., UE) may skip five CG resources occur after sending (e.g., transmitting) the unused CGO indication, for example, if the value is five. The value may be a quantity (e.g., number) of time units (e.g., slot, symbol, subframe, system frame, millisecond, second, CG periodicity, DRX cycle). The wireless device (e.g., UE) may skip two slots of CG resources after sending (e.g., transmitting) the unused CGO indication, for example, if the value is two slots.

A value may be included in the unused CGO indication (e.g., via UCI (e.g., CG-UCI or a UCI for XR)). For example, a wireless device (e.g., UE) may send (e.g., transmit) an unused CGO indication comprising one or more fields to indicate a value for the quantity (e.g., number) of CG resources that will not be used (e.g., will be skipped) by the wireless device (e.g., UE). The wireless device (e.g., UE) may skip one or more CG resources based on the value. The wireless device (e.g., UE) may select one of multiple values configured by a (RRC) configuration parameter to indicate via the unused CGO indication. The configuration parameter may configure a set of values (e.g., three different values), and the wireless device (e.g., UE) may select one of three values to indicate via the unused CGO indication.

A value may be indicated by a configuration parameter (e.g., via RRC configuration). The value may be indicated by a DCI. The DCI may indicate one of multiple values configured by a (RRC) configuration parameter. The configuration parameter may configure a set of durations (e.g., three different durations), and the DCI may indicate one of three durations.

A wireless device (e.g., UE), as shown in FIG. 25, may determine to skip a quantity (e.g., number) of CG resources based on a value in response to sending (e.g., transmitting) an unused CGO indication. The quantity (e.g., number) of CG resources based on the value may be counted based on the quantity (e.g., number) of (CG) resource occasions. The quantity (e.g., number) of (CG) resource occasions may be indicated by a configuration for multiple CGOs within a CG period. The quantity (e.g., number) of CG resources based on the value may be counted based on the quantity (e.g., number) of (CG) time resources. The quantity (e.g., number) of CG resources based on the value may be counted based on the quantity (e.g., number) of transmission opportunities. The quantity (e.g., number) of CG resources based on the value may be counted based on the CG resource that occur or reoccur sequentially based on SFN, numberOfSlotsPerFrame, numberOfSymbolsPerSlot, slot quantity (e.g., number) in the frame, symbol quantity (e.g., number) in the slot, imeReferenceSFN, umberOfSlotsPerFrame, timeDomainOffset, S, N, and/or periodicity. For example, the next/following/subsequent CG resource(s) may occur based on:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) \text{} modulo \text{} ( 1024 \times numberOfSlotsPerFrame \times numberOfSymbolsPerSlot ) .$$

The quantity (e.g., number) of CG resources based on the value may be counted based on the quantity (e.g., number) of UL grants. The quantity (e.g., number) of CG resources based on the value may be counted based on the quantity (e.g., number) of time units of the CG resources (e.g., slot, symbol, subframe, system frame, millisecond, second, CG periodicity, DRX cycle).

A wireless device (e.g., UE), as shown in FIG. 25, may determine to skip a quantity (e.g., number) of CG resources based on a value in response to sending (e.g., transmitting) an unused CGO indication, wherein the value may be counted based on a counter. The wireless device (e.g., UE) may count the value of the quantity (e.g., number) of CG resources by incrementing or decreasing the value of the counter based on (e.g., in response to) skipping the CG resources. The wireless device (e.g., UE) may increment or decrease the value of the counter by 1, for example, if the wireless device (e.g., UE) skips one CG resource. The wireless device (e.g., UE) may not increment or decrease the value of the counter, for example, if the wireless device (e.g., UE) does not skip the CG resource. The wireless device (e.g., UE) may stop skipping the CG resources and/or the wireless device (e.g., UE) may reset the counter, for example, if the counter equals to zero or reaches to a (maximum) value.

The counter may be configured in a CG configuration. The counter may be configured in a configuration for multiple CGOs within a CG period. The counter may be configured in a configuration for unused CGO indication.

A wireless device (e.g., UE), as shown in FIG. 25, may determine to skip a quantity (e.g., number) of CG resources based on a value in response to sending (e.g., transmitting) an unused CGO indication, wherein the quantity (e.g., number) of CG resources may be associated with the same CG periodic (as the CG period that the unused CGO indication is sent (e.g., transmitted) on) and/or may be associated with different CG periodic. The quantity (e.g., number) of CG resources may be associated with the same CG period, for example, if the CG period that the unused CGO indication is sent (e.g., transmitted) on. The wireless device (e.g., UE) may skip two CG resource which are located within the same CG period (as the CG period that the unused CGO indication is sent (e.g., transmitted) on), for example, if the value indicates two CG resources.

A quantity (e.g., number) of CG resources may be associated with different CG periodic. The wireless device (e.g., UE) may skip five CG resource which are located within the same CG periodic (as the CG period that the unused CGO indication is sent (e.g., transmitted) on), for example, if the value indicates five CG resources. The wireless device (e.g., UE) may skip the four CG resources which are associated with the same CG periodic (as the CG period that the unused CGO indication is sent (e.g., transmitted) on) and not skip the one CG resource which is associated with the next CG periodic, for example, if there are four CG resources within the same CG periodic (as the CG period that the unused CGO indication is sent (e.g., transmitted) on) but one CG resource is associated with a next CG periodic.

A wireless device (e.g., UE), as shown in FIG. 25, may determine to skip a quantity (e.g., number) of CG resources based on a value in response to sending (e.g., transmitting) an unused CGO indication. The quantity (e.g., number) of CG resources based on a value may be one or more CG resource (s) occurs/counted within the same CG period (as the CG period that the unused CGO indication is sent (e.g., transmitted) on) and/or a next CG period after sending (e.g., transmitting) the unused CGO indication. The wireless device (e.g., UE) may send (e.g., transmit) the unused CGO indication within a first period of CG, and the wireless device (e.g., UE) may skip a quantity (e.g., number) of CG resources based on a value within the first period of CG.

A wireless device (e.g., UE) may send (e.g., transmit) the unused CGO indication within a first period of CG, and the wireless device (e.g., UE) may skip a quantity (e.g., number) of CG resources based on a value within a second period of CG, wherein the second period of CG may be a next period of CG of the first period of CG. The second period of CG may be one or more periods of CG after the first period of CG.

A wireless device (e.g., UE), as shown in FIG. 25, may determine to skip a quantity (e.g., number) of CG resources based on a value in response to sending (e.g., transmitting) an unused CGO indication. The wireless device (e.g., UE) may determine to skip a quantity (e.g., number) of CG resources after the time period/offset from the time of sending (e.g., transmitting) the unused CGO indication after the wireless device (e.g., UE) sends (e.g., transmits) the unused CGO indication. The wireless device (e.g., UE) may not skip the CG resources after the time of sending (e.g., transmitting) the unused CGO indication and before the time period/offset from the time of sending (e.g., transmitting) the unused CGO indication.

The time period/offset may be determined based on a quantity (e.g., number) of time unit. The time unit may be based on slot, symbol, subframe, system frame, millisecond, second, periodicity of CG, and/or DRX cycle. The quantity (e.g., number) of time unit may be pre-defined, and/or configured (indicated) by a configuration parameter (e.g., RRC configuration). The quantity (e.g., number) of time unit may be indicated by the wireless device (e.g., UE) (e.g., via the UCI (e.g., CG-UCI or a UCI for XR) and/or the unused CGO indication).

The time period/offset may be determined based on a time duration. The time duration may be pre-defined, and/or configured (indicated) by a configuration parameter (e.g., RRC configuration). The time duration may be indicated by the wireless device (e.g., UE) (e.g., via the UCI (e.g., CG-UCI or a UCI for XR) and/or the unused CGO indication).

The time period/offset may be determined based on a transmission delay. The transmission delay may be a delay for sending (e.g., transmitting) the unused CGO indication (e.g., via UCI (e.g., CG-UCI or a UCI for XR)). The transmission delay may be a delay based on the transmission time of the unused CGO indication (e.g., via UCI (e.g., CG-UCI or a UCI for XR)). The transmission delay may be pre-defined, and/or configured (indicated) by a configuration parameter (e.g., RRC configuration). The transmission delay may be indicated by the wireless device (e.g., UE) (e.g., via the UCI (e.g., CG-UCI or a UCI for XR) and/or the unused CGO indication).

The time period/offset may be determined based on an application delay/processing time. The application delay/processing time may be a delay for the wireless device (e.g., UE) and/or the BS to decode the unused CGO indication. The application delay/processing time may be pre-defined, and/or configured (indicated) by a configuration parameter (e.g., RRC configuration). The application delay/processing time may be indicated by the wireless device (e.g., UE) (e.g., via the UCI (e.g., CG-UCI or a UCI for XR) and/or the unused CGO indication).

The time period/offset may be determined based on a timer/time window. The timer/time window may be (re)started in response to sending (e.g., transmitting) the unused CGO indication. The wireless device (e.g., UE) may start skipping the unused CGO resource when/after the timer/time window expires and/or when/after the timer/time window is not running. The wireless device (e.g., UE) may not skip the CG resources while the timer/time window is running. The wireless device (e.g., UE) may stop the timer when receiving a signal from the BS. The wireless device (e.g., UE) may stop the timer when an UL data arrival.

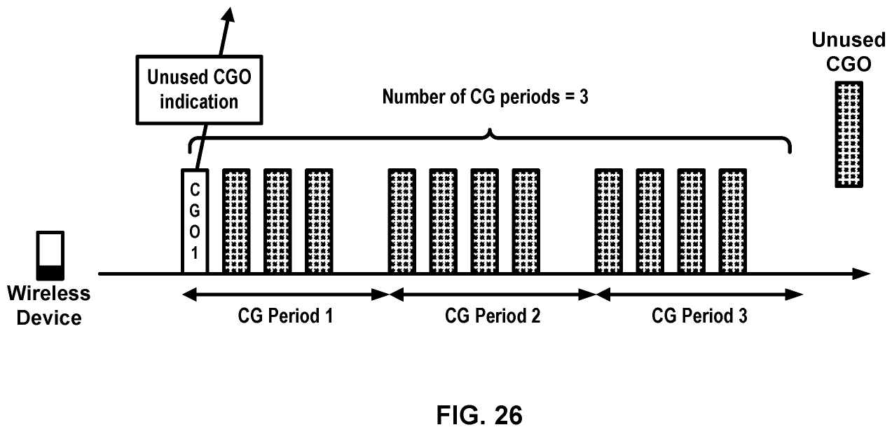

A wireless device (e.g., UE), as shown in FIG. 26, may send (e.g., transmit) one or more unused CGO indications. The wireless device (e.g., UE) may skip CG resources within a quantity (e.g., number) of one or more CG periods in response to sending (e.g., transmitting) the unused CGO indication.

CG period (periodicity) may be used for UL transmission without UL grant for type 1 and type 2. The CG period may be referred to as the periodicity of CG. The CG period may be determined based on a configuration parameter “periodicity” indicated (configured) by a configured grant configuration. The CG period (periodicity) may be used for UL transmission without UL grant for type 1 and type 2.

A quantity (e.g., number) of the one or more CG periods may be indicated (configured) by a configuration parameter (e.g., RRC configuration). The quantity (e.g., number) of the one or more CG periods may be indicated (configured) by a CG configuration. The quantity (e.g., number) of the one or more CG periods may be indicated (configured) by a configuration for multiple CGOs within a CG period. The quantity (e.g., number) of the one or more CG periods may be indicated (configured) by a configuration for unused CGO indication. The quantity (e.g., number) of the one or more CG periods may be indicated by the unused CGO indication (e.g., UCI (e.g., CG-UCI or a UCI for XR)). Each unused CGO indication may indicate CG resources within one or more CG periods will not be used (e.g., will be skipped) by the wireless device (e.g., UE).

A wireless device (e.g., UE), as shown in FIG. 26, may send (e.g., transmit) one or more unused CGO indications. The wireless device (e.g., UE) may skip CG resources within a quantity (e.g., number) of one or more CG periods based on (e.g., in response to) sending (e.g., transmitting) the unused CGO indication. The wireless device (e.g., UE) may skip CG resources within the one or more CG periods based on a value (e.g., the value may indicate the quantity (e.g., number) of the one or more CG periods) based on (e.g., in response to) sending (e.g., transmitting) the unused CGO.

A value may be an integer number. The wireless device (e.g., UE) may skip CG resources within two CG periods when/after sending (e.g., transmitting) the unused CGO indication, for example, if the value is two. The wireless device (e.g., UE) may skip CG resources within five CG periods when/after sending (e.g., transmitting) the unused CGO indication, for example, if the value is five.

A value may be included in the unused CGO indication (e.g., via UCI (e.g., CG-UCI or a UCI for XR)). A wireless device (e.g., UE) may send (e.g., transmit) an unused CGO indication comprising a field to indicate a value for the quantity (e.g., number) of CG resources that will not be used (e.g., will be skipped) by the wireless device (e.g., UE). The wireless device (e.g., UE) may skip CG resources within one or more CG periods based on the value. The wireless device (e.g., UE) may select one of multiple values (of the CG periods) configured by a (RRC) configuration parameter to indicate via the unused CGO indication. The configuration parameter may configure a set of values (e.g., three different values), and the wireless device (e.g., UE) may select one of three values to indicate via the unused CGO indication.

A value (of the CG periods) may be indicated by a configuration parameter (e.g., via RRC configuration). The value (of the CG periods) may be indicated by DCI. The DCI may indicate one of multiple values (of the CG periods) configured by a (RRC) configuration parameter. The configuration parameter may configure a set of values (e.g., three different values), and the DCI may indicate one of three values.

A wireless device (e.g., UE), as shown in FIG. 26, may send (e.g., transmit) one or more unused CGO indications. The wireless device (e.g., UE) may skip CG resources within a quantity (e.g., number) of one or more CG periods based on (e.g., in response to) sending (e.g., transmitting) the unused CGO indication, wherein the quantity (e.g., number) of one or more CG periods may be counted based on a counter. The wireless device (e.g., UE) may count the value of the quantity (e.g., number) of one or more CG resources by incrementing or decreasing the value of the counter. The wireless device (e.g., UE) may increment or decrease the value of the counter by 1, for example, if the wireless device (e.g., UE) skips one or more CG resources within a CG period. The wireless device (e.g., UE) may not increment or decrease the value of the counter, for example, if the wireless device (e.g., UE) does not skip any CG resource within a CG period. The wireless device (e.g., UE) may stop skipping the CG resources and/or the wireless device (e.g., UE) may reset the counter, for example, if the counter equals to zero or reaches to a (maximum) value.

The counter may be configured in a CG configuration. The counter may be configured in a configuration for multiple CGOs within a CG period. The counter may be configured in a configuration for unused CGO indication.

A wireless device (e.g., UE), as shown in FIG. 26, may send (e.g., transmit) one or more unused CGO indications. The wireless device (e.g., UE) may skip CG resources within a quantity (e.g., number) of one or more CG periods based on (e.g., in response to) sending (e.g., transmitting) the unused CGO indication, wherein the quantity (e.g., number) of one or more CG periods may be counted from the current CG period for the transmission of the unused CGO indication and/or a next CG period after sending (e.g., transmitting) the unused CGO indication. The wireless device (e.g., UE) may start skipping the CG resources from the current CG period for the transmission of the unused CGO indication and/or a next CG period after sending (e.g., transmitting) the unused CGO indication.

A wireless device (e.g., UE) may send (e.g., transmit) an unused CGO indication, and the wireless device (e.g., UE) may skip the CG resources for three CG periods. The wireless device (e.g., UE) may skip the CG resources within the first CG period, a second CG period, and a third CG period, for example, if the wireless device (e.g., UE) sends (e.g., transmits) the unused CGO indication within a first CG period. The second CG period may be a next CG period of the first CG period. The third CG period may be a next CG period of the second CG period.

A wireless device (e.g., UE) may send (e.g., transmit) an unused CGO indication, and the wireless device (e.g., UE) may skip the CG resources for three CG periods. The wireless device (e.g., UE) may not skip the CG resources within the first CG period, for example, if the wireless device (e.g., UE) sends (e.g., transmits) the unused CGO indication within a first CG period. The wireless device (e.g., UE) may skip the CG resource within a second CG period, a third CG period, and a fourth CG period. The second CG period may be a next CG period of the first CG period. The third CG period may be a next CG period of the second CG period. The fourth CG period may be a next CG period of the third CG period.

A wireless device (e.g., UE), as shown in FIG. 26, may determine to skip CG resources within a quantity (e.g., number) of one or more CG periods based on a value in response to sending (e.g., transmitting) an unused CGO indication. The wireless device (e.g., UE) may send (e.g., transmit) one or more unused CGO indications after the wireless device (e.g., UE) sends (e.g., transmits) the unused CGO indication. The wireless device (e.g., UE) may skip CG resources within a quantity (e.g., number) of one or more CG periods in response to sending (e.g., transmitting) the unused CGO indication after the time period/offset from the time of sending (e.g., transmitting) the unused CGO indication.

The time period/offset may be determined based on a quantity (e.g., number) of time unit. The time unit may be based on slot, symbol, subframe, system frame, millisecond, second, periodicity of CG, and/or DRX cycle. The quantity (e.g., number) of time unit may be pre-defined, and/or configured (indicated) by a configuration parameter (e.g., RRC configuration). The quantity (e.g., number) of time unit may be indicated by the wireless device (e.g., UE) (e.g., via the UCI (e.g., CG-UCI or a UCI for XR) and/or the unused CGO indication).

The time period/offset may be determined based on a time duration. The time duration may be pre-defined, and/or configured (indicated) by a configuration parameter (e.g., RRC configuration). The time duration may be indicated by the wireless device (e.g., UE) (e.g., via the UCI (e.g., CG-UCI or a UCI for XR) and/or the unused CGO indication).

The time period/offset may be determined based on a transmission delay. The transmission delay may be a delay for sending (e.g., transmitting) the unused CGO indication (e.g., via UCI (e.g., CG-UCI or a UCI for XR)). The transmission delay may be a delay based on the transmission time of the unused CGO indication (e.g., via UCI (e.g., CG-UCI or a UCI for XR)). The transmission delay may be pre-defined, and/or configured (indicated) by a configuration parameter (e.g., RRC configuration). The transmission delay may be indicated by the wireless device (e.g., UE) (e.g., via the UCI (e.g., CG-UCI or a UCI for XR) and/or the unused CGO indication).

The time period/offset may be determined based on an application delay/processing time. The application delay/processing time may be a delay for the wireless device (e.g., UE) and/or the BS to decode the unused CGO indication. The application delay/processing time may be pre-defined, and/or configured (indicated) by a configuration parameter (e.g., RRC configuration). The application delay/processing time may be indicated by the wireless device (e.g., UE) (e.g., via the UCI (e.g., CG-UCI or a UCI for XR) and/or the unused CGO indication).

The time period/offset may be determined based on a timer/time window. The timer/time window may be (re)started in response to sending (e.g., transmitting) the unused CGO indication. The wireless device (e.g., UE) may start skipping the unused CGO resource when/after the timer/time window expires and/or if/when/after the timer/time window is not running. The wireless device (e.g., UE) may not skip the CG resources, for example, if/while the timer/time window is running. The wireless device (e.g., UE) may stop the timer, for example, if/when receiving a signal from the BS. The wireless device (e.g., UE) may stop the timer, for example, if/when an UL data arrival.

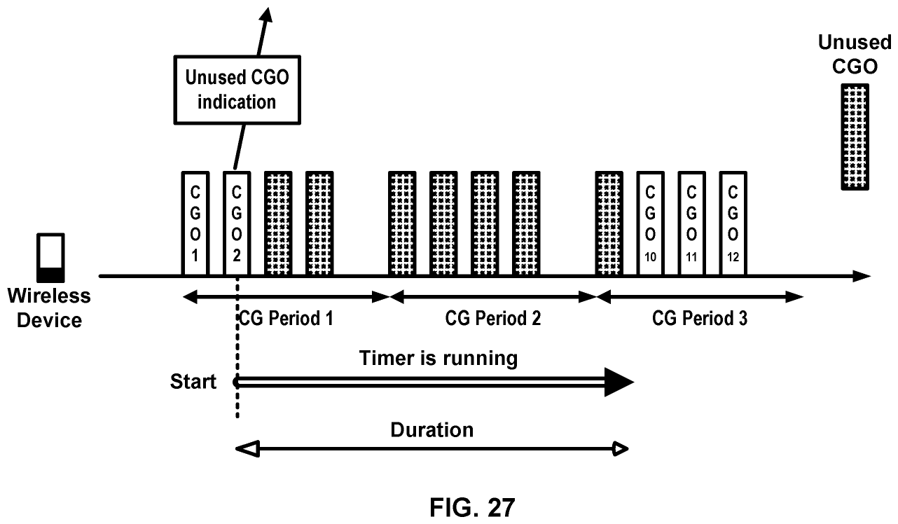

A wireless device (e.g., UE), as shown in FIG. 27, may send (e.g., transmit) one or more unused CGO indications. The wireless device (e.g., UE) may skip CG resources based on a duration (e.g., within a duration) based on (e.g., in response to) sending (e.g., transmitting) the unused CGO indication.

A duration may be included in the unused CGO indication (e.g., via UCI (e.g., CG-UCI or a UCI for XR)). A wireless device (e.g., UE) may send (e.g., transmit) an unused CGO indication comprising one or more fields to indicate a duration for CG resources that will not be used (e.g., will be skipped) by the wireless device (e.g., UE). The wireless device (e.g., UE) may skip CG resources based on the duration (e.g., within the duration). The wireless device (e.g., UE) may select one of multiple durations configured by a (RRC) configuration parameter. The configuration parameter may configure a set of durations (e.g., three different durations), and the wireless device (e.g., UE) may select one of three durations to indicate.

A duration may be indicated by a configuration parameter (e.g., via RRC configuration). The duration may be indicated by DCI. The DCI may indicate one of multiple durations configured by a (RRC) configuration parameter. The configuration parameter may configure a set of durations (e.g., three different durations), and the DCI may indicate one of three durations. The duration may be indicated by a quantity (e.g., number) of time units (e.g., slot, symbol, subframe, system frame, millisecond, second, CG periodicity, DRX cycle).

A wireless device (e.g., UE), as shown in FIG. 27, may send (e.g., transmit) one or more unused CGO indications. The wireless device (e.g., UE) may skip CG resources based on a duration (e.g., within a duration) based on (e.g., in response to) sending (e.g., transmitting) the unused CGO indication.

A wireless device (e.g., UE) may skip CG resources from the start of the duration to the end of the duration. The wireless device (e.g., UE) may skip one or more or all CG resources within the duration.

A wireless device (e.g., UE), as shown in FIG. 27, may send (e.g., transmit) one or more unused CGO indications. The wireless device (e.g., UE) may skip CG resources based on a timer (e.g., if/while the timer is running) based on (e.g., in response to) sending (e.g., transmitting) the unused CGO indication.

A wireless device (e.g., UE) may skip CG resources if (e.g., while) the timer is running. The wireless device (e.g., UE) may not skip CG resource if (e.g., while) the timer is not running and/or while the timer expires.

A wireless device (e.g., UE) may start or restart the timer based on (e.g., in response to) sending (e.g., transmitting) the unused CGO indication. The wireless device (e.g., UE) may start or restart the timer based on (e.g., in response to) triggering the unused CGO. The wireless device (e.g., UE) may start or restart the timer in response to receiving a signaling from BS. The signaling may be feedback (for the transmission of the unused CGO indication). The feedback may be an ACK or NACK. The signaling may be a response/confirmation for the unused CGO indication. The signaling may be DCI, MAC CE, and/or a RRC message. The wireless device (e.g., UE) may start or restart the timer based on (e.g., in response to) receiving a RRC configuration for unused CGO indication. The wireless device (e.g., UE) may start or restart the timer in response to receiving DCI for triggering unused CGO.

A wireless device (e.g., UE) may stop the timer in response to receiving a signaling from BS. The signaling may be feedback (for the transmission of the unused CGO indication). The feedback may be an ACK or NACK. The signaling may be a response/confirmation for the unused CGO indication. The signaling may be DCI, MAC CE, and/or a RRC message.

A wireless device (e.g., UE), as shown in FIG. 27, may send (e.g., transmit) one or more unused CGO indications. The wireless device (e.g., UE) may skip CG resources based on a timer (e.g., if/while the timer is running) in response to sending (e.g., transmitting) the unused CGO indication.

A timer may be associated with a specific CG configuration. The wireless device (e.g., UE) may skip CG resources indicated (configured) by a first CG configuration, for example, if a first timer is running, wherein the first timer may be indicated (configured) by the first CG configuration. The wireless device (e.g., UE) may not skip CG resources indicated (configured) by the first CG configuration, for example, if a second timer is running, wherein the second timer may be indicated (configured) by a second CG configuration.

A wireless device (e.g., UE), as shown in FIG. 27, may send (e.g., transmit) one or more unused CGO indications. The wireless device (e.g., UE) may skip CG resources based on a duration (e.g., within a duration) in response to sending (e.g., transmitting) the unused CGO indication. The wireless device (e.g., UE) may skip CG resources based on a timer (e.g., if/while the timer is running) in response to sending (e.g., transmitting) the unused CGO indication.

A wireless device (e.g., UE) may determine to skip CG resources based on a duration (within a duration) and/or based on a timer (e.g., while the timer is running) after the time period/offset from the time of sending (e.g., transmitting) the unused CGO indication, for example, if the wireless device (e.g., UE) sends (e.g., transmits) the unused CGO indication. The wireless device (e.g., UE) may not skip the CG resources after the time of sending (e.g., transmitting) the unused CGO indication and before the time period/offset from the time of sending (e.g., transmitting) the unused CGO indication. The start of the duration may occur after the time period/offset from the time of sending (e.g., transmitting) the unused CGO indication.

A wireless device (e.g., UE) may not skip the CG resources after the time of sending (e.g., transmitting) the unused CGO indication and before the time period/offset from the time of sending (e.g., transmitting) the unused CGO indication no matter whether within the duration. The wireless device (e.g., UE) may not skip the CG resources after the time of sending (e.g., transmitting) the unused CGO indication and before the time period/offset from the time of sending (e.g., transmitting) the unused CGO indication no matter whether the timer is running. The wireless device (e.g., UE) may start or restart the timer after the time period/offset from the time of sending (e.g., transmitting) the unused CGO indication.

A time period/offset may be determined based on a quantity (e.g., number) of time unit. The time unit may be based on slot, symbol, subframe, system frame, millisecond, second, periodicity of CG, and/or DRX cycle. The quantity (e.g., number) of time unit may be pre-defined, and/or configured (indicated) by a configuration parameter (e.g., RRC configuration). The quantity (e.g., number) of time unit may be indicated by the wireless device (e.g., UE) (e.g., via the UCI (e.g., CG-UCI or a UCI for XR) and/or the unused CGO indication).

The time period/offset may be determined based on a time duration. The time duration may be pre-defined, and/or configured (indicated) by a configuration parameter (e.g., RRC configuration). The time duration may be indicated by the wireless device (e.g., UE) (e.g., via the UCI (e.g., CG-UCI or a UCI for XR) and/or the unused CGO indication).

The time period/offset may be determined based on a transmission delay. The transmission delay may be a delay for sending (e.g., transmitting) the unused CGO indication (e.g., via UCI (e.g., CG-UCI or a UCI for XR)). The transmission delay may be a delay based on the transmission time of the unused CGO indication (e.g., via UCI (e.g., CG-UCI or a UCI for XR)). The transmission delay may be pre-defined, and/or configured (indicated) by a configuration parameter (e.g., RRC configuration). The transmission delay may be indicated by the wireless device (e.g., UE) (e.g., via the UCI (e.g., CG-UCI or a UCI for XR) and/or the unused CGO indication).

The time period/offset may be determined based on an application delay/processing time. The application delay/processing time may be a delay for the wireless device (e.g., UE) and/or the BS to decode the unused CGO indication. The application delay/processing time may be pre-defined, and/or configured (indicated) by a configuration parameter (e.g., RRC configuration). The application delay/processing time may be indicated by the wireless device (e.g., UE) (e.g., via the UCI (e.g., CG-UCI or a UCI for XR) and/or the unused CGO indication).

The time period/offset may be determined based on a timer/time window. The timer/time window may be (re)started based on (e.g., in response to) sending (e.g., transmitting) the unused CGO indication. The wireless device (e.g., UE) may start skipping the unused CGO resource, if/when/after the timer/time window expires and/or if/when/after the timer/time window is not running. The wireless device (e.g., UE) may not skip the CG resources, for example, if the timer/time window is running. The wireless device (e.g., UE) may stop the timer, for example, if receiving a signal from the BS. The wireless device (e.g., UE) may stop the timer, for example, if an UL data arrival.

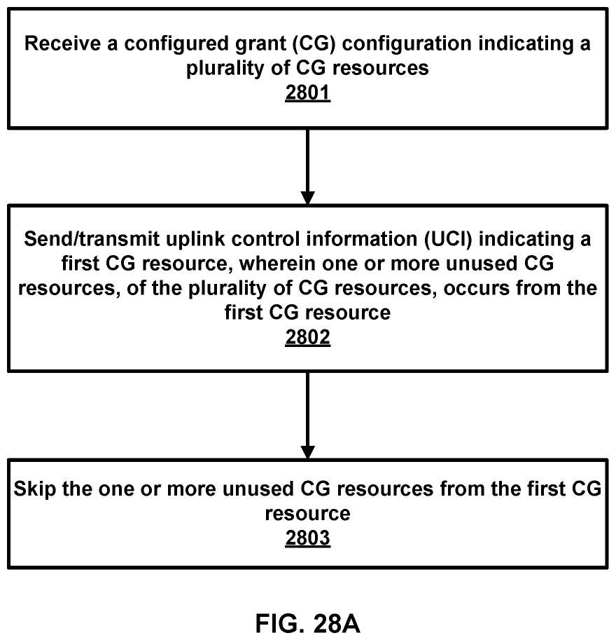

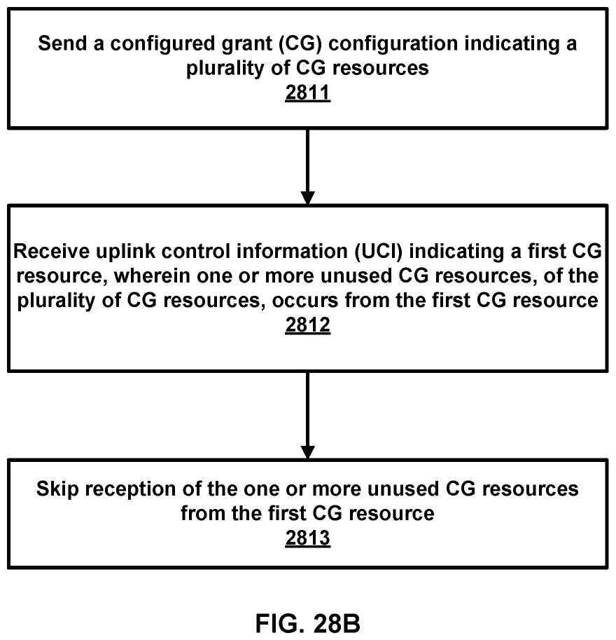

FIG. 28A shows an example of unused CGO indication. At 2801, a wireless device may receive a configured grant (CG) configuration indicating a plurality of CG resources. At 2802, the wireless device may send (e.g., transmit) uplink control information (UCI) indicating a first CG resource, wherein one or more unused CG resources of the plurality of CG resources may occur from the first CG resource. At 2803, the wireless device may skip the one or more unused CG resources from the first CG resource.

FIG. 28B shows an example of unused CGO indication. At 2811, a base station may send a configured grant (CG) configuration indicating a plurality of CG resources. At 2812, the base station may receive uplink control information (UCI) indicating a first CG resource, wherein one or more unused CG resources of the plurality of CG resources may occur from the first CG resource. At 2813, the base station may skip reception of the one or more unused CG resources the first CG resource.

In at least some wireless communications, CG resource may start in a time resource and to reoccur with periodicity (e.g., the CG resources may occur and reoccur sequentially in time domain), for example, if the wireless device (e.g., UE) is configured with (e.g., indicated by) a configured uplink grant and/or the wireless device (e.g., UE) initializes/re-initializes/activates the CG. The wireless device (e.g., UE) may use the CG resources as UL grants for UL transmission, for example, if there is UL data. The wireless device (e.g., UE) may be configured with (indicated by) a plurality of CG configurations (e.g., either type 1 CG or type 2 CG). The wireless device (e.g., UE) may activate/(re-)initialize one or more of the configured plurality of CG configurations. Each CG configuration may configure (indicate) periodic CG resources (e.g., CGOs). The wireless device (e.g., UE) may determine to skip one or more CG resources, for example, if there is no UL data for transmission and/or the size of the UL data is smaller than the configured CG resource. Then the wireless device (e.g., UE) may send (e.g., transmit) an unused CGO indication to indicate that the wireless device (e.g., UE) will skip the one or more CG resources. The wireless device (e.g., UE) should not use the CGO(s) (for example, if these CGO(s) were indicated as unused) to send (e.g., transmit) the UL data, for example, if an UL data arrival after sending (e.g., transmitting) the unused CGO indication.

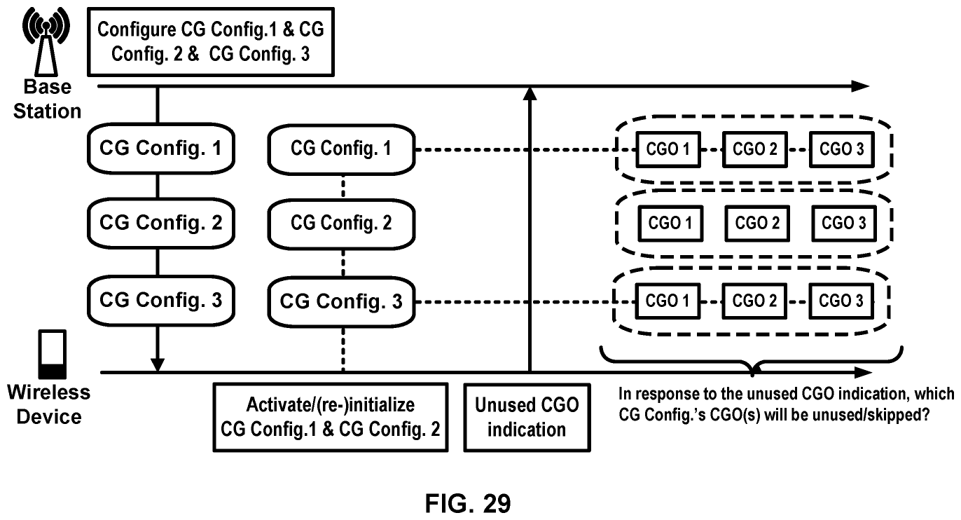

FIG. 29 shows an example issues of unused CGO indication. A wireless device (e.g., UE) is configured with three CG configurations (e.g., CG configuration 1, CG configuration 2, and CG configuration 3). The wireless device (e.g., UE) may send (e.g., transmit) an unused CGO indication to indicate there is one or more unused CG resources. The unused CGO indication may not be clear to indicate which CG configurations' CGO(s) will be unused/skipped by the wireless device (e.g., UE). The misalignment of the CG resources usage between the BS and the wireless device (e.g., UE) may be introduced, which results in unexpected conditions. For example, the wireless device (e.g., UE) may skip a first CGO(s) of a first CG configuration, but the BS does not reallocate the first CGO(s) of the first CG configuration to other wireless devices (e.g., UEs), which will cause the resource wastage because the first CGO(s) of the first CG configuration will not be used. The wireless device (e.g., UE) may not skip a second CGO(s) of a second CG configuration, but the BS may reallocate the second CGO(s) of the second CG configuration to other wireless devices (e.g., UEs), which will cause power consumption without transmission chance for the wireless device (e.g., UE).

Examples described herein may enable a wireless device (e.g., UE) to send (e.g., transmit) an unused CGO indication that indicates one or more CG grants/resources associated with one or more CG configurations are unused. Examples described herein may prevent the misalignment of the CG resources usage between the BS and the wireless device (e.g., UE). For example, examples described herein may improve the resource utilization by preventing the misalignment. A single unused CSO indication in example embodiments in the present disclosure may indicate one or more CG grants/resources associated with a plurality of CG configurations are unused. Examples described herein may reduce a signaling overhead by sending (e.g., transmitting) an (e.g., single) unused CGO indication indicating that the one or more CG grants/resources associated with the plurality of CG configurations.

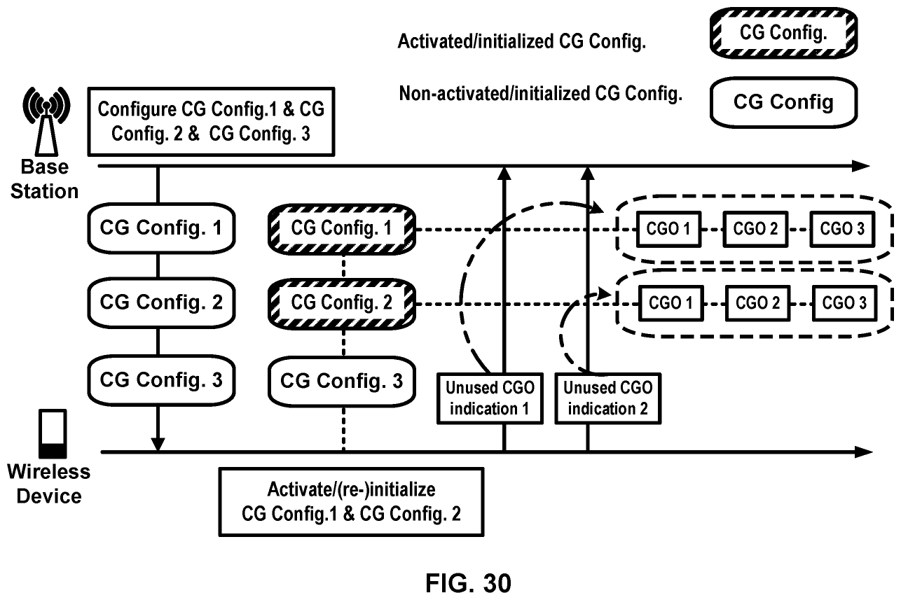

A wireless device (e.g., UE), as shown in FIG. 30, may be configured with (e.g., indicated by) a plurality of CG configurations (e.g., a first CG configuration, a second CG configuration, and a third CG configuration). The wireless device (e.g., UE) may activate/(re-)initialize one or more CGs among the one or more CG configurations (e.g., a first CG configuration and a second CG configuration). Each CG configuration may configure/indicate respective CGOs periodically to the wireless device (e.g., UE). The wireless device (e.g., UE) may send (e.g., transmit) one or more unused CGO indications. Each unused CGO indication may indicate one or more CG resources of a CG configuration will be unused/skipped. The wireless device (e.g., UE) may unuse/skip the one or more CG resources of the CG configuration based on the unused CGO indication, wherein the CG configuration may be CG configuration being activated/(re-initialized).

A first unused CGO indication may indicate a first CGO(s) of a first CG configuration will be unused/skipped. The wireless device (e.g., UE) may unuse/skip the first CGO(s) of the first CG configuration based on the first unused CGO indication. A second unused CGO indication may indicate a second CGO(s) of a second CG configuration will be unused/skipped. The wireless device (e.g., UE) may unuse/skip the second CGO(s) of the second CG configuration based on the second unused CGO indication.

An association between an unused CGO indication and one or more CG configuration may be indicated by the unused CGO indication (e.g., based on a field). The unused CGO indication may comprise an index/identifier of the CG configuration.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an unused CGO indication comprising a first index/identifier of the first CG configuration. The wireless device (e.g., UE) may unuse/skip CGO(s) of the first CG configuration based on (e.g., in response to) sending (e.g., transmitting) the unused CGO indication. The wireless device (e.g., UE) may not unuse/skip CGO(s) of the second CG configuration.

An association between an unused CGO indication and one or more CG configuration may be indicated by a configuration for the unused CGO indication. The configuration for the unused CGO indication may comprise an index/identifier of the CG configuration. The configuration for the unused CGO indication may enable/disable the function of the unused CGO indication.

A wireless device (e.g., UE) may apply the function based on (e.g., in response to) sending (e.g., transmitting) the unused CGO indication, for example, if the wireless device (e.g., UE) is configured with (and/or enabled and/or with value true) the configuration for unused CGO indication. The configuration for the unused CGO indication may be included in a CG configuration, a PUSCH configuration, a (UL)BWP configuration, a serving cell configuration, a MAC entity configuration, and/or a PHY layer configuration.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may receive a configuration for the unused CGO indication (which indicates an association between the unused CGO indication and one or more CG configuration). The wireless device (e.g., UE) may send (e.g., transmit) the unused CGO indication (based on the configuration for the unused CGO indication). The wireless device (e.g., UE) may unuse/skip the CGO(s) of the CG configuration based on (e.g., in response to) sending (e.g., transmitting) the unused CGO indication.

An association between an unused CGO indication and a CG configuration may be based on a certain CG resource. The certain CG resource may be associated with the CG configuration. The certain CG resource may be configured by the CG configuration. The certain CG resource may be configured by a second CG configuration, wherein the second CG configuration may indicate that the certain CG resource is associated with the configuration.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an unused CGO indication via a first CG resource. The wireless device (e.g., UE) may unuse/skip the CGO(s) of a first CG configuration based on (e.g., in response to) sending (e.g., transmitting) the unused CGO indication via the first CG resource. The first CG resource may be associated with first CG configuration. The first CG resource may be configured by the first CG configuration. The first CG resource may be configured by a second CG configuration, wherein the second CG configuration may indicate that the first CG resource is associated with the first CG configuration.

An association between an unused CGO indication and a CG configuration may be based on a certain UL resource. The certain UL resource may be a PUCCH resource, PUSCH resource, and/or a PRACH resource. The certain UL resource may be a CG resource.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an unused CGO indication via a first UL resource. The wireless device (e.g., UE) may unuse/skip the CGO(s) of a first CG configuration based on (e.g., in response to) sending (e.g., transmitting) the unused CGO indication via the first UL resource. The first UL resource may be associated with the first CG configuration. The first UL resource may be configured by a configuration parameter, wherein the configuration parameter may indicate that the first CG resource is associated with the first CG configuration.

An association between an unused CGO indication and a CG configuration may be indicated (configured) by a DL signaling (from a BS). The DL signaling may be a RRC message, a DCI, and/or a MAC CE. The DL signaling may be sent (e.g., transmitted) via PDSCH and/or PDCCH. The DL signaling may comprise an index/identifier of the CG configuration. The DL signaling may indicate/configure/schedule UL resource or DL resource.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may receive a DL signaling. The DL signaling may indicate that an unused CGO indication is associated with a first CG configuration. The wireless device (e.g., UE) may send (e.g., transmit) an unused CGO indication. The wireless device (e.g., UE) may unuse/skip the CGO(s) of the first CG configuration based on (e.g., in response to) sending (e.g., transmitting) the unused CGO indication.

An association between an unused CGO indication and a CG configuration may be indicated by an UL signaling (from a wireless device (e.g., UE)). The UL signaling may be an UCI, a MAC CE, and/or a RRC message. The UL signaling may be sent (e.g., transmitted) via PUSCH, PUCCH, and/or a CG resource. The UL signaling may comprise an index/identifier of the CG configuration. The UL signaling may be the unused CGO indication.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an UL signaling. The UL signaling may indicate that an unused CGO indication is associated with the first CG configuration. The wireless device (e.g., UE) may unuse/skip the CGO(s) of the first CG configuration based on (e.g., in response to) sending (e.g., transmitting) the unused CGO indication.

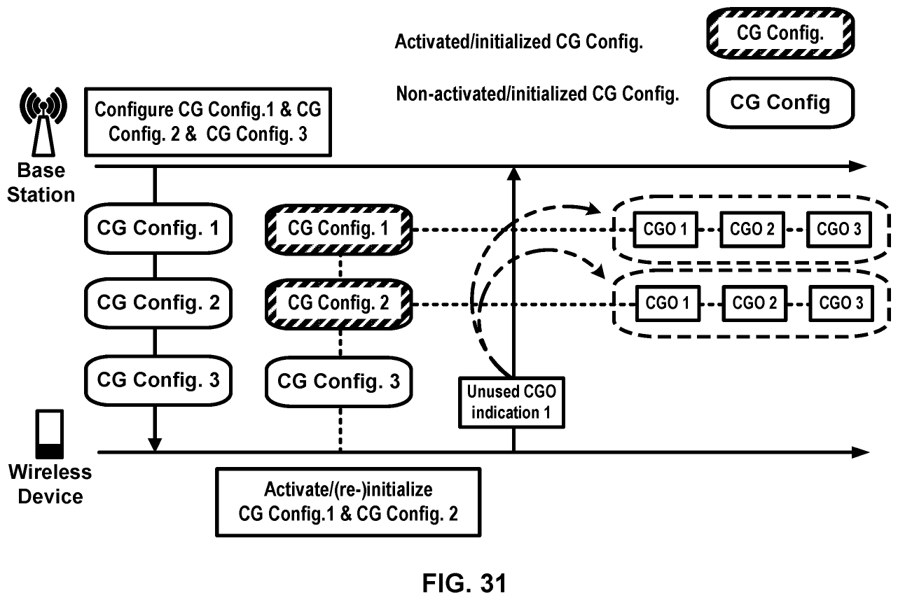

A wireless device (e.g., UE), as shown in FIG. 31, may be configured with (e.g., indicated by) a plurality of CG configurations (e.g., a first CG configuration, a second CG configuration, and a third CG configuration). The wireless device (e.g., UE) may activate/(re-)initialize one or more CGs among the one or more CG configurations (e.g., a first CG configuration and a second CG configuration). Each CG configuration may configure/indicate respective CGOs periodically to the wireless device (e.g., UE). The wireless device (e.g., UE) may send (e.g., transmit) one or more unused CGO indications. Each unused CGO indication may indicate one or more CG resources of the one or more CG configurations will be unused/skipped. The wireless device (e.g., UE) may unuse/skip the one or more CG resources of the one or more CG configurations (e.g., all CG configurations) based on the unused CGO indication, wherein the one or more CG configurations may be CG configurations being activated/(re-initialized). The one or more CG configurations may not comprise the CG configurations which are deactivated/suspended.

An unused CGO indication may indicate that the unused CGO indication is associated with the one or more CG configurations based on a field of the unused CG indication. The one or more CG configurations may be CG configurations being activated/(re-initialized). The unused CGO indication may comprise a field to indicate that the unused CGO indication is associated with the one or more CG configurations.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an unused CGO indication comprising the field to indicate that the unused CGO indication is associated with the one or more CG configurations. The wireless device (e.g., UE) may unuse/skip CGO(s) of the first CG configuration and the second CG configuration based on (e.g., in response to) sending (e.g., transmitting) the unused CGO indication.

An unused CGO indication may indicate that the unused CGO indication is associate with the one or more CG configurations based on a configuration for the unused CGO indication. The one or more CG configurations may be CG configurations being activated/(re-initialized).

A configuration for the unused CGO indication may enable/disable the function of the unused CGO indication. The configuration for the unused CGO indication may comprise a configuration parameter (e.g., IE) to indicate the unused CGO indication is associated with the one or more CG configurations. The configuration for the unused CGO indication may be included in a CG configuration, a PUSCH configuration, a (UL)BWP configuration, a serving cell configuration, a MAC entity configuration, and/or a PHY layer configuration.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may receive a configuration for the unused CGO indication (which may indicate the unused CGO indication is associated with the one or more CG configurations). The wireless device (e.g., UE) may send (e.g., transmit) the unused CGO indication (based on the configuration for the unused CGO indication). The wireless device (e.g., UE) may unuse/skip the CGO(s) of the one or more CG configurations based on (e.g., in response to) sending (e.g., transmitting) the unused CGO indication.

An unused CGO indication may indicate that the unused CGO indication is associate with the one or more CG configurations based on a certain CG resource. The one or more CG configurations may be CG configurations being activated/(re-initialized). The certain CG resource may be associated with one of the one or more CG configurations. The certain CG resource may be configured by one of the one or more CG configurations.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an unused CGO indication via a first CG resource of the first CG configuration or via a second CG resource of the second CG configuration. The wireless device (e.g., UE) may unuse/skip the CGO(s) of the first CG configuration and the CGO(s) of the second CG configuration based on (e.g., in response to) sending (e.g., transmitting) the unused CGO indication. The first CG resource may be associated with the first CG configuration. The first CG resource may be configured by the first CG configuration. The second CG resource may be associated with the second CG configuration. The second CG resource may be configured by the second CG configuration.

An unused CGO indication may indicate that the unused CGO indication is associated with one or more CG configurations (e.g., all CG configurations) based on a certain UL resource. The one or more CG configurations may be CG configurations being activated/(re-initialized). The certain UL resource may be a PUCCH resource, PUSCH resource, and/or a PRACH resource. The certain UL resource may be a CG resource.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an unused CGO indication via a certain UL resource. The wireless device (e.g., UE) may unuse/skip the CGO(s) of one or more CG configurations (e.g., all CG configurations) based on (e.g., in response to) sending (e.g., transmitting) the unused CGO indication via the certain UL resource.

An unused CGO indication may indicate that the unused CGO indication is associate with the one or more CG configurations based on a DL signaling (from BS). The one or more CG configurations may be CG configurations being activated/(re-initialized). The DL signaling may be a RRC message, a DCI, and/or a MAC CE. The DL signaling may be sent (e.g., transmitted) via PDSCH and/or PDCCH. The DL signaling may comprise an index/identifier of the CG configuration. The DL signaling may indicate/configure/schedule UL resource or DL resource.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may receive a DL signaling. The DL signaling may indicate that an UL resource is associated with one or more CG configurations (e.g., all CG configurations). The wireless device (e.g., UE) may send (e.g., transmit) an unused CGO indication. The wireless device (e.g., UE) may unuse/skip the CGO(s) of the one or more CG configurations based on (e.g., in response to) sending (e.g., transmitting) the unused CGO indication.

An unused CGO indication may indicate that the unused CGO indication is associate with one or more CG configurations (e.g., all CG configurations) an UL signaling (from a wireless device (e.g., UE)). The one or more CG configurations may be CG configurations being activated/(re-initialized). The UL signaling may be an UCI, a MAC CE, and/or a RRC message. The UL signaling may be sent (e.g., transmitted) via PUSCH, PUCCH, and/or a CG resource. The UL signaling may comprise an index/identifier of the CG configuration. The UL signaling may be the unused CGO indication.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an UL signaling. The UL signaling may indicate that an UL resource is associated with the one or more CG configurations. The wireless device (e.g., UE) may unuse/skip the CGO(s) of the one or more CG configurations based on (e.g., in response to) sending (e.g., transmitting) the unused CGO indication.

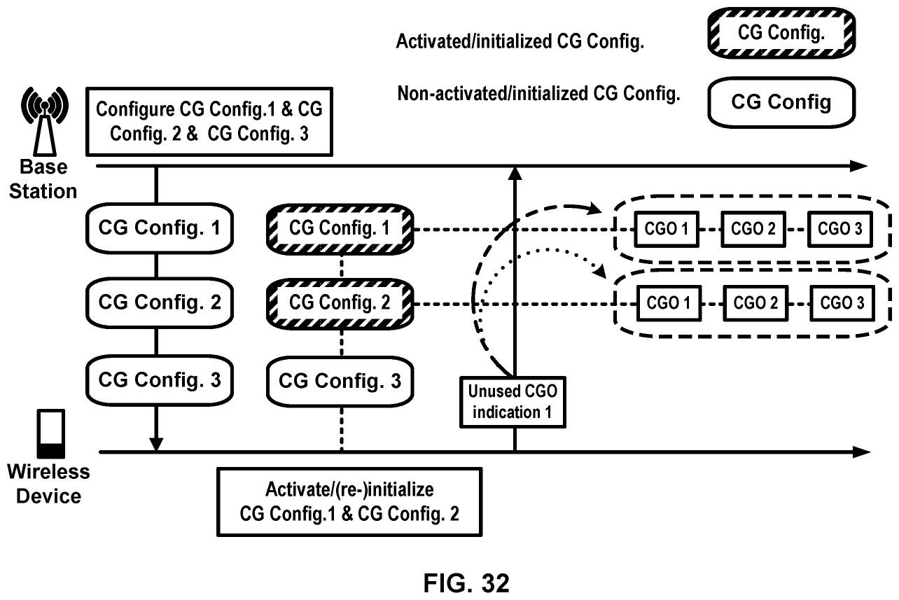

A wireless device (e.g., UE), as shown in FIG. 32, may be configured with (e.g., indicated by) a plurality of CG configurations (e.g., a first CG configuration, a second CG configuration, and a third CG configuration). The wireless device (e.g., UE) may activate/(re-)initialize one or more CGs among the one or more CG configurations (e.g., a first CG configuration and a second CG configuration). Each CG configuration may configure/indicate respective CGOs periodically to the wireless device (e.g., UE). The wireless device (e.g., UE) may send (e.g., transmit) one or more unused CGO indications. Each unused CGO indication may indicate one or more respective CG resources of one or more CG configurations will be unused/skipped. The wireless device (e.g., UE) may unuse/skip the one or more respective CG resources of the CG configuration based on the unused CGO indication, wherein the one or more CG configurations may be CG configurations being activated/(re-initialized).

A first unused CGO indication may indicate a first CGO(s) of a first CG configuration and a second CG configuration will be unused/skipped. The wireless device (e.g., UE) may unuse/skip the first CGO(s) of the first CG configuration and the second CGO(s) of the second CG configuration based on the first unused CGO indication. A second unused CGO indication may indicate a second CGO(s) of a second CG configuration will be unused/skipped. The wireless device (e.g., UE) may unuse/skip the second CGO(s) of the second CG configuration based on the second unused CGO indication.

An association between an unused CGO indication and one or more CG configurations may be indicated by the unused CGO indication (e.g., based on one or more fields and/or a bitmap and/or a list). The unused CGO indication may comprise one or more fields to indicate one or more index/identifiers of the CG configurations. A field may indicate one index/identifier of the CG configuration. A field may indicate multiple index/identifiers of the CG configurations.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an unused CGO indication comprising a first index/identifier of the first CG configuration and a second index/identifier of the second CG configuration. The wireless device (e.g., UE) may unuse/skip CGO(s) of the first CG configuration and the CGO(s) of the second CG configuration based on (e.g., in response to) sending (e.g., transmitting) the unused CGO indication.

An unused CGO indication may comprise a bitmap to indicate the one or more CG configurations. A bit of the bitmap may indicate one CG configuration. A bit of the bitmap may indicate multiple CG configurations. The unused CGO indication may comprise a list to indicate the one or more CG configurations.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an unused CGO indication comprising a bitmap indicating the first CG configuration and the second CG configuration. The wireless device (e.g., UE) may unuse/skip CGO(s) of the first CG configuration and the CGO(s) of the second CG configuration based on (e.g., in response to) sending (e.g., transmitting) the unused CGO indication.

An association between an unused CGO indication and one or more CG configurations may be indicated by a configuration for the unused CGO indication. The configuration for the unused CGO indication may comprise one or more fields to indicate one or more index/identifiers of the CG configurations. A field may indicate one index/identifier of the CG configuration. A field may indicate multiple index/identifiers of the CG configurations.

A configuration for the unused CGO indication may comprise a bitmap to indicate the one or more CG configurations. A bit of the bitmap may indicate one CG configuration. A bit of the bitmap may indicate multiple CG configurations.

A configuration for the unused CGO indication may comprise a list to indicate the one or more CG configurations. The configuration for the unused CGO indication may enable/disable the function of the unused CGO indication.

A wireless device (e.g., UE) may apply the function based on (e.g., in response to) sending (e.g., transmitting) the unused CGO indication, for example, if the wireless device (e.g., UE) is configured with (and/or enabled and/or with value true) the configuration for unused CGO indication. The configuration for the unused CGO indication may be included in a CG configuration, a PUSCH configuration, a (UL)BWP configuration, a serving cell configuration, a MAC entity configuration, and/or a PHY layer configuration.

An association between an unused CGO indication and one or more CG configurations may be indicated (configured) by a DL signaling (from a BS). The DL signaling may be a RRC message, a DCI, and/or a MAC CE. The DL signaling may be sent (e.g., transmitted) via PDSCH and/or PDCCH. The DL signaling may comprise one or more fields to indicate one or more index/identifiers of the CG configurations. A field may indicate one index/identifier of the CG configuration. A field may indicate multiple index/identifiers of the CG configurations.

A DL signaling may comprise a bitmap to indicate the one or more CG configurations. A bit of the bitmap may indicate one CG configuration. A bit of the bitmap may indicate multiple CG configurations. The DL signaling may comprise a list to indicate the one or more CG configurations. The DL signaling may indicate/configure/schedule UL resource or DL resource.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may receive a DL signaling. The DL signaling may indicate that an unused CGO indication is associated with a first CG configuration and a second CG configuration. The wireless device (e.g., UE) may send (e.g., transmit) an unused CGO indication. The wireless device (e.g., UE) may unuse/skip the CGO(s) of the first CG configuration and the CGO(s) of the second CG configuration based on (e.g., in response to) sending (e.g., transmitting) the unused CGO indication.

An association between an unused CGO indication and a CG configuration may be indicated by an UL signaling (from a wireless device (e.g., UE)). The UL signaling may be an UCI, a MAC CE, and/or a RRC message. The UL signaling may be sent (e.g., transmitted) via PUSCH, PUCCH, and/or a CG resource. The UL signaling may be the unused CGO indication. The UL signaling may comprise one or more fields to indicate one or more index/identifiers of the CG configurations. A field may indicate one index/identifier of the CG configuration. A field may indicate multiple index/identifiers of the CG configurations.

The UL signaling may comprise a bitmap to indicate the one or more CG configurations. A bit of the bitmap may indicate one CG configuration. A bit of the bitmap may indicate multiple CG configurations. The DL signaling may comprise a list to indicate the one or more CG configurations.

A wireless device (e.g., UE) may be configured with a first CG configuration, a second CG configuration, and a third CG configuration. The wireless device (e.g., UE) may activate/(re-)initialize the first CG configuration and the second CG configuration. The wireless device (e.g., UE) may send (e.g., transmit) an UL signaling. The UL signaling may indicate that an unused CGO indication is associated with the first CG configuration and the second CG configuration. In response to sending (e.g., transmitting) the unused CGO indication, the wireless device (e.g., UE) may unuse/skip the CGO(s) of the first CG configuration and the CGO(s) of the second CG configuration.

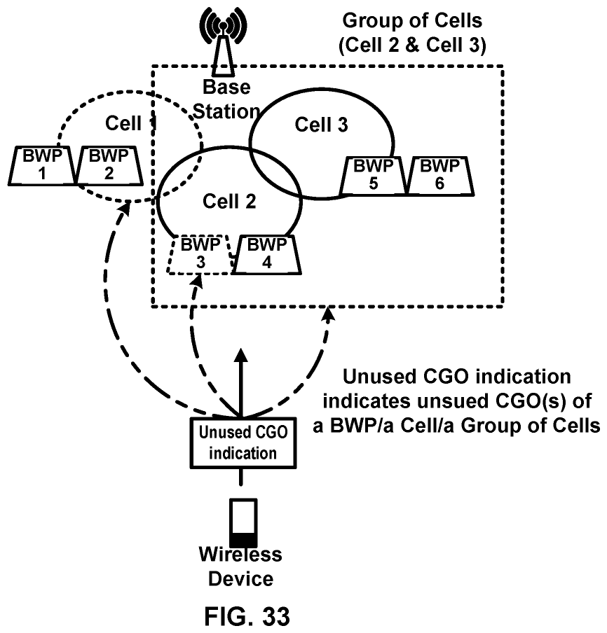

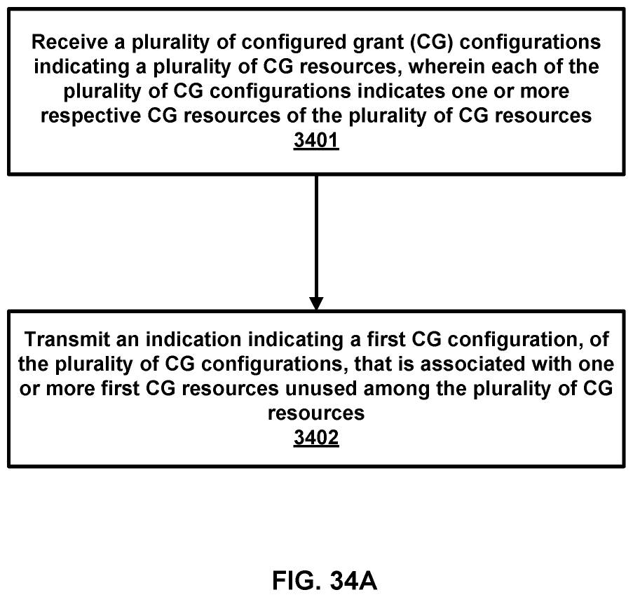

An unused CGO indication, as shown in FIG. 33, may indicate respective CG resource/CG configuration, of one or more BWP/Cell/Group of Cells, will be unused/skipped. The wireless device (e.g., UE) may unuse/skip the respective CG resource/CG configuration, of the one or more BWP/Cell/Group of Cells, based on the unused CGO indication. The respective CG resources may be configured/indicated by the respective CG configurations which is configured/indicated on the respective BWP/Cell/Group of Cells. The BWP may be an UL BWP or an DL BWP. The BWP may be an active BWP. The Cell may be PCell, PSCell, and/or SCell. The Cell may be an activated Cell. The Cell may be a deactivated cell. The cell may be a dormant cell. The Group of Cells may be configured/indicated by a (RRC) configuration parameter, wherein the (RRC) configuration parameter may configure/indicate one or more Cells (e.g., via a list and/or bitmap).

A first unused CGO indication may indicate a first CG resource/configuration of a first BWP/Cell/Group of Cells will be unused/skipped. The wireless device (e.g., UE) may unuse/skip the first CG resource/configuration of a first BWP/Cell/Group of Cells based on the first unused CGO indication. A second unused CGO indication may indicate a second CG resource/configuration of a second BWP/Cell/Group of Cells will be unused/skipped. The wireless device (e.g., UE) may unuse/skip the second CG resource/configuration of the second BWP/Cell/Group of Cell based on the second unused CGO indication.

An association between an unused CGO indication and one or more BWP/Cell/Group of Cells may be indicated by the unused CGO indication (e.g., based on one or more fields and/or a bitmap). The unused CGO indication may comprise one or more fields to indicate one or more index/identifiers of the BWP/Cell/Group of Cells. A field may indicate one index/identifier of the BWP/Cell/Group of Cells. A field may indicate multiple index/identifiers of the BWP/Cell/Group of Cells.

The unused CGO indication may comprise a bitmap to indicate the one or more BWP/Cell/Group of Cells. A bit of the bitmap may indicate one BWP/Cell/Group of Cells. A bit of the bitmap may indicate multiple BWP/Cell/Group of Cells. The unused CGO indication may comprise a list to indicate the one or more BWP/Cell/Group of Cells.

An association between an unused CGO indication and one or more BWP/Cell/Group of Cells may be indicated by a configuration for the unused CGO indication. The configuration for the unused CGO indication may comprise one or more fields to indicate one or more index/identifiers of the BWP/Cell/Group of Cells. A field may indicate one index/identifier of the BWP/Cell/Group of Cells. A field may indicate multiple index/identifiers of the BWP/Cell/Group of Cells.

A configuration for the unused CGO indication may comprise a bitmap to indicate the one or more BWP/Cell/Group of Cells. A bit of the bitmap may indicate one BWP/Cell/Group of Cells. A bit of the bitmap may indicate multiple BWP/Cell/Group of Cells. The configuration for the unused CGO indication may comprise a list to indicate the one or more BWP/Cell/Group of Cells. The configuration for the unused CGO indication may enable/disable the function of the unused CGO indication.

The wireless device (e.g., UE) may apply the function in response to sending (e.g., transmitting) the unused CGO indication, for example, if the wireless device (e.g., UE) is configured with (and/or enabled and/or with value true) the configuration for unused CGO indication. The configuration for the unused CGO indication may be included in a CG configuration, a PUSCH configuration, a (UL)BWP configuration, a serving cell configuration, a MAC entity configuration, and/or a PHY layer configuration.

An association between an unused CGO indication and one or more BWP/Cell/Group of Cells may be indicated (configured) by a DL signaling (from a BS). The DL signaling may be a RRC message, a DCI, and/or a MAC CE. The DL signaling may be sent (e.g., transmitted) via PDSCH and/or PDCCH. The DL signaling may comprise one or more fields to indicate one or more index/identifiers of the BWP/Cell/Group of Cells. A field may indicate one index/identifier of the BWP/Cell/Group of Cells. A field may indicate multiple index/identifiers of the BWP/Cell/Group of Cells.

A DL signaling may comprise a bitmap to indicate the one or more BWP/Cell/Group of Cells. A bit of the bitmap may indicate one BWP/Cell/Group of Cells. A bit of the bitmap may indicate multiple BWP/Cell/Group of Cells. The DL signaling may comprise a list to indicate the one or more BWP/Cell/Group of Cells. The DL signaling may indicate/configure/schedule UL resource or DL resource.

An association between an unused CGO indication and one or more BWP/Cell/Group of Cells may be indicated by an UL signaling (from a wireless device (e.g., UE)). The UL signaling may be an UCI, a MAC CE, and/or a RRC message. The UL signaling may be sent (e.g., transmitted) via PUSCH, PUCCH, and/or a CG resource. The UL signaling may be the unused CGO indication. The UL signaling may comprise one or more fields to indicate one or more index/identifiers of the BWP/Cell/Group of Cells. A field may indicate one index/identifier of the BWP/Cell/Group of Cells. A field may indicate multiple index/identifiers of the BWP/Cell/Group of Cells.

An UL signaling may comprise a bitmap to indicate the one or more BWP/Cell/Group of Cells. A bit of the bitmap may indicate one BWP/Cell/Group of Cells. A bit of the bitmap may indicate multiple BWP/Cell/Group of Cells. The UL signaling may comprise a list to indicate the one or more BWP/Cell/Group of Cells.

An unused CGO indication may indicate respective CG resource/CG configuration, for one or more HARQ process/HARQ entity, will be unused/skipped. The wireless device (e.g., UE) may unuse/skip the respective CG resource/CG configuration of the one or more HARQ process/HARQ entity, based on the unused CGO indication. The respective CG resources may be configured/indicated by the respective CG configurations which is configured/indicated for the respective HARQ process/HARQ entity.

A first unused CGO indication may indicate a first CG resource/configuration for a first HARQ process/HARQ entity will be unused/skipped. The wireless device (e.g., UE) may unuse/skip the first CG resource/configuration for first HARQ process/HARQ entity based on the first unused CGO indication. A second unused CGO indication may indicate a second CG resource/configuration for a second HARQ process/HARQ entity will be unused/skipped. The wireless device (e.g., UE) may unuse/skip the second CG resource/configuration of the second HARQ process/HARQ entity based on the second unused CGO indication.

An association between an unused CGO indication and one or more HARQ process/HARQ entity may be indicated by the unused CGO indication (e.g., based on one or more fields and/or a bitmap and/or a list). The unused CGO indication may comprise one or more fields to indicate one or more index/identifiers of the HARQ process/HARQ entity. A field may indicate one index/identifier of the HARQ process/HARQ entity. A field may indicate multiple index/identifiers of the HARQ process/HARQ entity.

The unused CGO indication may comprise a bitmap to indicate the one or more HARQ process/HARQ entity. A bit of the bitmap may indicate one HARQ process/HARQ entity. A bit of the bitmap may indicate multiple HARQ process/HARQ entity. The unused CGO indication may comprise a list to indicate the one or more HARQ process/HARQ entity.

An association between an unused CGO indication and one or more HARQ process/HARQ entity may be indicated by a configuration for the unused CGO indication. The configuration for the unused CGO indication may comprise one or more fields to indicate one or more index/identifiers of the HARQ process/HARQ entity. A field may indicate one index/identifier of the HARQ process/HARQ entity. A field may indicate multiple index/identifiers of the HARQ process/HARQ entity.

A configuration for the unused CGO indication may comprise a bitmap to indicate the one or more HARQ process/HARQ entity. A bit of the bitmap may indicate one HARQ process/HARQ entity. A bit of the bitmap may indicate multiple HARQ process/HARQ entity. The configuration for the unused CGO indication may comprise a list to indicate the one or more HARQ process/HARQ entity. The configuration for the unused CGO indication may enable/disable the function of the unused CGO indication.

The wireless device (e.g., UE) may apply the function in response to sending (e.g., transmitting) the unused CGO indication, for example, if the wireless device (e.g., UE) is configured with (and/or enabled and/or with value true) the configuration for unused CGO indication. The configuration for the unused CGO indication may be included in a CG configuration, a PUSCH configuration, a (UL)BWP configuration, a serving cell configuration, a MAC entity configuration, and/or a PHY layer configuration.

The association between an unused CGO indication and one or more HARQ process/HARQ entity may be indicated (configured) by a DL signaling (from a BS). The DL signaling may be a RRC message, a DCI, and/or a MAC CE. The DL signaling may be sent (e.g., transmitted) via PDSCH and/or PDCCH. The DL signaling may comprise one or more fields to indicate one or more index/identifiers of the HARQ process/HARQ entity. A field may indicate one index/identifier of the HARQ process/HARQ entity. A field may indicate multiple index/identifiers of the HARQ process/HARQ entity.

A DL signaling may comprise a bitmap to indicate the one or more HARQ process/HARQ entity. A bit of the bitmap may indicate one HARQ process/HARQ entity. A bit of the bitmap may indicate multiple HARQ process/HARQ entity. The DL signaling may comprise a list to indicate the one or more HARQ process/HARQ entity. The DL signaling may indicate/configure/schedule UL resource or DL resource.

An association between an unused CGO indication and one or more HARQ process/HARQ entity may be indicated by an UL signaling (from a wireless device (e.g., UE)). The UL signaling may be an UCI, a MAC CE, and/or a RRC message. The UL signaling may be sent (e.g., transmitted) via PUSCH, PUCCH, and/or a CG resource. The UL signaling may be the unused CGO indication. The UL signaling may comprise one or more fields to indicate one or more index/identifiers of the HARQ process/HARQ entity. A field may indicate one index/identifier of the HARQ process/HARQ entity. A field may indicate multiple index/identifiers of the HARQ process/HARQ entity.

An UL signaling may comprise a bitmap to indicate the one or more HARQ process/HARQ entity. A bit of the bitmap may indicate one HARQ process/HARQ entity. A bit of the bitmap may indicate multiple HARQ process/HARQ entity. The UL signaling may comprise a list to indicate the one or more HARQ process/HARQ entity.

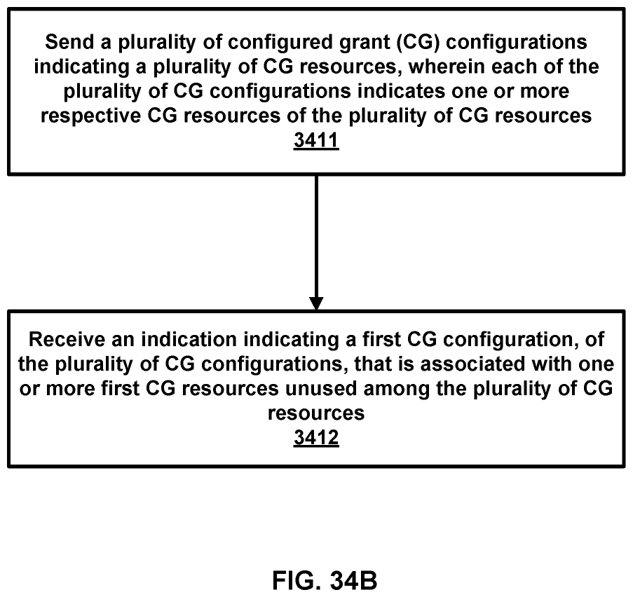

FIG. 34A shows an example embodiment. At 3401, a wireless device may receive a plurality of configured grant (CG) configurations indicating a plurality of CG resources, wherein each of the plurality of CG configurations may indicate one or more respective CG resources of the plurality of CG resources. At 3402, the wireless device may send (e.g., transmits) an indication indicating a first CG configuration of the plurality of CG configurations that is associated with one or more first CG resources unused among the plurality of CG resources.

FIG. 34B shows an example embodiment. At 3411, a base station may send a plurality of configured grant (CG) configurations indicating a plurality of CG resources, wherein each of the plurality of CG configurations may indicate one or more respective CG resources of the plurality of CG resources. At 3402, the base station may receive an indication indicating a first CG configuration of the plurality of CG configurations that is associated with one or more first CG resources unused among the plurality of CG resources.

A wireless device may perform various operations. The wireless device may receive at least one message indicating a configured grant (CG) configuration, wherein the at least one message may comprise: a first parameter indicating a quantity of slots for one or more CG transmission occasions (TOs) in a period of the CG configuration; and a second parameter indicating a quantity of bits in a bitmap for uplink control information (UCI), wherein each bit in the bitmap may indicate whether a respective CG TO of the CG configuration, is to be used or unused for uplink transmission. The wireless device may send, via a first CG TO of the CG configuration, UCI comprising the bitmap, wherein at least one CG TO, associated with the bitmap, may be subsequent to the first CG TO. The wireless device may send a first uplink signal via a second CG TO of the one or more CG TOs, wherein the sending the first uplink signal via the second CG TO may be based on: a first bit, in the bitmap, being associated with the second CG TO; and a first value of the first bit indicating the second CG TO is to be used for uplink transmission. The wireless device may skip sending a second uplink signal via a third CG TO of the one or more CG TOs, wherein the skipping may be based on: a second bit, in the bitmap, being associated with the third CG TO; and a second value of the second bit indicating the third CG TO may be to be unused for uplink transmission, wherein: the CG configuration may comprise a parameter indicating a time offset; and the one or more CG TOs may occur after the time offset from the first CG TO. The wireless device may skip sending a third uplink signal via a fourth CG TO, of the one or more CG TOs, after the time offset; and may resume sending a fourth uplink signal via a fifth CG TO, of the one or more CG TOs, after skipping sending the third uplink signal, wherein the UCI may comprise one or more fields, and each field of the one or more fields: is associated with one or more CG resources of the plurality of CG resources; and indicates whether the CG resources are used or not; wherein the UCI may comprise one or more fields, and each field of the one or more fields: may be associated with a respective CG resource of the plurality of CG resources; and may indicate whether the respective CG resources are used or not; wherein the CG resource may occur after sending the UCI may be one or more CG resources, of the plurality of CG resources, after a transmission delay from the UCI transmission; wherein the transmission delay may be based on a pre-defined value or the transmission delay may be based on a value indicated by a BS; wherein the CG resource may occur after transmitting the UCI may be one or more CG resources, of the plurality of CG resources, after an application delay from the UCI transmission; wherein the application delay may be based on a pre-defined value or the application delay may be based on a value indicated by a BS; wherein the CG resource may occur after transmitting the UCI is one or more CG resources, of the plurality of CG resources, after a processing time from the UCI transmission, wherein the processing time may be a processing time for a BS, the processing time may be based on a pre-defined value or the processing time may be based on a value indicated by a BS; wherein the CG resource may occur after sending the UCI may be one or more CG resources, of the plurality of CG resource, after an end of a time duration from the UCI transmission, wherein the time duration may be based on a pre-defined value or the time duration may be based on a value indicated by a BS; wherein the CG resource may occur after transmitting the UCI may be one or more CG resources, of the plurality of CG resource, after transmitting the UCI and after an expiration of a timer, wherein the timer may be started or restarted in response to transmitting the UCI. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may perform various operations. The wireless device may receive at least one message indicating a configured grant (CG) configuration, wherein the CG configuration may indicate a plurality of CG resources. The wireless device may send uplink control information (UCI) comprising an indication of at least one unused CG resource, wherein the at least one unused CG resource may occur during a time period after the sending the UCI. The wireless device may skip, based on the UCI, the at least one unused CG resource. The wireless device may resume at least one used CG resource after the skipping the at least one unused CG resource, wherein the at least one used CG resource is indicated in the UCI. The wireless device may skip, based on a first bit in the indication, the at least one unused CG resource, wherein the first bit may indicate the at least one unused CG resource; wherein the time period may be based on at least one of: a transmission delay; an application delay; a processing time; or an expiration of a timer; wherein: the time period may be indicated by the UCI; and the time period may be based on at least one of: slot; subframe; system frame; millisecond; second; discontinuous reception (DRX) cycle; CG periodicity; a pre-defined value; or a value indicated by a base station; wherein: the CG configuration may indicate a first set of CG resources within a first CG period and a second set of CG resources within a second CG period. The wireless device may send the UCI comprises: sending the UCI within the first CG period; and skipping the at least one unused CG resource comprises: skipping remaining resources of the first set of CG resources within the first CG period. The wireless device may resume the second set of CG resources within the second CG period. The wireless device may start, or restart, a timer after sending the UCI; wherein the UCI may comprise one or more fields, and each field of the one or more fields: is associated with one or more CG resources of the plurality of CG resources; and indicates whether the CG resources are used or not; wherein the UCI may comprise one or more fields, and each field of the one or more fields: may be associated with a respective CG resource of the plurality of CG resources; and may indicate whether the respective CG resources are used or not; wherein the CG resource may occur after sending the UCI may be one or more CG resources, of the plurality of CG resources, after a transmission delay from the UCI transmission; wherein the transmission delay may be based on a pre-defined value or the transmission delay may be based on a value indicated by a BS; wherein the CG resource may occur after transmitting the UCI may be one or more CG resources, of the plurality of CG resources, after an application delay from the UCI transmission; wherein the application delay may be based on a pre-defined value or the application delay may be based on a value indicated by a BS; wherein the CG resource may occur after transmitting the UCI is one or more CG resources, of the plurality of CG resources, after a processing time from the UCI transmission, wherein the processing time may be a processing time for a BS, the processing time may be based on a pre-defined value or the processing time may be based on a value indicated by a BS; wherein the CG resource may occur after sending the UCI may be one or more CG resources, of the plurality of CG resource, after an end of a time duration from the UCI transmission, wherein the time duration may be based on a pre-defined value or the time duration may be based on a value indicated by a BS; wherein the CG resource may occur after transmitting the UCI may be one or more CG resources, of the plurality of CG resource, after transmitting the UCI and after an expiration of a timer, wherein the timer may be started or restarted in response to transmitting the UCI. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may perform various operations. The wireless device may receive at least one message indicating a configured grant (CG) configuration, wherein the CG configuration may indicate a plurality of CG resources. The wireless device may send uplink control information (UCI) indicating that at least one CG resource of the plurality of CG resources may be unused, or used, based on a field of the UCI. The wireless device may skip, based on sending the UCI, a configured transmission via the at least one CG resource; wherein: the field may be a bitmap and may comprise a first value and a second value; and wherein: the field, based on the first value, may indicate an unused CG resource of the plurality of CG resources; or the field, based on the second value, may indicate a used CG resource of the plurality of CG resources; wherein the at least one message may comprise: a first parameter indicating a quantity of CG transmission occasions (TOs) in a period of the CG configuration; and a second parameter indicating a quantity of bits in a bitmap for uplink control information (UCI), wherein each bit in the bitmap may indicate whether a respective CG TO of the CG configuration, may be to be used or unused for uplink transmission. The wireless device may send the UCI via a first CG resource within a CG period, wherein the first CG resource within the CG period may be indicated by the CG configuration; or may send the UCI via a last CG resource within a CG period, wherein the last CG resource within a CG period may be indicated by the CG configuration; wherein the at least one CG resource may be: Physical Uplink Shared Channel (PUSCH) resource; or Physical uplink control channel (PUCCH) resource; wherein: the at least one CG resource may be associated with a first CG period and sending the UCI may comprise sending the UCI during the first CG period; or the at least one CG resource may be associated with a second CG period and sending the UCI may comprise sending the UCI during the first CG period and prior to the second CG period; wherein: the UCI may comprise a first value indicating that remaining CG resources, of the plurality of CG resources, may be unused; or the UCI may comprise a second value indicating that remaining CG resources, of the plurality of CG resources, may be used. The wireless device may determine whether one or more CG resources, of the plurality of CG resources and within the CG period, may be used or unused; and based on the determining: the wireless device may send the UCI if the one or more CG resources of the plurality of CG resources within the CG period are unused; or may skip sending the UCI if the one or more CG resources of the plurality of CG resources within the CG period are used; wherein the UCI may comprise one or more fields, and each field of the one or more fields: is associated with one or more CG resources of the plurality of CG resources; and indicates whether the CG resources are used or not; wherein the UCI may comprise one or more fields, and each field of the one or more fields: may be associated with a respective CG resource of the plurality of CG resources; and may indicate whether the respective CG resources are used or not; wherein the CG resource may occur after sending the UCI may be one or more CG resources, of the plurality of CG resources, after a transmission delay from the UCI transmission; wherein the transmission delay may be based on a pre-defined value or the transmission delay may be based on a value indicated by a BS; wherein the CG resource may occur after transmitting the UCI may be one or more CG resources, of the plurality of CG resources, after an application delay from the UCI transmission; wherein the application delay may be based on a pre-defined value or the application delay may be based on a value indicated by a BS; wherein the CG resource may occur after transmitting the UCI is one or more CG resources, of the plurality of CG resources, after a processing time from the UCI transmission, wherein the processing time may be a processing time for a BS, the processing time may be based on a pre-defined value or the processing time may be based on a value indicated by a BS; wherein the CG resource may occur after sending the UCI may be one or more CG resources, of the plurality of CG resource, after an end of a time duration from the UCI transmission, wherein the time duration may be based on a pre-defined value or the time duration may be based on a value indicated by a BS; wherein the CG resource may occur after transmitting the UCI may be one or more CG resources, of the plurality of CG resource, after transmitting the UCI and after an expiration of a timer, wherein the timer may be started or restarted in response to transmitting the UCI. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may perform various operations. The wireless device may receive at least one message indicating a plurality of configured grant (CG) configurations, wherein each CG configuration, of the plurality of CG configurations, may indicate at least one CG transmission occasion (TO) of a plurality of CG TOs. The wireless device may send uplink control information (UCI) comprising: an indicated CG configuration of the plurality of CG configurations; and at least one bit field indicating whether a CG TO, indicated in the indicated CG configuration, may be to be used or unused for uplink transmission; wherein the UCI may comprise a first index to indicate a first CG configuration as the indicated CG configuration. The wireless device may skip, based on the sending the UCI, the uplink transmission via the CG TO indicated in the indicated CG configuration; wherein: the plurality of CG configurations may be grouped into one or more CG groups; and the indicated CG configuration may be indicated by a group identifier of a first CG group of the one or more CG groups, wherein the group identifier may be associated with a first CG configuration; wherein: the at least one bit field may comprise a first bit and a second bit; a first bit comprising a first value may be associated with a first CG configuration; the first value may indicate at least one CG TO may be unused a second bit comprising a second value may be associated with a second CG configuration; and the second value may indicate at least one CG TO is used. The wireless device may determine that the CG TO indicated in the indicated CG configuration is unused; selecting, based on the determining, a second CG TO indicated in the indicated CG configuration; and wherein the sending the UCI may comprise sending the UCI via the second CG TO; wherein receiving the at least one message may comprise receiving a first CG configuration and a second CG configuration. The wireless device may activate the first CG configuration and the second CG configuration; wherein sending the UCI may comprise sending the UCI via an uplink source, and wherein the uplink source may be at least one of: a physical uplink shared channel (PUSCH) resource; or a physical uplink control channel (PUCCH) resource. The wireless device may start, based on sending the UCI, a timer; and may skip, based on the timer, the CG TO indicated by the CG configuration; wherein the first CG configuration and the second CG configuration may be activated or initialized; wherein the first CG configuration and the second CG configuration may be in an active state; wherein the first CG configuration and the second CG configuration may indicate a configuration parameter for the indication; wherein the first CG configuration and the second CG configuration may indicate enable for the indication; wherein the first CG configuration may indicate a configuration parameter for the indication, but the second CG configuration may not indicate the configuration parameter for the indication; wherein the first CG configuration may indicate enable for the indication, but the second CG configuration may indicate disable for the indication; wherein the indication may be an unused configuration grant resource occasions (CGO) indication; wherein the indication may be transmitted via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may perform various operations. The wireless device may receive a first configured grant (CG) configuration associated with a first CG index and a second CG configuration associated with a second CG index. The wireless device may skip a first uplink transmission via at least one first CG resource indicated by the first CG configuration, wherein the skipping may be based on the at least one first CG resource being indicated as to be unused. The wireless device may send a second uplink transmission via at least one second CG resource indicated by the second CG configuration, wherein the sending may be based on the at least one second CG resource being indicated as to be used. The wireless device may send an indication comprising a bitmap, wherein: the bitmap may indicate at least a first bit comprising a first value and a second bit comprising a second value; and the first bit may be associated with the first CG configuration, and the second bit may be associated with the second CG configuration. The wireless device may send an indication, comprising the first CG index associated with the first CG configuration, to indicate that the at least one first CG resource is to be unused; wherein each of the first CG configuration and the second CG configuration indicates periodic CG resources. The wireless device may receive: a first set of CG configurations comprising a configuration parameter of an indication; and a second set of CG configurations not comprising the configuration parameter of the indication. The wireless device may receive a configuration for an unused CGO indication, wherein the configuration may indicate an association between the unused CGO indication and the at least one first CG resource indicated by the first CG configuration; and may send, based on the configuration for the unused CGO indication, the unused CGO indication. The wireless device may determine that the at least one first CG resource may be to be unused by determining whether: there is no uplink data for transmission; or a first size of uplink data is smaller than a second size of the at least one first CG resource; wherein the first CG configuration and the second CG configuration may be activated or initialized; wherein the first CG configuration and the second CG configuration may be in an active state; wherein the first CG configuration and the second CG configuration may indicate a configuration parameter for the indication; wherein the first CG configuration and the second CG configuration may indicate enable for the indication; wherein the first CG configuration may indicate a configuration parameter for the indication, but the second CG configuration may not indicate the configuration parameter for the indication; wherein the first CG configuration may indicate enable for the indication, but the second CG configuration may indicate disable for the indication; wherein the indication may be an unused configuration grant resource occasions (CGO) indication; wherein the indication may be transmitted via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A base station may perform various operations. The base station may send at least one message indicating a plurality of configured grant (CG) configurations, wherein each CG configuration, of the plurality of CG configurations, may indicate at least one CG transmission occasion (TO) of a plurality of CG TOs. The base station may receive uplink control information (UCI) comprising: an indicated CG configuration of the plurality of CG configurations; and at least one bit field indicating whether a CG TO indicated in the indicated CG configuration, is to be used or unused for uplink transmission; wherein the receiving the UCI may comprise receiving, from a first wireless device, the UCI. The base station may reallocate the first CG TO for a second wireless device; wherein the sending the plurality of CG configurations may comprise sending a first CG configuration and a second CG configuration; and wherein the receiving the UCI may comprise: receiving, based on the at least one CG TO determined to be unused for the uplink transmission, the UCI. The base station may receive second UCI comprising: an indication indicating a second CG configuration of the plurality of CG configurations; and at least one bit field indicating whether a second CG TO, indicated by the second CG configuration, is to be used or unused for transmission; wherein the first CG configuration and the second CG configuration may be activated or initialized; wherein the first CG configuration and the second CG configuration may be in an active state; wherein the first CG configuration and the second CG configuration may indicate a configuration parameter for the indication; wherein the first CG configuration and the second CG configuration may indicate enable for the indication; wherein the first CG configuration may indicate a configuration parameter for the indication, but the second CG configuration may not indicate the configuration parameter for the indication; wherein the first CG configuration may indicate enable for the indication, but the second CG configuration may indicate disable for the indication; wherein the indication may be an unused configuration grant resource occasions (CGO) indication; wherein the indication may be transmitted via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may perform various operations. The wireless device may receive at least one message indicating a configured grant (CG) configuration, wherein the CG configuration indicates a plurality of CG resources. The wireless device may send uplink control information (UCI) indicating that at least one CG resource of the plurality of CG resources is unused, or used, based on a field of the UCI. The wireless device may skip, based on sending the UCI, a configured transmission via the at least one CG resource; wherein: the field may be a bitmap and may comprise a first value and a second value; and wherein: the field, based on the first value, may indicate an unused CG resource of the plurality of CG resources; or the field, based on the second value, indicates a used CG resource of the plurality of CG resources; wherein the at least one message may comprise: a first parameter indicating a quantity of CG transmission occasions (TOs) in a period of the CG configuration; and a second parameter indicating a quantity of bits in a bitmap for uplink control information (UCI), wherein each bit in the bitmap indicates whether a respective CG TO of the CG configuration, is to be used or unused for uplink transmission. The wireless device may send the UCI via a first CG resource within a CG period, wherein the first CG resource within the CG period may be indicated by the CG configuration; or may send the UCI via a last CG resource within a CG period, wherein the last CG resource within a CG period may be indicated by the CG configuration; wherein the first CG configuration and the second CG configuration may be activated or initialized; wherein the first CG configuration and the second CG configuration may be in an active state; wherein the first CG configuration and the second CG configuration may indicate a configuration parameter for the indication; wherein the first CG configuration and the second CG configuration may indicate enable for the indication; wherein the first CG configuration may indicate a configuration parameter for the indication, but the second CG configuration may not indicate the configuration parameter for the indication; wherein the first CG configuration may indicate enable for the indication, but the second CG configuration may indicate disable for the indication; wherein the indication may be an unused configuration grant resource occasions (CGO) indication; wherein the indication may be transmitted via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; and the wireless device may send (e.g., transmit) uplink control information (UCI) indicating a first CG resource, wherein one or more unused CG resources of the plurality of CG resources may occur from the first CG resource. The wireless device may skip (e.g., prevent from use of) the one or more unused CG resources from the first CG resource. The first CG resource may occur after a time period (offset) from sending (e.g., transmitting) the UCI. The time period (offset) may be based on at least one of a quantity (e.g., number) of time units, a time duration, a transmission delay, an application delay, a processing time, and/or an expiration of a timer. The UCI may comprise one or more fields, and each field of the one or more fields: may be associated with one or more CG resources of the plurality of CG resources; and/or may indicate whether the CG resources are used or not. The UCI may comprise one or more fields, and each field of the one or more fields: may be associated with a respective CG resource of the plurality of CG resources; and/or may indicate whether the respective CG resources are used or not. The wireless device may skip (e.g., prevent from use of) the one or more unused CG resources from the first CG resource, associated with a period indicated by the CG configuration, to an end of the period. The wireless device may skip (e.g., prevent from use of) the one or more unused CG resources, based on a value, from the first CG resource, wherein the value may indicate a quantity (e.g., number) of the one or more unused CG resources. The value may be indicated by a configuration parameter. The value may be indicated by the UCI. The wireless device may skip (e.g., prevent from use of) the one or more unused CG resources from the first CG resource within a duration. The wireless device may skip (e.g., prevent from use of) the one or more unused CG resources from the first CG resource while a timer is running. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating one or more CG resource sets, wherein each CG resource set of the one or more CG resource sets may comprise one or more respective CG resources; the wireless device may send (e.g., transmit) uplink control information (UCI) indicating that a first CG resource set is unused; and/or the wireless device may skip one or more transmission, via one or more first CG resources, wherein the one or more first CG resources are associated with the first CG resource set. The wireless device may not skip one or more transmission, via one or more second CG resources, wherein the one or more second resources may be associated with a different CG resource set from the first CG resource set. The UCI may be sent (e.g., transmitted) via a CG resource within a first period indicated by the CG configuration; and/or the one or more first CG resources may be associated with the first periodic. A quantity (e.g., number) of the one or more first CG resources, included in the first CG resource set, may be indicated by a value. The value may be indicated by a configuration parameter. According to an example embodiment, the value may be indicated by the UCI. The one or more first CG resources may be associated with one or more first period indicated by the CG configuration; and/or the one or more second CG resources may be associated with one or more second period indicated by the CG configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) indicating that one or more CG resources, of the plurality of CG resource, are unused; and/or the wireless device may start or restart a timer in response to sending (e.g., transmitting) the UCI; and/or the wireless device may skip a CG resource of the plurality of CG resource based on the timer being running. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) comprising an indication of an unused CG resource, wherein the unused CG resource occurs after a time period (offset) starting based on (e.g., in response to) sending (e.g., transmitting) the UCI; and/or the wireless device may skip (e.g., prevent from use of), based on the sending (e.g., transmitting), the unused CG resource. The wireless device may skip, based on the sending (e.g., transmitting), uplink transmission via the unused CG resource. The time period (offset) may be based on at least one of a quantity (e.g., number) of time units, a time duration, a transmission delay, an application delay, a processing time, and an expiration of a timer. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) indicating that one or more CG resources, of the plurality of CG resources, are unused; and/or the wireless device may skip (e.g., prevent from use of) the one or more CG resources after a time period (offset) from sending (e.g., transmitting) the UCI. The time period (offset) may be based on at least one of a quantity (e.g., number) of time units, a time duration, a transmission delay, an application delay, a processing time, and an expiration of a timer. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive, by a wireless device, a configured grant (CG) configuration indicating a plurality of CG resources; the wireless device may send (e.g., transmit) uplink control information (UCI) indicating that a CG resource occurs after sending (e.g., transmitting) the UCI, of the plurality of CG resources, is unused; and/or the wireless device may skip (e.g., prevent from use of) the CG resource for transmission in response to sending (e.g., transmitting) the UCI. The CG resource may occur after sending (e.g., transmitting) the UCI is one or more CG resources, of the plurality of CG resources, after a quantity (e.g., number) of time units from the UCI transmission. The time unit may be based on slot, subframe, system frame, millisecond, second, DRX cycle, or CG periodicity. The quantity (e.g., number) of time units may be indicated by the UCI. The quantity (e.g., number) of time units may be based on a pre-defined value. The quantity (e.g., number) of time units may be based on a value indicated by a BS. The CG resource may occur after sending (e.g., transmitting) the UCI is one or more CG resources of the plurality of CG resources, after a transmission delay from the UCI transmission. The transmission delay may be based on a pre-defined value. The transmission delay may be based on a value indicated by a BS. The CG resource may occur after sending (e.g., transmitting) the UCI is one or more CG resources of the plurality of CG resources, after an application delay from the UCI transmission. The application delay may be based on a pre-defined value. The application delay may be based on a value indicated by a BS. The CG resource may occur after sending (e.g., transmitting) the UCI is one or more CG resources of the plurality of CG resources, after a processing time from the UCI transmission. The processing time may be a processing time for a BS. The processing time may be based on a pre-defined value. The processing time may be based on a value indicated by a BS. The CG resource may occur after sending (e.g., transmitting) the UCI is one or more CG resources of the plurality of CG resource, after an end of a time duration from the UCI transmission. The time duration may be based on a pre-defined value. The time duration may be based on a value indicated by a BS. The CG resource may occur after sending (e.g., transmitting) the UCI is one or more CG resources of the plurality of CG resource, after sending (e.g., transmitting) the UCI and after an expiration of a timer. The timer may be started or restarted in response to sending (e.g., transmitting) the UCI. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; and/or the wireless device may send (e.g., transmit) uplink control information (UCI) indicating that a CG resource, of the plurality of CG resources, are unused. The wireless device may not use the CG resource for transmission based on (e.g., in response to) sending (e.g., transmitting) the UCI, wherein the CG resource may be a next CG resource after sending (e.g., transmitting) the UCI. The next CG resource may be one or more CG resources of the plurality of CG resource, after sending (e.g., transmitting) the UCI. The next CG resource may be one or more CG resources of the plurality of CG resource, after a quantity (e.g., number) of time units from the UCI transmission. The time unit may be based on slot, subframe, system frame, millisecond, second, DRX cycle, or CG periodicity. The quantity (e.g., number) of time unit may be indicated by the UCI. The quantity (e.g., number) of time unit may be based on a pre-defined value. The quantity (e.g., number) of time unit may be based on a value indicated by a BS. The next CG resource may be one or more CG resources of the plurality of CG resource, after a transmission delay from the UCI transmission. The transmission delay may be based on a pre-defined value. The transmission delay may be based on a value indicated by a BS. The next CG resource may be one or more CG resources of the plurality of CG resource, after an application delay from the UCI transmission. The application delay may be based on a pre-defined value. The application delay may be based on a value indicated by a BS. The next CG resource may be one or more CG resources of the plurality of CG resource, after a processing time from the UCI transmission. The processing time may be a processing time for a BS. The processing time may be based on a pre-defined value. The processing time may be based on a value indicated by a BS. The next CG resource may be one or more CG resources of the plurality of CG resource, after an end of a time duration from the UCI transmission. The time duration may be based on a pre-defined value. The time duration may be based on a value indicated by a BS. The next CG resource may be one or more CG resources of the plurality of CG resource, after sending (e.g., transmitting) the UCI and after an expiration of a timer. The timer may be started or restarted in response to sending (e.g., transmitting) the UCI. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) comprising a bitmap, wherein: each bit of the bitmap may be associated with a respective CG resource of the plurality of CG resources; each bit of the bitmap may indicate whether the respective CG resource is unused; and/or the wireless device may skip (e.g., prevent from use of) a first CG resource of the plurality of CG resources, based on a first bit in the bitmap, wherein the bitmap: being associated with the first CG resource; and/or may indicate that the first CG resource is unused. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) indicating that one or more CG resources of the plurality of CG resource, are unused/used based on a bitmap of the UCI, wherein each bit of the bitmap indicating a status of the unused/used for each CG resource of the one or more CG resources. After a time period (offset) from sending (e.g., transmitting) the UCI: the wireless device may skip (e.g., prevent from use of) a first CG resource of the one or more CG resources, based on (e.g., in response to) a first bit of the bitmap indicating a first value for the first CG resource; and/or the wireless device may stop skipping (e.g., preventing from use of) a second CG resource of the one or more CG resources, based on (e.g., in response to) a second bit of the bitmap indicating a second value for the second CG resource. The time period (offset) may be based on at least one of a quantity (e.g., number) of time units, a time duration, a transmission delay, an application delay, a processing time, and an expiration of a timer. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; and/or the wireless device may send (e.g., transmit) uplink control information (UCI) indicating that one or more CG resources of the plurality of CG resource, are unused/used based on a field of the UCI, wherein the field may be a bitmap. The wireless device may skip (e.g., prevent from use of) the one or more CG resources for transmission in response to sending (e.g., transmitting) the UCI. The filed may indicate a status of unused or used for the one or more CG resources. The field may indicate that a CG resource of the plurality of CG resource is unused based on a first value. The first value may be zero or one. The field may indicate that a CG resource of the plurality of CG resource is used based on a second value. The second value may be zero or one. The UCI may be sent (e.g., transmitted) via a first CG resource within a CG period indicated by the CG configuration. The UCI may be sent (e.g., transmitted) via a last CG resource within a CG period indicated by the CG configuration. The UCI may be sent (e.g., transmitted) via any UL resource indicated by the CG configuration. The UL resource may be a CG resource indicated by the CG configuration. The UL resource may be a PUSCH resource. The UL resource may be a PUCCH resource. The one or more CG resources may be associated with a first CG period and the UCI may be sent (e.g., transmitted) in the first CG period. The one or more CG resources may be associated with a second CG period and the UCI may be sent (e.g., transmitted) in a first CG period prior to the second CG period. The second CG period may be a next CG period of the first CG period. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive, by a wireless device, a configured grant (CG) configuration indicating a plurality of CG resources; and/or the wireless device may send (e.g., transmit) uplink control information (UCI) indicating that one or more CG resources of the plurality of CG resource, are unused or used based on a field of the UCI. The wireless device may not use the one or more CG resources for transmission based on (e.g., in response to) sending (e.g., transmitting) the UCI. The field may be a bitmap. The filed may indicate a status of unused or used for the one or more CG resources. The field may indicate that a CG resource of the plurality of CG resource is unused based on a first value. The first value may be zero or one. The field may indicate that a CG resource of the plurality of CG resource is used based on a second value. According to an example embodiment, the second value may be zero or one. The UCI may be sent (e.g., transmitted) via a first CG resource within a CG period indicated by the CG configuration. The UCI may be sent (e.g., transmitted) via a last CG resource within a CG period indicated by the CG configuration. According to an example embodiment, the UCI may be sent (e.g., transmitted) via any UL resource indicated by the CG configuration. The UL resource may be a CG resource indicated by the CG configuration. The UL resource may be a PUSCH resource. The UL resource may be a PUCCH resource. The one or more CG resources may be associated with a first CG period and the UCI is sent (e.g., transmitted) in the first CG period. The one or more CG resources may be associated with a second CG period and the UCI may be sent (e.g., transmitted) in a first CG period prior to the second CG period. According to an example embodiment, the second CG period may be a next CG period of the first CG period. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a first set of CG resources within a first CG period and a second set of CG resource within a second CG period; the wireless device may send (e.g., transmit) uplink control information (UCI), within the first CG period, indicating that one or more CG resources of the first set of CG resource, are unused; after a time period (offset) from sending (e.g., transmitting) the UCI: the wireless device may skip (e.g., prevent from use of) remaining (subsequent) CG resources, of the first set of CG resource; and/or the wireless device may stop skipping (e.g., prevent from use of) the second set of CG resources. The time period (offset) may be based on at least one of a quantity (e.g., number) of time units, a time duration, a transmission delay, an application delay, a processing time, and an expiration of a timer. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; and the wireless device may send (e.g., transmit) uplink control information (UCI), within a CG period, indicating that one or more CG resources of the plurality of CG resources, are unused; and the wireless device may skip (e.g., prevent from use of) the one or more CG resources based on (e.g., in response to) sending (e.g., transmitting) the UCI, wherein the one or more CG resources may be remaining (subsequent) resources within the CG period after sending (e.g., transmitting) the UCI. The UCI may comprise a first value indicating that the remaining (subsequent) CG resource are unused. The UCI may comprise a second value indicating that the remaining (subsequent) CG resource are used. The wireless device may determine one or more CG resources of the plurality of CG resources within the CG period are unused; and the wireless device may send (e.g., transmit) the UCI based on (e.g., in response to) the determining. The wireless device may determine one or more CG resources, of the plurality of CG resources, within the CG period are used; and the wireless device may not send (e.g., transmit) the UCI in response to the determining. The remaining (subsequent) CG resources may be resources within the CG period after a quantity (e.g., number) of time units from the UCI transmission. The time unit may be based on slot, subframe, system frame, millisecond, second, DRX cycle, or CG periodicity. The quantity (e.g., number) of time unit may be indicated by the UCI. The quantity (e.g., number) of time unit may be based on a pre-defined value. The quantity (e.g., number) of time unit may be based on a value indicated by a BS. The remaining (subsequent) CG resources may be resources within the CG period after a transmission delay from the UCI transmission. The transmission delay may be based on a pre-defined value. The transmission delay may be based on a value indicated by a BS. The remaining (subsequent) CG resources may be resources within the CG period after an application delay from the UCI transmission. The application delay may be based on a pre-defined value. The application delay may be based on a value indicated by a BS. The remaining (subsequent) CG resources may be resources within the CG period after a processing time from the UCI transmission. The processing time may be a processing time for a BS. According to an example embodiment, the processing time may be based on a pre-defined value. According to an example embodiment, the processing time may be based on a value indicated by a BS. The remaining (subsequent) CG resources may be resources within the CG period after an end of a time duration from the UCI transmission. The time duration may be based on a pre-defined value. The time duration may be based on a value indicated by a BS. The remaining (subsequent) CG resources may be resources within the CG period after an expiration of a timer from the UCI transmission. The timer may be started or restarted in response to sending (e.g., transmitting) the UCI. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) comprising a value to indicate one or more CG resources of the plurality of CG resources are not used; based on (e.g., in response to) sending (e.g., transmitting) the UCI: the wireless device may skip (e.g., prevent from use of) the one or more CG resources based on the value; and the wireless device may stop skipping (e.g., prevent from use of) a CG resource, of the plurality of CG resources, which may not be the one or more CG resources after skipping (e.g., preventing from use of) the one or more CG resources. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) indicating that one or more CG resources of the plurality of CG resource are unused; and the wireless device may skip (e.g., prevent from use of) the one or more CG resources based on a value, wherein the value may indicate a quantity (e.g., number) of the one or more CG resource to be unused. The value may be indicated by the UCI. The value may be indicated by a RRC configuration from a BS. The value may be indicated by DCI or a MAC CE from a BS. The one or more CG resources may be associated with a CG period. The one or more CG resources may be associated one or more CG periods. The wireless device may increase or decrease a value of a counter based on (e.g., in response to) not using a CG resource of the one or more CG resources. The counter may be decreased by one in response to not using one of the one or more CG resources. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) indicating that one or more CG resources of the plurality of CG resource are unused; based on (e.g., in response to) sending (e.g., transmitting) the UCI: the wireless device may skip (e.g., prevent from use of) the one or more CG resources from a start of a duration; and the wireless device may stop skipping (preventing from use of) the one or more CG resources after an end of the duration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating a plurality of CG resources; the wireless device may send (e.g., transmit) uplink control information (UCI) indicating that one or more CG resources of the plurality of CG resource are unused; and/or the wireless device may skip (e.g., prevent from use of) the one or more CG resources within a duration. The wireless device may use the one or more CG resources after an end of the duration. The duration may be based on a value indicated by a RRC configuration, a MAC CE, or DCI. The duration may be based on one or more CG periods. The one or more CG periods may be based on a value that indicates a quantity (e.g., number) of the one or more CG periods. The one or more CG period may comprise a CG period for transmission of the UCI. The one or more CG period may start from a CG period after transmission of the UCI. The one or more CG period may start from a next CG period after transmission of the UCI. The value may be indicated by the UCI. The value may be indicated by a RRC configuration from a BS. The value may be indicated by DCI or a MAC CE from a BS. The wireless device may increase or decrease a value of a counter based on (e.g., in response to) not using the one or more CG resource within the one or more CG periods. The counter may be decreased by one based on (e.g., in response to) not using the one or more CG resources of one CG period. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a configured grant (CG) configuration indicating: a plurality of CG resources; and/or a timer; the wireless device may send (e.g., transmit) uplink control information (UCI) indicating that one or more CG resources of the plurality of CG resource are unused; the wireless device may start or restart the timer in response to sending (e.g., transmitting) the UCI; the wireless device may skip (e.g., prevent from use of) the one or more CG resources, for example, if the timer is running; and/or the wireless device may stop skipping (e.g., prevent from use of) the one or more CG resources, for example, if the timer is not running or after the timer expires. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive, by a wireless device, a configured grant (CG) configuration indicating a plurality of CG resources; the wireless device may send (e.g., transmit) uplink control information (UCI) indicating that one or more CG resources, of the plurality of CG resource, are unused; and/or the wireless device may use or not use the one or more CG resources based on a timer. The wireless device may not use the one or more CG resources, for example, if the timer is running. The wireless device may use the one or more CG resources, for example, if the timer is not running. The wireless device may start or restart the timer, for example, if or after sending (e.g., transmitting) the UCI. The wireless device may start or restart the timer based on (e.g., in response to) receiving a first indication from a BS. The wireless device may stop the timer based on (e.g., in response to) receiving a second indication from a BS. The wireless device may stop the timer, for example, if an UL data arrival. The wireless device may stop the timer, for example, if triggering a buffer status report. The wireless device may stop the timer, for example, if triggering a scheduling request. The wireless device may start or restart the timer after a quantity (e.g., number) of time units from the UCI transmission. The time unit may be based on slot, subframe, system frame, millisecond, second, DRX cycle, or CG periodicity. The quantity (e.g., number) of time unit may be indicated by the UCI. According to an example embodiment, the quantity (e.g., number) of time unit may be based on a pre-defined value. According to an example embodiment, the quantity (e.g., number) of time unit may be based on a value indicated by a BS. The wireless device may start or restart the timer after a transmission delay from the UCI transmission. The transmission delay may be based on a pre-defined value. The transmission delay may be based on a value indicated by a BS. The wireless device may start or restart the timer after an application delay from the UCI transmission. The application delay may be based on a pre-defined value. The application delay may be based on a value indicated by a BS. The wireless device may start or restart the timer after a processing time from the UCI transmission. The processing time may be a processing time for a BS. The processing time may be based on a pre-defined value. The processing time may be based on a value indicated by a BS. The wireless device may start or restart the timer after an end of a time duration from the UCI transmission. The time duration may be based on a pre-defined value. The time duration may be based on a value indicated by a BS. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may be configured with (e.g., indicated by) one or more CG configurations (e.g., based on configuration parameters ConfiguredGrantConfigIndex, ConfiguredGrantConfigIndexMAC, ConfiguredGrantConfig, configuredGrantConfigToAddModList, and/or configuredGrantConfigToReleaseList). The wireless device (e.g., UE) may activate/initialize one or more CGs among the one or more CG configurations. The wireless device (e.g., UE) may initialize or re-initialize the configured uplink grant (for a Serving Cell) to start in the associated PUSCH duration and to recur sequentially with periodicity, for example, if the wireless device (e.g., UE) receives contents indicate configured grant Type 2 activation. The wireless device (e.g., UE/MAC entity), upon configuration of a configured grant Type 1 for a BWP of a Serving Cell, may initialize or re-initialize the configured uplink grant to start in the symbol according to timeDomainOffset, timeReferenceSFN, and S (derived from SLIV or provided by startSymbol and to reoccur sequentially with periodicity. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may determine the size/quantity/number of the multiple fields (e.g., the size of the bitmap) of the unused CGO indication may be based on the quantity (e.g., number) of the CGOs (configured within a CG period.) The wireless device (e.g., UE) may determine the size/quantity/number of the multiple fields (e.g., the size of the bitmap) based on the remaining/subsequent/following CGOs within a CG period after sending (e.g., transmitting) the unused CGO indication. The wireless device (e.g., UE) may determine the size/quantity/number of the multiple fields (e.g., the size of the bitmap) based on a (RRC) configuration parameter. The (RRC) configuration parameter may be included in a CG configuration, a configuration for unused CGO indication and/or a configuration for multiple CGOs within a CG period.) The wireless device (e.g., UE) may determine the size/quantity/number of the multiple fields (e.g., the size of the bitmap) based on how many number of CGOs will be unused/skipped. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) the unused CGO periodically and/or dynamically (e.g., if/when the wireless device (e.g., UE) triggers the transmission of the unused CGO indication). The wireless device (e.g., UE) may send (e.g., transmit) the unused CGO indication in each CG period and or in a certain period configured by a configuration parameter. The wireless device (e.g., UE) may send (e.g., transmit) the unused CGO no matter whether any unused CGO is determined or not. The wireless device (e.g., UE) may send (e.g., transmit) the unused CGO indication, for example, if the wireless device (e.g., UE) triggers the transmission of the unused CGO indication. The wireless device (e.g., UE) may send (e.g., transmit) the unused CGO indication, for example, if the wireless device (e.g., UE) determines there is unused CGO and (e.g., if there is no data needs to be sent (e.g., transmitted)). The wireless device (e.g., UE) may not send (e.g., transmit) the unused CGO indication, for example, if the wireless device (e.g., UE) does not determine there is unused CGO (e.g., when there is data needs to be sent (e.g., transmitted)). A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may be configured with (e.g., indicated by) a configuration for multiple CGO within a CG period. The configuration for multiple CGO within a CG period may be enabled and/or with value true. The wireless device (e.g., UE) may apply the function in response to sending (e.g., transmitting) the unused CGO indication, for example, if the wireless device (e.g., UE) is configured with (and/or enabled and/or with value true) the configuration for multiple CGO within a CG period. The wireless device (e.g., UE) may clear the CG resources in response to sending (e.g., transmitting) the unused CGO indication, for example, if the wireless device (e.g., UE) is configured with (and/or enabled and/or with value true) the configuration for multiple CGO within a CG period. The wireless device (e.g., UE) may deactivate/suspend the corresponding CGs based on (e.g., in response to) sending (e.g., transmitting) the unused CGO indication, for example, if the wireless device (e.g., UE) is configured with (and/or enabled and/or with value true) the configuration for multiple CGO within a CG period. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may determining/considering the CG resources are invalid/unavailable based on (e.g., in response to) sending (e.g., transmitting) the unused CGO indication, for example, if the wireless device (e.g., UE) is configured with (and/or enabled and/or with value true) the configuration for multiple CGO within a CG period. The wireless device (e.g., UE) may not generate a data for the CG resources based on (e.g., in response to) sending (e.g., transmitting) the unused CGO indication, for example, if the wireless device (e.g., UE) is configured with (and/or enabled and/or with value true) the configuration for multiple CGO within a CG period. The wireless device (e.g., UE) may not apply the function in response to sending (e.g., transmitting) the unused CGO indication, for example, if the wireless device (e.g., UE) is not configured with (and/or disabled and/or with value false) the configuration for multiple CGO within a CG period. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may indicate it supports the capability of unused CGO indication (e.g., by sending the wireless device (e.g., UE) Capability Information message which includes a parameter of unused CGO indication). The wireless device (e.g., UE) may apply the function based on (e.g., in response to) sending (e.g., transmitting) the unused CGO indication, for example, if the UE indicates it supports the capability of unused CGO indication. The wireless device (e.g., UE) may clear the CG resources based on (e.g., in response to) sending (e.g., transmitting) the unused CGO indication, for example, if the wireless device (e.g., UE) indicates it supports the capability of unused CGO indication. The wireless device (e.g., UE) may deactivate/suspend the corresponding CGs in response to sending (e.g., transmitting) the unused CGO indication, for example, if the wireless device (e.g., UE) indicates it supports the capability of unused CGO indication. The wireless device (e.g., UE) may determining/considering the CG resources are invalid/unavailable in response to sending (e.g., transmitting) the unused CGO indication, for example, if the wireless device (e.g., UE) indicates it supports the capability of unused CGO indication. The wireless device (e.g., UE) may not generate a data for the CG resources in response to sending (e.g., transmitting) the unused CGO indication, for example, if the wireless device (e.g., UE) indicates it supports the capability of unused CGO indication. The wireless device (e.g., UE) may not apply the function in response to sending (e.g., transmitting) the unused CGO indication, for example, if the wireless device (e.g., UE) does not indicate it supports the capability of unused CGO indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may be configured with (e.g., indicated by) a configuration for unused CGO indication. The configuration for unused CGO indication may be enabled and/or with value true. The wireless device (e.g., UE) may apply the function based on (e.g., in response to) sending (e.g., transmitting) the unused CGO indication, for example, if the wireless device (e.g., UE) is configured with (and/or enabled and/or with value true) the configuration for unused CGO indication. The wireless device (e.g., UE) may clear the CG resources based on (e.g., in response to) sending (e.g., transmitting) the unused CGO indication, for example, if the wireless device (e.g., UE) is configured with (and/or enabled and/or with value true) the configuration for unused CGO indication. The wireless device (e.g., UE) may deactivate/suspend the corresponding CGs based on (e.g., in response to) sending (e.g., transmitting) the unused CGO indication, for example, if the wireless device (e.g., UE) is configured with (and/or enabled and/or with value true) the configuration for unused CGO indication. The wireless device (e.g., UE) may determine/consider the CG resources are invalid/unavailable based on (e.g., in response to) sending (e.g., transmitting) the unused CGO indication, for example, if the wireless device (e.g., UE) is configured with (and/or enabled and/or with value true) the configuration for unused CGO indication. The wireless device (e.g., UE) may not generate a data for the CG resources based on (e.g., in response to) sending (e.g., transmitting) the unused CGO indication, for example, if the wireless device (e.g., UE) is configured with (and/or enabled and/or with value true) the configuration for unused CGO indication. The wireless device (e.g., UE) may not apply the function based on (e.g., in response to) sending (e.g., transmitting) the unused CGO indication, for example, if the wireless device (e.g., UE) is not configured with (and/or disabled and/or with value false) the configuration for unused CGO indication. The unused CGO indication may be sent (e.g., transmitted) via an UL resource/UL channel. The unused CGO indication may be sent (e.g., transmitted) via PUCCH, PUSCH, and/or PRACH. The unused CGO indication may be sent (e.g., transmitted) by an UCI (e.g., CG-UCI or an UCI for XR), a MAC CE, and/or a RRC signaling. The unused CGO indication may be sent (e.g., transmitted) via a UL resource (e.g., CG resource). The unused CGO indication may be sent (e.g., transmitted) via a first CGO of the multiple CGOs within a CG period. The unused CGO indication may be sent (e.g., transmitted) via a last CGO of the multiple CGOs within a CG period. The unused CGO indication may be sent (e.g., transmitted) via any CGO of the multiple CGOs within a CG period. The wireless device (e.g., UE) may be configured with multiple CGOs within a CG period. The wireless device (e.g., UE) may select a first CGO among the multiple CGOs within a CG period to send (e.g., transmit) the unused CGO indication, for example, if the wireless device (e.g., UE) determine to send (e.g., transmit) the unused CGO indication. The wireless device (e.g., UE) may be configured with multiple CGOs within a CG period. The wireless device (e.g., UE) may select a last CGO among the multiple CGOs within a CG period to send (e.g., transmit) the unused CGO indication, for example, if the wireless device (e.g., UE) determine to send (e.g., transmit) the unused CGO indication. The wireless device (e.g., UE) may be configured with multiple CGOs within a CG period. The wireless device (e.g., UE) may select any CGO among the multiple CGOs within a CG period to send (e.g., transmit) the unused CGO indication, for example, if the wireless device (e.g., UE) determine to send (e.g., transmit) the unused CGO indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may apply the function (based on/in response to sending (e.g., transmitting) unused CGO indication) within the same CG period (as the CG period that the unused CGO indication is sent (e.g., transmitted) on) and/or a next CG period after sending (e.g., transmitting) the unused CGO indication. The wireless device (e.g., UE) may send (e.g., transmit) the unused CGO indication within a first period of CG, and the wireless device (e.g., UE) may apply the function (based on/in response to sending (e.g., transmitting) unused CGO indication) within the first period of CG. The wireless device (e.g., UE) may send (e.g., transmit) the unused CGO indication within a first period of CG, and the wireless device (e.g., UE) may clear the CG resources within the first period of CG based on (e.g., in response to) sending (e.g., transmitting) the unused CGO indication. The wireless device (e.g., UE) may send (e.g., transmit) the unused CGO indication within a first period of CG, and the wireless device (e.g., UE) may deactivate/suspend the corresponding CGs within the first period of CG based on (e.g., in response to) sending (e.g., transmitting) the unused CGO indication. The wireless device (e.g., UE) may send (e.g., transmit) the unused CGO indication within a first period of CG, and the wireless device (e.g., UE) may determining/considering the CG resources are invalid/unavailable within the first period of CG based on (e.g., in response to) sending (e.g., transmitting) the unused CGO indication. The wireless device (e.g., UE) may send (e.g., transmit) the unused CGO indication within a first period of CG, and the wireless device (e.g., UE) may not generate a data for the CG resources within the first period of CG based on (e.g., in response to) sending (e.g., transmitting) the unused CGO indication. The wireless device (e.g., UE) may send (e.g., transmit) the unused CGO indication within a first period of CG, and the wireless device (e.g., UE) may apply the function (based on/in response to sending (e.g., transmitting) unused CGO indication) within a second period of CG, wherein the second period of CG may be a next period of CG from the first period of CG. The second period of CG may be one or more periods of CG after the first period of CG. The wireless device (e.g., UE) may send (e.g., transmit) the unused CGO indication within a first period of CG, and the wireless device (e.g., UE) may clear the CG resources within the second period of CG based on (e.g., in response to) sending (e.g., transmitting) the unused CGO indication. The wireless device (e.g., UE) may send (e.g., transmit) the unused CGO indication within a first period of CG, and the wireless device (e.g., UE) may deactivate/suspend the corresponding CGs within the second period of CG based on (e.g., in response to) sending (e.g., transmitting) the unused CGO indication. The wireless device (e.g., UE) may send (e.g., transmit) the unused CGO indication within a first period of CG, and the wireless device (e.g., UE) may determine/consider the CG resources are invalid/unavailable within the second period of CG based on (e.g., in response to) sending (e.g., transmitting) the unused CGO indication. The wireless device (e.g., UE) may send (e.g., transmit) the unused CGO indication within a first period of CG, and the wireless device (e.g., UE) may not generate a data for the CG resources within the second period of CG based on (e.g., in response to) sending (e.g., transmitting) the unused CGO indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) one or more unused CGO indications. Each unused CGO indication may indicate a next/following/subsequent CG resource(s) of one or more CG configurations will not be used (e.g., will be skipped) by the wireless device (e.g., UE). The next/following/subsequent CG resource(s) may be next one or more CG resource (s) occurs after sending (e.g., transmitting) the unused CGO indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) one or more unused CGO indications. Each unused CGO indication may indicate a next/following/subsequent CG resource(s) of one or more CG configurations will not be used (e.g., will be skipped) by the wireless device (e.g., UE). The next/following/subsequent CG resource(s) may be determined based on multiple CGOs within a CG period. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) one or more unused CGO indications. Each unused CGO indication may indicate a next/following/subsequent CG resource(s) of one or more CG configurations will not be used (e.g., will be skipped) by the wireless device (e.g., UE). The next/following/subsequent CG resource(s) may be one or more CG resource (s) occurs within the same CG period (as the CG period that the unused CGO indication is sent (e.g., transmitted) on) and/or a next CG period after sending (e.g., transmitting) the unused CGO indication of one or more CG configurations. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) one or more unused CGO indications. Each unused CGO indication may indicate a next/following/subsequent CG resource(s) of one or more CG configurations will not be used (e.g., will be skipped) by the wireless device (e.g., UE). The next/following/subsequent CG resource(s) of one or more CG configurations may be next one or more CG resource (s) occurs after a time period/offset from sending (e.g., transmitting) the unused CGO indication. The time period/offset may be determined based on a quantity (e.g., number) of time unit. The time period/offset may be determined based on a time duration. The time period/offset may be determined based on a transmission delay. The time period/offset may be determined based on an application delay/processing time. The time period/offset may be determined based on a timer/time window. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) one or more unused CGO indications. Each unused CGO indication may comprise multiple fields (e.g., based on a bitmap). Each field (e.g., each bit) may indicate one or more CG resource(s) of one or more CG configurations will not be used (e.g., will be skipped) by the wireless device (e.g., UE). A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) an unused CGO indication via a CG period (e.g., a first CG period), and the unused CGO indication may indicate one or more remaining/subsequent CG resource(s) within the same CG period (e.g., the first CG period) of one or more CG configurations will not be used (e.g., will be skipped) by the wireless device (e.g., UE), wherein the remaining/subsequent CG resources may be CG resources of one or more CG configurations after sending (e.g., transmitting) the unused CGO indication. The remaining/subsequent CG resource(s) may be one or more CG resources sequentially occur after sending (e.g., transmitting) the unused CGO indication (in time domain). The remaining/subsequent CG resource(s) may be CG resources sequentially occur within the same CG period (as the CG period that the unused CGO indication is sent (e.g., transmitted) on). The remaining/subsequent CG resource(s) may be CG resources sequentially occur based on the configuration of multiple CGO within a CG period. The remaining/subsequent CG resource(s) may be CG resources sequentially occur based on SFN, numberOfSlotsPerFrame, numberOfSymbolsPerSlot, slot quantity (e.g., number) in the frame, symbol quantity (e.g., number) in the slot, imeReferenceSFN, umberOfSlotsPerFrame, timeDomainOffset, S, N, and/or periodicity. For example, the next/following/subsequent CG resource(s) may occur based on:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) \text{} modulo \text{} ( 1024 \times numberOfSlotsPerFrame \times numberOfSymbolsPerSlot ) .$$

A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may determine to unuse/skip a quantity (e.g., number) of CG resources of one or more CG configurations based on a value based on (e.g., in response to) sending (e.g., transmitting) an unused CGO indication. The wireless device (e.g., UE) may determine to unuse/skip a quantity (e.g., number) of CG resources of one or more CG configurations based on a value based on (e.g., in response to) sending (e.g., transmitting) an unused CGO indication. The quantity (e.g., number) of CG resources based on the value may be counted based on the quantity (e.g., number) of (CG) resource occasions. The quantity (e.g., number) of (CG) resource occasions may be indicated by a configuration for multiple CGOs within a CG period. The quantity (e.g., number) of CG resources based on the value may be counted based on the quantity (e.g., number) of (CG) time resources. The quantity (e.g., number) of CG resources based on the value may be counted based on the quantity (e.g., number) of transmission opportunities. The quantity (e.g., number) of CG resources based on the value may be counted based on the CG resource that occur or reoccur sequentially based on SFN, numberOfSlotsPerFrame, numberOfSymbolsPerSlot, slot number in the frame, symbol quantity (e.g., number) in the slot, imeReferenceSFN, umberOfSlotsPerFrame, timeDomainOffset, S, N, and/or periodicity. For example, the next/following/subsequent CG resource(s) may occur based on:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) \text{} modulo \text{} ( 1024 \times numberOfSlotsPerFrame \times numberOfSymbolsPerSlot ) .$$

The quantity (e.g., number) of CG resources based on the value may be counted based on the quantity (e.g., number) of UL grants. The quantity (e.g., number) of CG resources based on the value may be counted based on the quantity (e.g., number) of time units of the CG resources (e.g., slot, symbol, subframe, system frame, millisecond, second, CG periodicity, DRX cycle). A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) one or more unused CGO indications. The wireless device (e.g., UE) may unuse/skip CG resources of one or more CG configurations within a quantity (e.g., number) of one or more CG periods based on (e.g., in response to) sending (e.g., transmitting) the unused CGO indication. The CG period (periodicity) may be used for UL transmission without UL grant for type 1 and type 2. The CG period may be referred to as the periodicity of CG. The CG period may be determined based on a configuration parameter “periodicity” indicated (configured) by a configured grant configuration. The CG period (periodicity) may be used for UL transmission without UL grant for type 1 and type 2. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) one or more unused CGO indications. The wireless device (e.g., UE) may unuse/skip CG resources of one or more CG configurations based on a duration (e.g., within a duration) based on (e.g., in response to) sending (e.g., transmitting) the unused CGO indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device (e.g., UE) may send (e.g., transmit) one or more unused CGO indications. The wireless device (e.g., UE) may unuse/skip CG resources of one or more CG configurations based on a timer (e.g., if/while the timer is running) based on (e.g., in response to) sending (e.g., transmitting) the unused CGO indication. The wireless device (e.g., UE) may start or restart the timer based on (e.g., in response to) sending (e.g., transmitting) the unused CGO indication. The wireless device (e.g., UE) may start or restart the timer based on (e.g., in response to) triggering the unused CGO. The wireless device (e.g., UE) may start or restart the timer based on (e.g., in response to) receiving a signaling from BS, therein the signaling may be feedback (for the transmission of the unused CGO indication). The feedback may be an ACK or NACK. The signaling may be a response/confirmation for the unused CGO indication. The signaling may be an DCI, MAC CE, and/or a RRC message. The wireless device (e.g., UE) may start or restart the timer based on (e.g., in response to) receiving a RRC configuration for unused CGO indication. The wireless device (e.g., UE) may start or restart the timer in response to receiving a DCI for triggering unused CGO. The wireless device (e.g., UE) may stop the timer based on (e.g., in response to) receiving a signaling from BS. The signaling may be feedback (for the transmission of the unused CGO indication). The feedback may be an ACK or NACK. The signaling may be a response/confirmation for the unused CGO indication. The signaling may be an DCI, MAC CE, and/or a RRC message. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a plurality of configured grant (CG) configurations indicating a plurality of CG resources, wherein each of the plurality of CG configurations may indicate one or more respective CG resources of the plurality of CG resources; and/or the wireless device may send (e.g., transmit) an indication indicating a first CG configuration of the plurality of CG configurations that may be associated with one or more first CG resources unused among the plurality of CG resources. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a plurality of configured grant (CG) configurations indicating a plurality of CG resources, wherein each of the plurality of CG configurations may indicate one or more respective CG resources of the plurality of CG resources; and/or the wireless device may send (e.g., transmit) an indication comprising at least one of: an indication indicates that one or more first CG resources, among the plurality of CG resources, may be unused; and/or an identifier of a first CG configuration, of the plurality of CG configurations, wherein the first CG configuration may indicate the one or more first CG resources. the identifier may be an index of the first CG configuration. The wireless device may skip (e.g., prevent from use of) the one or more first CG resources based on (e.g., in response to) sending (e.g., transmitting) the indication. The plurality of CG configurations may be grouped into one or more CG groups; and/or the identifier may be a group identifier of a first CG group of the one or more CG groups that the first CG configuration belongings to. The plurality of CG configurations may be grouped into one or more CG groups based on a configuration parameter. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a plurality of configured grant (CG) configurations indicating a plurality of CG resources, wherein each of the plurality of CG configurations may indicate one or more respective CG resources of the plurality of CG resources; and/or the wireless device may send (e.g., transmit) an indication comprising a plurality of fields, wherein each field of the plurality of fields: may be associated with a respective CG configuration of the plurality of CG configurations; and/or may indicate whether at least one CG resource associated with the respective CG configuration may be unused. The indication may comprise a bitmap comprising the plurality of fields. Each field of the plurality of fields may indicate the at least one CG resource associated with the respective CG configuration may be unused by indicating a first value. Each field of the plurality of fields may indicate each CG resource associated with a respective CG configuration may be used by indicating a second value. The wireless device may skip (e.g., prevent from use of) the at least one CG resource associated with the respective CG configuration based on (e.g., in response to) sending (e.g., transmitting) the indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a plurality of configured grant (CG) configurations indicating a plurality of CG resources, wherein each of the plurality of CG configurations may indicate one or more respective CG resources of the plurality of CG resources; and/or the wireless device may send (e.g., transmit) an indication, via a first CG resource associated with a first CG configuration of the plurality of CG configurations, indicating that one or more CG resources indicated by the first CG configuration may be unused. The wireless device may skip (e.g., prevent from use of) the one or more CG resources indicated by the first CG configuration based on (e.g., in response to) sending (e.g., transmitting) the indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a plurality of configured grant (CG) configurations indicating a plurality of CG resources, wherein each of the plurality of CG configurations may indicate one or more respective CG resources of the plurality of CG resources; the wireless device may determine one or more CG resources indicated by a first CG configuration may be unused; the wireless device may select, for a transmission of an indication indicating the one or more first CG resources may be unused, a first CG resource indicated by the first CG configuration; and/or the wireless device may send (e.g., transmit), via the first CG resource, the indication. The wireless device may skip (e.g., prevent from use of) the one or more CG resources indicated by the first CG configuration in response to sending (e.g., transmitting) the indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first CG configuration and a second CG configuration. The wireless device may determine that: one or more first CG resources indicated by the first CG configuration may be unused; and/or one or more second CG resources indicated by the second CG configuration may be used. Based on the determining: the wireless device may select a first CG resource indicated by the first CG configuration to send (e.g., transmit) an indication indicating that the one or more first CG resources may be unused; and/or the wireless device may send (e.g., transmit) the indication via the first CG resource; the wireless device may skip (e.g., prevent from use of) the one or more first CG resources in response to sending (e.g., transmitting) the indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first CG configuration and a second CG configuration; the wireless device may send (e.g., transmit) an indication indicating that one or more CG resources may be unused, wherein the indication may be sent (e.g., transmitted) via a first CG resource indicated by the first CG configuration; the wireless device may skip (e.g., prevent from use of) a first CG resource indicated by the first CG configuration based on (e.g., in response to) sending (e.g., transmitting) the indication via the first CG resource; and/or the wireless device may use a second CG resource indicated by the second CG configuration. The indication may be sent (e.g., transmitted) via a UL resource. The UL resource may be a PUSCH resource. The UL resource may be a CG resource. The UL resource may be scheduled by a PDCCH. The first CG configuration and the second CG configuration may be activated (initialized). The first CG configuration and the second CG configuration may be in an active state. The first CG configuration and the second CG configuration may indicate a configuration parameter for the indication. The first CG configuration and the second CG configuration may indicate enable for the indication. The first CG configuration may indicate a configuration parameter for the indication, and the second CG configuration may not indicate the configuration parameter for the indication. The first CG configuration may indicate enable for the indication, but the second CG configuration may indicate disable for the indication. The indication may be an unused configuration grant resource occasions (CGO) indication The indication may be sent (e.g., transmitted) via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first CG configuration and a second CG configuration; the wireless device may determine that: one or more first CG resources indicated by the first CG configuration may be unused; and/or one or more second CG resources indicated by the second CG configuration may be used. Based on the determining: the wireless device may send (e.g., transmit) an indication comprising a CG index associated with the first CG configuration to indicate that the one or more first CG resources may be unused; the wireless device may skip (e.g., prevent from use of) the one or more first CG resources in response to sending (e.g., transmitting) the indication. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first CG configuration and a second CG configuration; the wireless device may send (e.g., transmit) an indication indicating that one or more CG resources, indicated by the first CG configuration, may be unused, wherein the indication may comprise a first CG index associated with the first CG configuration; and/or the wireless device may skip (e.g., prevent from use of) the one or more CG resources, indicated by the first CG configuration based on the first CG index. The indication may be sent (e.g., transmitted) via a UL resource. The UL resource may be a PUSCH resource. The UL resource may be a CG resource. The UL resource may be scheduled by a PDCCH. The first CG configuration and the second CG configuration may be activated (initialized). The first CG configuration and the second CG configuration may be in an active state. The first CG configuration and the second CG configuration may indicate a configuration parameter for the indication. The first CG configuration and the second CG configuration may indicate enable for the indication. The first CG configuration may indicate a configuration parameter for the indication, and the second CG configuration may not indicate the configuration parameter for the indication. The first CG configuration may indicate enable for the indication, and the second CG configuration may indicate disable for the indication. The indication may be an unused configuration grant resource occasions (CGO) indication. The indication may be sent (e.g., transmitted) via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first CG configuration associated with a first CG index and a second CG configuration associated with a second CG index; the wireless device may send (e.g., transmit) an indication indicating that one or more CG resources may be unused, wherein the indication may comprise the first CG index and may not comprises the second CG index; and/or based on (e.g., in response to) sending (e.g., transmitting) the indication: the wireless device may skip (e.g., prevent from use of) a first CG resource indicated by the first CG configuration; and/or the wireless device may use a second CG resource indicated by the second CG configuration. The indication may be sent (e.g., transmitted) via a UL resource. The UL resource may be a PUSCH resource. The UL resource may be a CG resource. The UL resource may be scheduled by a PDCCH. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first set of CG configurations comprising a configuration parameter of an indication; and/or a second set of CG configurations not comprising the configuration parameter of the indication; the wireless device may send (e.g., transmit) the indication indicating that one or more CG resources may be unused; and/or based on (e.g., in response to) sending (e.g., transmitting) the indication: the wireless device may skip (e.g., prevent from use of) CG resources indicated by the first set of CG configurations; and/or the wireless device may keep using CG resources indicated by the second set of CG configurations. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a plurality of CG configurations; the wireless device may send (e.g., transmit) an indication indicating that one or more CG resources, indicated by the plurality of CG configurations, may be unused, wherein the indication may be sent (e.g., transmitted) via a CG resource indicated by one of the plurality of CG configurations; and/or the wireless device may skip (e.g., prevent from use of) CG resources, indicated by the plurality of CG configurations, based on (e.g., in response to) sending (e.g., transmitting) the indication via the CG resource. The indication may be sent (e.g., transmitted) via a UL resource. UL resource may be a PUSCH resource. UL resource may be a CG resource. UL resource may be scheduled by a PDCCH. The first CG configuration and the second CG configuration may be activated (initialized). The first CG configuration and the second CG configuration may be in an active state. The first CG configuration and the second CG configuration may indicate a configuration parameter for the indication. The first CG configuration and the second CG configuration may indicate enable for the indication. The first CG configuration may indicate a configuration parameter for the indication, and the second CG configuration may not indicate the configuration parameter for the indication. The first CG configuration may indicate enable for the indication, and the second CG configuration may indicate disable for the indication. The indication may be an unused configuration grant resource occasions (CGO) indication. The indication may be sent (e.g., transmitted) via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may send (e.g., transmit) an indication indicating that one or more CG resources, indicated by one or more CG configurations, may be unused, wherein the indication may be sent (e.g., transmitted) via a CG resource indicated by the one or more CG configurations; and/or the wireless device may skip (e.g., prevent from use of) the one or more CG resources in response to sending (e.g., transmitting) the indication via the CG resource. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first set of CG configurations comprising a configuration parameter of an indication; and/or a second set of CG configurations not comprising the configuration parameter of the indication; the wireless device may send (e.g., transmit) the indication indicating that one or more CG resources may be unused; and/or based on (e.g., in response to) sending (e.g., transmitting) the indication: the wireless device may skip (e.g., prevent from use of) CG resources indicated by the first set of CG configurations and the second set of CG configurations. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first CG configuration and a second CG configuration, wherein the first CG configuration may be activated (initialized) and the second CG configuration may be deactivated (suspended); the wireless device may send (e.g., transmit) an indication indicating that one or more CG resources, may be unused; and/or based on (e.g., in response to) sending (e.g., transmitting) the indication: the wireless device may skip (e.g., prevent from use of) a first CG resource indicated by the first CG configuration; and/or the wireless device may use a second CG resource indicated by the second CG configuration. The indication may be sent (e.g., transmitted) via a UL resource. UL resource may be a PUSCH resource. UL resource may be a CG resource. UL resource may be scheduled by a PDCCH. The first CG configuration and the second CG configuration may be activated (initialized). The first CG configuration and the second CG configuration may be in an active state. The first CG configuration and the second CG configuration may indicate a configuration parameter for the indication. The first CG configuration and the second CG configuration may indicate enable for the indication. The first CG configuration may indicate a configuration parameter for the indication, and the second CG configuration may not indicate the configuration parameter for the indication. The first CG configuration may indicate enable for the indication, and the second CG configuration may indicate disable for the indication. The indication may be an unused configuration grant resource occasions (CGO) indication. The indication may be sent (e.g., transmitted) via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first CG configuration associated with a first CG index and a second CG configuration associated with a second CG index; the wireless device may determine that: one or more first CG resources indicated by the first CG configuration may be unused; and/or one or more second CG resources indicated by the second CG configuration may be used. Based on the determining: the wireless device may send (e.g., transmit) an indication comprising a bitmap indicating at least a first bit with a first value and a second bit with a second value, wherein the first bit may be associated with the first CG configuration and the second bit may be associated with the second CG configuration. Based on (e.g., in response to) sending (e.g., transmitting) the indication: the wireless device may skip (e.g., prevent from use of) the one or more first CG resources indicated by the first CG configuration; and/or the wireless device may use the one or more second CG resources indicated by the second CG configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive a first CG configuration and a second CG configuration; the wireless device may send (e.g., transmit) an indication indicating that one or more CG resources may be unused, wherein the indication may comprise a bitmap indicating a first bit with a first value for the first CG configuration and indicating a second bit with a second value for the second CG configuration. Based on (e.g., in response to) sending (e.g., transmitting) the indication: the wireless device may skip (e.g., prevent from use of) a first CG resources indicated by the first CG configuration; and/or the wireless device may use a second CG resources indicated by the second CG configuration. The indication may be sent (e.g., transmitted) via a UL resource. The UL resource may be a PUSCH resource. The UL resource may be a CG resource. The UL resource may be scheduled by a PDCCH. The first CG configuration and the second CG configuration may be activated (initialized). The first CG configuration and the second CG configuration may be in an active state. The first CG configuration and the second CG configuration may indicate a configuration parameter for the indication. The first CG configuration and the second CG configuration may indicate enable for the indication. The first CG configuration may indicate a configuration parameter for the indication, and the second CG configuration may not indicate the configuration parameter for the indication. The first CG configuration may indicate enable for the indication, and the second CG configuration may indicate disable for the indication. The indication may be an unused configuration grant resource occasions (CGO) indication. The indication may be sent (e.g., transmitted) via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

A wireless device may receive one or more CG configurations; and/or the wireless device may send (e.g., transmit) an indication indicating that one or more CG resources, indicated by the one or more CG configurations, may be unused. The indication may be sent (e.g., transmitted) via a UL resource. The UL resource may be a PUSCH resource. The UL resource may be a CG resource. The UL resource may be scheduled by a PDCCH. The first CG configuration and the second CG configuration may be activated (initialized). The first CG configuration and the second CG configuration may be in an active state. The first CG configuration and the second CG configuration may indicate a configuration parameter for the indication. The first CG configuration and the second CG configuration may indicate enable for the indication. The first CG configuration may indicate a configuration parameter for the indication, and the second CG configuration may not indicate the configuration parameter for the indication. The first CG configuration may indicate enable for the indication, and the second CG configuration may indicate disable for the indication. The indication may be an unused configuration grant resource occasions (CGO) indication. The indication may be sent (e.g., transmitted) via UCI, MAC CE, or a RRC configuration. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a based station configured to send, to the wireless device, one or more radio resource control configuration parameters. A computer-readable medium storing instructions that, when executed, cause performance of the described method, additional operations and/or include the additional elements.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. For example, if a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, Wifi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described herein, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving, by a wireless device, at least one message indicating a configured grant (CG) configuration, wherein the at least one message comprises:
a first parameter indicating a quantity of slots for one or more CG transmission occasions (TOs) in a period of the CG configuration; and
a second parameter indicating a quantity of bits in a bitmap for uplink control information (UCI), wherein each bit in the bitmap indicates whether a respective CG TO of the CG configuration, is to be used or unused for uplink transmission; and
sending, via a first CG TO of the CG configuration, UCI comprising the bitmap, wherein at least one CG TO, associated with the bitmap, is subsequent to the first CG TO.

2. The method of claim 1, further comprising:
sending a first uplink signal via a second CG TO of the one or more CG TOs, wherein the sending the first uplink signal via the second CG TO is based on:
a first bit, in the bitmap, being associated with the second CG TO; and
a first value of the first bit indicating the second CG TO is to be used for uplink transmission.

3. The method of claim 1, further comprising:
skipping sending a second uplink signal via a third CG TO of the one or more CG TOs, wherein the skipping is based on:
a second bit, in the bitmap, being associated with the third CG TO; and
a second value of the second bit indicating the third CG TO is to be unused for uplink transmission.

4. The method of claim 1, wherein:
the CG configuration comprises a parameter indicating a time offset; and
the one or more CG TOs occur after the time offset from the first CG TO.

5. The method of claim 4, further comprising:
skipping sending a third uplink signal via a fourth CG TO, of the one or more CG TOs, after the time offset; and
resuming sending a fourth uplink signal via a fifth CG TO, of the one or more CG TOs, after skipping sending the third uplink signal.

6. A method comprising:
receiving, by a wireless device, at least one message indicating a configured grant (CG) configuration, wherein the CG configuration indicates a plurality of CG resources;
sending uplink control information (UCI) comprising an indication of at least one unused CG resource, wherein the at least one unused CG resource occurs during a time period after the sending the UCI; and
skipping, based on the UCI, the at least one unused CG resource.

7. The method of claim 6, further comprising:
resuming at least one used CG resource after the skipping the at least one unused CG resource, wherein the at least one used CG resource is indicated in the UCI.

8. The method of claim 6, wherein the skipping further comprising:
skipping, based on a first bit in the indication, the at least one unused CG resource, wherein the first bit indicates the at least one unused CG resource.

9. The method of claim 6, wherein the time period is based on at least one of:
a transmission delay;
an application delay;
a processing time; or
an expiration of a timer.

10. The method of claim 6, wherein:
the time period is indicated by the UCI; and
the time period is based on at least one of:
slot;
subframe;
system frame;
millisecond;
second;
discontinuous reception (DRX) cycle;
CG periodicity;
a pre-defined value; or
a value indicated by a base station.

11. The method of claim 6, wherein:
the CG configuration indicates a first set of CG resources within a first CG period and a second set of CG resources within a second CG period;
sending the UCI comprises:
sending the UCI within the first CG period; and
skipping the at least one unused CG resource comprises:
skipping remaining resources of the first set of CG resources within the first CG period; and
the method further comprises:
resuming the second set of CG resources within the second CG period.

12. The method of claim 6, further comprising starting, or restarting, a timer after sending the UCI.

13. A method comprising:
receiving, by a wireless device, at least one message indicating a configured grant (CG) configuration, wherein the CG configuration indicates a plurality of CG resources;
sending uplink control information (UCI) indicating that at least one CG resource of the plurality of CG resources is unused, or used, based on a field of the UCI; and
skipping, based on sending the UCI, a configured transmission via the at least one CG resource.

14. The method of claim 13, wherein:
the field is a bitmap and comprises a first value and a second value; and wherein:
the field, based on the first value, indicates an unused CG resource of the plurality of CG resources; or
the field, based on the second value, indicates a used CG resource of the plurality of CG resources.

15. The method of claim 13, wherein the at least one message comprises:
a first parameter indicating a quantity of CG transmission occasions (TOs) in a period of the CG configuration; and
a second parameter indicating a quantity of bits in a bitmap for uplink control information (UCI), wherein each bit in the bitmap indicates whether a respective CG TO of the CG configuration, is to be used or unused for uplink transmission.

16. The method of claim 13, further comprising:
sending the UCI via a first CG resource within a CG period, wherein the first CG resource within the CG period is indicated by the CG configuration; or
sending the UCI via a last CG resource within a CG period, wherein the last CG resource within a CG period is indicated by the CG configuration.

17. The method of claim 13, wherein the at least one CG resource is:
Physical Uplink Shared Channel (PUSCH) resource; or
Physical uplink control channel (PUCCH) resource.

18. The method of claim 13, wherein:
the at least one CG resource is associated with a first CG period and sending the UCI comprises sending the UCI during the first CG period; or
the at least one CG resource is associated with a second CG period and sending the UCI comprises sending the UCI during the first CG period and prior to the second CG period.

19. The method of claim 13, wherein:
the UCI comprises a first value indicating that remaining CG resources, of the plurality of CG resources, are unused; or
the UCI comprises a second value indicating that remaining CG resources, of the plurality of CG resources, are used.

20. The method of claim 13, further comprising:
determining whether one or more CG resources, of the plurality of CG resources and within a CG period, are used or unused; and
based on the determining:
sending the UCI if the one or more CG resources of the plurality of CG resources within the CG period are unused; or
skipping sending the UCI if the one or more CG resources of the plurality of CG resources within the CG period are used.
